(19) United States
(12) Patent Application Publication
(10) Pub. No.: US 2026/0364435 A1
(43) Pub. Date: Nov. 19, 2026

(54) POLYMERIZABLE COMPOSITIONS FOR MOUTHGUARDS AND ASSOCIATED METHODS

(71) Applicant: Align Technology, Inc., San Jose, CA (US)

(72) Inventors: Christian Gorsche, Mattersburg (AT); Christian Frank, Vienna (AT); Sanghamitra Sen, San Jose, CA (US); Umesh Upendra Choudhary, Scotts Valley, CA (US)

(21) Appl. No.: 19/666,026

(22) Filed: May 1, 2026

Related U.S. Application Data
(60) Provisional application No. 63/798,875, filed on May 2, 2025.
(60) Provisional application No. 63/832,913, filed on Jun. 30, 2025.

(51) Int. Cl. A63B 71/08; C08F 2/48; C08K 5/5397; C08L 33/10

(52) U.S. Cl. CPC A63B 71/085; C08F 2/48; C08K 5/5397; C08L 33/10; C08L 2203/02; C08L 2205/02

(57) ABSTRACT

Polymerizable compositions for use in fabricating objects such as dental appliances are provided. In some embodiments, a dental appliance for protecting a subject's teeth is provided. The dental appliance can include a shell composed of a plurality of additively manufactured layers of a polymeric material that is configured to protect the subject's teeth from injury. The polymeric material can be prepared from a polymerizable composition including a polymerizable compound, a reactive diluent, and an initiator. The polymerizable compound can include a non-polar unit and a polar unit substituted with one or more curable groups. A ratio of the non-polar unit to the polar unit can be configured to confer shock absorption properties to the polymeric material while maintaining low water uptake of the polymeric material.

### CROSS-REFERENCE TO RELATED APPLICATION(S)

The present application claims the benefit of priority to U.S. Provisional Application No. 63/798,875, filed May 2, 2025, and U.S. Provisional Application No. 63/832,913, filed Jun. 30, 2025, the disclosures of which are incorporated by reference herein in their entirety.

### TECHNICAL FIELD

The present technology generally relates to dental appliances, and in particular, to polymerizable compositions for mouthguards and associated methods.

### BACKGROUND

Mouthguards are dental appliances that are worn on an individual's teeth to protect the teeth from injury due to impacts, abrasion, etc. For instance, a sportsguard can protect the teeth from forces during physical activities such as contact sports, while a nightguard can protect the teeth from bruxism during sleep. Mouthguards may benefit from personalization and/or patient-specific designs, which may yield superior performance characteristics such as improved safety and protection, good mouth feel, high comfort, improved breathing, reduced speech impairment, and/or sport-specific design. There is a need in the field of mouthguards for materials that can confer such improved performance characteristics. The present disclosure addresses these issues along with providing other unexpected benefits.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 illustrates a mouthguard prepared from a polymerizable composition in accordance with embodiments of the present technology.

FIG. 2 is a partially schematic diagram providing a general overview of an additive manufacturing process, in accordance with embodiments of the present technology.

FIG. 3 is a partially schematic diagram of an additive manufacturing device, in accordance with embodiments of the present technology.

FIG. 4A illustrates a representative example of a tooth repositioning appliance configured in accordance with embodiments of the present technology.

FIG. 4B illustrates a tooth repositioning system including a plurality of appliances, in accordance with embodiments of the present technology.

FIG. 4C illustrates a method of orthodontic treatment using a plurality of appliances, in accordance with embodiments of the present technology.

FIG. 5 illustrates a method for designing an orthodontic appliance, in accordance with embodiments of the present technology.

FIG. 6 illustrates a method for digitally planning an orthodontic treatment, in accordance with embodiments of the present technology.

FIG. 7 illustrates a method for digitally planning an orthodontic treatment and/or design or fabrication of an appliance, in accordance with embodiments of the present technology.

FIG. 8 illustrates a method for generating and administering an orthodontic treatment, in accordance with embodiments of the present technology.

FIGS. 9A-9G illustrate a dental appliance for protecting a subject's teeth, in accordance with embodiments of the present technology.

FIGS. 10A and 10B illustrate a dental appliance for protecting a subject's teeth with variable gingival coverage, in accordance with embodiments of the present technology.

FIG. 11A is a bottom view of a dental appliance for protecting a subject's teeth with reduced lingual coverage, in accordance with embodiments of the present technology.

FIG. 11B is a perspective view of a dental appliance for protecting a subject's teeth with thickened buccal walls and reduced lingual coverage, in accordance with embodiments of the present technology.

FIGS. 12A-12D illustrate dental appliances for protecting a subject's teeth with varying occlusal surface geometries, in accordance with embodiments of the present technology.

FIGS. 13A and 13B illustrate a dental appliance for protecting a subject's teeth with a flattened occlusal surface, in accordance with embodiments of the present technology.

FIG. 13C is a perspective view of a dental appliance for protecting a subject's teeth with a contoured occlusal surface, in accordance with embodiments of the present technology.

FIG. 13D is a perspective view of a dental appliance for protecting a subject's teeth with a flattened anterior surface, in accordance with embodiments of the present technology.

FIGS. 14A-14F are partially schematic cross-sectional views of dental appliances with shock absorbing features, in accordance with embodiments of the present technology.

FIGS. 15A-15C are cross-sectional views of dental appliances with variable offset distances, in accordance with embodiments of the present technology.

FIGS. 16A-16C illustrate a dental appliance for protecting teeth of a subject's upper and lower jaws, in accordance with embodiments of the present technology.

FIGS. 17A and 17B are perspective views of dental appliances composed of multiple materials, in accordance with embodiments of the present technology.

FIGS. 18A-18D illustrate results from rebound testing of a conventional mouthguard material versus an additively manufactured material, in accordance with embodiments of the present technology.

### DETAILED DESCRIPTION

The present technology relates to polymerizable compositions for use in fabricating objects such as dental appliances, and associated methods. In some embodiments, a dental appliance for protecting a subject's teeth (e.g., a mouthguard) is provided. The dental appliance can include a shell composed of a plurality of additively manufactured layers of a polymeric material that is configured to protect the subject's teeth from injury. The polymeric material can be prepared from a polymerizable composition including a polymerizable compound (e.g., an oligomer or a polymer), a reactive diluent, and an initiator. The polymerizable compound can include a non-polar unit and a polar unit that is substituted with one or more curable groups. In some embodiments, the ratio of the non-polar unit to the polar unit in the polymerizable compound is configured to confer shock absorption properties to the polymeric material (e.g., to provide protection against impact forces, bruxism, abrasion, clenching) while maintaining low water uptake of the polymeric material (e.g., to improve staining resistance).

In some embodiments, the present disclosure includes embodiments of mouthguards with increased performance characteristics such as tear resistance, low water uptake, high stain resistance, rebound resilience, and/or absorbed energy. Embodiments of the present disclosure provide polymerizable compositions and methods for preparing the same that are versatile and adaptable and can be used, for example, for additive manufacturing of mouthguards and related dental appliances, such as sportsguards, nightguards, bite splints, occlusal splints, splints for therapy of myofunctional disorder, bite or jaw positioners, etc.

In some embodiments, the present disclosure provides useful compounds and compositions as well as methods ofusing (e.g., for producing polymerizable compositions, and/or polymeric material) and producing the same. The polymerizable compositions described herein can address an unmet need to produce mouthguards with advantageous properties (e.g., increased toughness, smoothness, stain resistance, improved shock absorption (e.g., as measured by rebound), safety, good mouthfeel, high comfort, improved breathing, reduced speech impairment). The present disclosure also provides a method of making the mouthguards with the advantageous properties by the direct fabrication via additive manufacturing.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

All terms, chemical names, expressions, and designations have their usual meanings which are well-known to those skilled in the art.

As used herein, a “monomer component,” “monomer,” or a grammatic equivalent refers to a molecule having a reactive functional group capable of undergoing a radical initiated polymerization reaction (e.g., alkenes or functionally substituted alkenes). Such polymerization reaction can be a photo-induced polymerization, e.g., via radical generation. In some embodiments, a monomer component is ethene, chloroethene, fluoroethene, chlorotrifluoroethene, tetrafluoroethene, propene, 2-methylpropene, styrene, propenenitrile, methyl methacrylate, phenyl ethylene, alkyl acrylate (e.g., n-butyl acrylate), 1,6,heandiol diacrylate, 2,6-dimethoxyphenyl acrylate, 2,6-dimethoxyphenyl methacrylate, and the like.

As used herein, the terms “polymer,” “polymeric material,” or an equivalent refers to a molecule composed of repeating structural units connected by covalent chemical bonds and characterized by a substantial number of repeating units (e.g., equal to or greater than 10 repeating units; in some embodiments, repeating units are equal to or greater than 100, 200, 250, 300, 350, 400, 450, or 500 repeating units) and a molecular weight greater than or equal to 5,000 Daltons (Da) or 5 kDa; for example, in some embodiments, a polymeric material has a molecular weight greater than or equal to 10 kDa, 15 kDa, 20 kDa, 30 kDa, 40 kDa, 50 kDa, or 100 kDa. Polymers of the present disclosure are the polymerization product of a photoinitiator of this disclosure and (optionally) one or more monomer components. The term polymer includes homopolymers, i.e., polymers consisting essentially of a single repeating monomer species. The term polymer also includes copolymers which are formed when two or more different types (or species) of monomers are linked in the same polymer. Copolymers may comprise two or more different monomer species, and include random, block, alternating, segmented, grafted, tapered and other copolymers.

As used herein, the term “oligomer” generally refers to a molecule composed of repeating structural units connected by covalent chemical bonds and characterized by a number of repeating units less than that of a polymer (e.g., equal to or less than 20 or less than 10 repeating units) and a lower molecular weight than polymers, e.g., less than 5,000 Da or less than 2,000 Da, and in various cases from about 0.5 kDa to about 5 kDa. In some case, oligomers may be the polymerization product of one or more monomer precursors.

“Dumbbell oligomer” refers to an oligomer with multiple functionalized chain ends resembling a dumbbell. The dumbbell oligomer may be symmetric or asymmetric. The dumbbell oligomer is formed by two identical or different “head” (e.g., a chain end) regions connected by a linker.

As used herein, the term “reactive diluent” generally refers to a substance which reduces the viscosity of another substance, such as a monomer or curable resin or polymerizable composition. A reactive diluent may become part of another substance, such as a polymer obtained by a polymerization process.

“Polar unit” refers to a moiety which includes a polar bond. The polar bond is formed with atoms that have electronegativity difference between 0.5 and 2.0. For example, the polar bond includes C—O, C═O, C—N, N—H, O—H, and Si—O. The polar unit may also be referred to as a hydrophilic unit. The hydrophilic unit mixes and dissolves well with water and is attracted to water and/or form hydrogen bonds with water.

“Non-polar unit” refers to a moiety which includes a non-polar bond. The non-polar bond is formed with atoms that have electronegativity difference less than 0.5. For example, the non-polar bond includes C—C, C—H, C═C, Si—H, and Si—C. The non-polar unit may also be referred to as a hydrophobic unit. The hydrophobic unit does not mix and dissolve well with water and is resistant to wetting and/or does not form hydrogen bonds with water.

The average molecular weight (M) is the average number of repeating units n times the molecular weight or molar mass (Mᵢ) of the repeating unit. The number average molecular weight (Mₙ) is the arithmetic mean, representing the total weight of the molecules present divided by the total number of molecules.

The term “biocompatible,” as used herein, refers to a material that does not elicit an immunological rejection or detrimental effect, referred herein as an adverse immune response when it is disposed within an in vivo biological environment. For example, in some embodiments, a biological marker indicative of an immune response changes less than 10%, less than 20%, less than 25%, less than 40%, or less than 50% from a baseline value when a human or animal is exposed to or in contact with the biocompatible material. Alternatively, the immune response may be determined histologically, wherein localized immune response is assessed by visually assessing markers, including immune cells or markers that are involved in the immune response pathway, in and adjacent to the material. In some embodiments, a biocompatible material or device does not observably change in immune response as determined histologically. In some embodiments, the disclosure provides biocompatible devices configured for long-term use, such as on the order of weeks to months, without invoking an adverse immune response. Biological effects may be initially evaluated by measurement of cytotoxicity, sensitization, irritation and intracutaneous reactivity, acute systemic toxicity, pyrogenicity, subacute/subchronic toxicity and/or implantation. Biological tests for supplemental evaluation include testing for chronic toxicity.

The term “bioinert,” as used herein, refers to a material that does not elicit an immune response from a human or animal when it is disposed within an in vivo biological environment. For example, a biological marker indicative of an immune response remains substantially constant (plus or minus 5% of a baseline value) when a human or animal is exposed to or in contact with the bioinert material. In some embodiments, the disclosure provides bioinert devices.

As used herein, the term “group” or “moiety” refers to a functional group of a chemical compound. Groups of the present compounds refer to an atom or a collection of atoms that are a part of the compound. Groups of the present disclosure may be attached to other atoms of the compound via one or more covalent bonds. Groups may also be characterized with respect to their valence state. The present disclosure includes groups characterized as monovalent, divalent, trivalent, etc., valence states.

As used herein, the term “substituted” refers to a compound (e.g., an alkyl chain) wherein a hydrogen is replaced by another functional group or atom, as described herein.

“Alkyl” refers to a saturated, straight or branched hydrocarbon chain radical consisting solely of carbon and hydrogen atoms, having from one to twelve carbon atoms (C₁-C₁₂ alkyl), one to eight carbon atoms (C₁-C₈ alkyl) or one to six carbon atoms (C₁-C₆ alkyl), or any value within these ranges, such as C₄-C₆ alkyl and the like, and which is attached to the rest of the molecule by a single bond, e.g., methyl, ethyl, n-propyl, 1-methylethyl (iso-propyl), n-butyl, n-pentyl, 1,1-dimethylethyl (t-butyl), 3-methylhexyl, 2-methylhexyl and the like. The number of carbons referred to relates to the carbon backbone and carbon branching but does not include carbon atoms belonging to any substituents. Unless stated otherwise specifically in the specification, an alkyl group is optionally substituted.

“Cycloalkyl” refers to a non-aromatic monocyclic or polycyclic carbocyclic radical consisting solely of carbon and hydrogen atoms, which may include fused or bridged ring systems, having from three to fifteen ring carbon atoms (C₃-C₁₅ cycloalkyl), from three to ten ring carbon atoms (C₃-C₁₀ cycloalkyl), or from three to eight ring carbon atoms (C₃-C₈ cycloalkyl), or any value within these ranges such as three to four carbon atoms (C₃-C₄ cycloalkyl), and which is saturated or partially unsaturated and attached to the rest of the molecule by a single bond. Monocyclic radicals include, for example, cyclopropyl, cyclobutyl, cyclopentyl, cyclohexyl, cycloheptyl, and cyclooctyl. Polycyclic radicals include, for example, adamantyl, norbornyl, decalinyl, 7,7-dimethyl-bicyclo[2.2.1]heptanyl, and the like. Unless otherwise stated specifically in the specification, a cycloalkyl group is optionally substituted.

Aryl groups include groups having one or more 5-, 6-, 7- or 8-membered aromatic rings, including heterocyclic aromatic rings. The term heteroaryl specifically refers to aryl groups having at least one 5-, 6-, 7- or 8-member heterocyclic aromatic ring. Aryl groups can contain one or more fused aromatic rings, including one or more fused heteroaromatic rings, and/or a combination of one or more aromatic rings and one or more nonaromatic rings that may be fused or linked via covalent bonds. Heterocyclic aromatic rings can include one or more N, O, or S atoms in the ring. Heterocyclic aromatic rings can include those with one, two or three N atoms, those with one or two O atoms, and those with one or two S atoms, or combinations of one or two or three N, O or S atoms. Aryl groups are optionally substituted. Substituted aryl groups include among others those that are substituted with alkyl or alkenyl groups, which groups in turn can be optionally substituted. Specific aryl groups include phenyl, biphenyl groups, pyrrolidinyl, imidazolidinyl, tetrahydrofuryl, tetrahydrothienyl, furyl, thienyl, pyridyl, quinolyl, isoquinolyl, pyridazinyl, pyrazinyl, indolyl, imidazolyl, oxazolyl, thiazolyl, pyrazolyl, pyridinyl, benzoxadiazolyl, benzothiadiazolyl, and naphthyl groups, all of which are optionally substituted. Substituted aryl groups include fully halogenated or semihalogenated aryl groups, such as aryl groups having one or more hydrogens replaced with one or more fluorine atoms, chlorine atoms, bromine atoms and/or iodine atoms. Substituted aryl groups include fully fluorinated or semifluorinated aryl groups, such as aryl groups having one or more hydrogens replaced with one or more fluorine atoms. Aryl groups include, but are not limited to, aromatic group-containing or heterocylic aromatic group-containing groups corresponding to any one of the following: benzene, naphthalene, naphthoquinone, diphenylmethane, fluorene, anthracene, anthraquinone, phenanthrene, tetracene, tetracenedione, pyridine, quinoline, isoquinoline, indoles, isoindole, pyrrole, imidazole, oxazole, thiazole, pyrazole, pyrazine, pyrimidine, purine, benzimidazole, furans, benzofuran, dibenzofuran, carbazole, acridine, acridone, phenanthridine, thiophene, benzothiophene, dibenzothiophene, xanthene, xanthone, flavone, coumarin, azulene or anthracycline. As used herein, a group corresponding to the groups listed above expressly includes an aromatic or heterocyclic aromatic group, including monovalent, divalent and polyvalent groups, of the aromatic and heterocyclic aromatic groups listed herein provided in a covalently bonded configuration in the compounds of the disclosure at any suitable point of attachment. In some embodiments, aryl groups contain between 5 and 30 carbon atoms. In some embodiments, aryl groups contain one aromatic or heteroaromatic six-member ring and one or more additional five- or six-member aromatic or heteroaromatic ring. In embodiments, aryl groups contain between five and eighteen carbon atoms in the rings. Aryl groups optionally have one or more aromatic rings or heterocyclic aromatic rings having one or more electron donating groups, electron withdrawing groups and/or targeting ligands provided as substituents.

The term “heteroalkyl,” as used herein, generally refers to an alkyl, alkenyl, or alkynyl group as defined herein, wherein at least one carbon atom of the alkyl group is replaced with a heteroatom. In some instances, heteroalkyl groups may contain from 1 to 18 non-hydrogen atoms (carbon and heteroatoms) in the chain, or from 1 to 12 non-hydrogen atoms, or from 1 to 6 non-hydrogen atoms, or from 1 to 4 non-hydrogen atoms. Heteroalkyl groups may be straight or branched, and saturated or unsaturated. Unsaturated heteroalkyl groups have one or more double bonds and/or one or more triple bonds. Heteroalkyl groups may be unsubstituted or substituted. Exemplary heteroalkyl groups include, but are not limited to, alkoxyalkyl (e.g., methoxymethyl), and aminoalkyl (e.g., alkylaminoalkyl and dialkylaminoalkyl). Heteroalkyl groups may be optionally substituted with one or more substituents.

“Heterocycloalkyl” refers to a non-aromatic monocyclic or polycyclic carbocyclic radical consisting of carbon, hydrogen, and hetero atoms, which may include fused or bridged ring systems, having from three to fifteen membered ring, from three to ten membered ring, or from three to eight membered ring, or any value within these ranges such as three to four membered ring, and which is saturated or partially unsaturated and attached to the rest of the molecule by a single bond. Unless otherwise stated specifically in the specification, a heterocycloalkyl group is optionally substituted.

“Alkyl acrylate” refers to an alkyl group having an acrylate functional group (CH₂═CHCO₂—). Unless otherwise stated specifically in the specification, an alkyl acrylate group is optionally substituted.

“Alkyl methacrylate” refers to an alkyl group having a methacrylate functional group (CH₂═C(CH₃)CO₂—). Unless otherwise stated specifically in the specification, an alkyl methacrylate group is optionally substituted.

“Heteroalkyl acrylate” refers to a heteroalkyl group having an acrylate functional group (CH₂═CHCO₂—). Unless otherwise stated specifically in the specification, a heteroalkyl acrylate group is optionally substituted.

“Heteroalkyl methacrylate” refers to a heteroalkyl group having a methacrylate functional group (CH₂═C(CH₃)CO₂—). Unless otherwise stated specifically in the specification, a heteroalkyl methacrylate group is optionally substituted.

“Cycloalkyl acrylate” refers to a cycloalkyl group having an acrylate functional group (CH₂═CHCO₂—). Unless otherwise stated specifically in the specification, a cycloalkyl acrylate group is optionally substituted.

“Cycloalkyl methacrylate” refers to a cycloalkyl group having a methacrylate functional group (CH₂═C(CH₃)CO₂—). Unless otherwise stated specifically in the specification, a cycloalkyl methacrylate group is optionally substituted.

“Heterocycloalkyl acrylate” refers to a heterocycloalkyl group having an acrylate functional group (CH₂═CHCO₂—). Unless otherwise stated specifically in the specification, a heterocycloalkyl acrylate group is optionally substituted.

“Heterocycloalkyl methacrylate” refers to a heterocycloalkyl group having a methacrylate functional group (CH₂═C(CH₃)CO₂—). Unless otherwise stated specifically in the specification, a heterocycloalkyl methacrylate group is optionally substituted.

“Aryl acrylate” refers to an aryl group having an acrylate functional group (CH₂═CHCO₂—). Unless otherwise stated specifically in the specification, an aryl acrylate group is optionally substituted.

“Aryl methacrylate” refers to an aryl group having a methacrylate functional group (CH₂═C(CH₃)CO₂—). Unless otherwise stated specifically in the specification, an aryl methacrylate group is optionally substituted.

The term “(meth)” when used herein as part of the name of a chemical compound indicates that the chemical compound encompasses species both with and without the methyl group. For instance, “(meth)acrylate” encompasses acrylate and methacrylate.

Unless otherwise defined herein, optional substituents for any alkyl group include substitution with one or more of the following substituents, among others:
halogen, including fluorine, chlorine, bromine or iodine;
pseudohalides, including —CN, —OCN (cyanate), —NCO (isocyanate), —SCN (thiocyanate) and —NCS (isothiocyanate);
—COOR, where R is a hydrogen, an alkyl group, or an aryl group, and more specifically where R is a methyl, ethyl, propyl, butyl, or phenyl group, all of which groups are optionally substituted;
—COR, where R is a hydrogen, an alkyl group, or an aryl group, and more specifically where R is a methyl, ethyl, propyl, butyl, or phenyl group, all of which groups are optionally substituted;
—CON(R)₂, where each R, independently of each other R, is a hydrogen, an alkyl group or an aryl group, and more specifically where R is a methyl, ethyl, propyl, butyl, or phenyl group, all of which groups are optionally substituted; and where R and R can form a ring which can contain one or more double bonds and can contain one or more additional carbon atoms;
—OCON(R)₂, where each R, independently of each other R, is a hydrogen, an alkyl group or an aryl group, and more specifically where R is a methyl, ethyl, propyl, butyl, or phenyl group, all of which groups are optionally substituted; and where R and R can form a ring which can contain one or more double bonds and can contain one or more additional carbon atoms;
—N(R)₂, where each R, independently of each other R, is a hydrogen, an alkyl group, an acyl group, or an aryl group, and more specifically where R is a methyl, ethyl, propyl, butyl, phenyl or acetyl group, all of which are optionally substituted; and where R and R can form a ring that can contain one or more double bonds and can contain one or more additional carbon atoms;
—SR, where R is hydrogen, an alkyl group, or an aryl group, and more specifically where R is hydrogen, methyl, ethyl, propyl, butyl, or a phenyl group, which are optionally substituted;
—SO₂R, or —SOR, where R is an alkyl group or an aryl group, and more specifically where R is a methyl, ethyl, propyl, butyl, or phenyl group, all of which are optionally substituted;
—OCOOR, where R is an alkyl group or an aryl group;
—SO₂N(R)₂, where each R, independently of each other R, is a hydrogen, an alkyl group, or an aryl group, all of which are optionally substituted; and wherein R and R can form a ring that can contain one or more double bonds and can contain one or more additional carbon atoms; and —OR, where R is H, an alkyl group, an aryl group, or an acyl group, all of which are optionally substituted. In a particular example, R can be an acyl yielding —OCOR″, where R″ is a hydrogen, an alkyl group, or an aryl group, and more specifically where R″ is a methyl, ethyl, propyl, butyl, or phenyl group, all of which groups are optionally substituted.

Specific substituted alkyl groups include haloalkyl groups, particularly trihalomethyl groups and specifically trifluoromethyl groups. Specific substituted aryl groups include mono-, di-, tri, tetra- and pentahalo-substituted phenyl groups; mono-, di-, tri-, tetra-, penta-, hexa-, and hepta-halo-substituted naphthalene groups; 3- or 4-halo-substituted phenyl groups, 3- or 4-alkyl-substituted phenyl groups, 3- or 4-alkoxy-substituted phenyl groups, 3- or 4-RCO-substituted phenyl, 5- or 6-halo-substituted naphthalene groups. More specifically, substituted aryl groups include acetylphenyl groups, particularly 4-acetylphenyl groups; fluorophenyl groups, particularly 3-fluorophenyl and 4-fluorophenyl groups; chlorophenyl groups, particularly 3-chlorophenyl and 4-chlorophenyl groups; methylphenyl groups, particularly 4-methylphenyl groups; and methoxyphenyl groups, particularly 4-methoxyphenyl groups.

As to any of the above groups that contain one or more substituents, it is understood that such groups do not contain any substitution or substitution patterns which are sterically impractical and/or synthetically non-feasible. In addition, as further described herein, the compounds of this disclosure can include all stereochemical isomers (and racemic mixtures) arising from the substitution of these compounds.

The headings provided herein are for convenience only and do not interpret the scope or meaning of the claimed present technology. Embodiments under any one heading may be used in conjunction with embodiments under any other heading.

### I. Compositions and Materials for Dental Appliances and Associated Methods

### A. Polymerizable Compositions

In some embodiments, the present disclosure provides polymerizable compositions (also referred to as “curable resins”). In some embodiments, the polymerizable composition is a photocurable composition. In some embodiments, the polymerizable composition is a thermocurable composition. In some embodiments, the polymerizable composition is a combination of a photocurable composition and a thermocurable composition. Although certain embodiments of the present technology are described herein in connection with photocurable groups (e.g., UV-curable groups) and photoinitiators, this is not intended to be limiting, and the present technology can also utilize thermally curable groups and thermal initiators.

The polymerizable composition can comprise a plurality (e.g., greater than 1) of polymerizable components, such as one or more monomers, oligomers, and/or reactive polymers. As described herein, such polymerizable components can include one or more species (e.g., 1, 2, 3, or more different species), such as one or more species of polymerizable monomers (e.g., reactive diluents), and/or one or more species of reactive (e.g., telechelic and/or side-functionalized) oligomers and/or polymers (e.g., toughness modifiers). Polymerizable compositions provided herein can form polymeric materials with advantageous mechanical properties (e.g., shock absorption), improved stain resistance and/or reduced water uptake, reduced leaching of (e.g., unreacted) resin components (e.g., monomers) from the cured material, and/or increased phase separation while providing a more continuous and uniform polymer matrix.

In some embodiments, a polymerizable composition is provided, the polymerizable composition comprising a polymerizable compound, a reactive diluent, and an initiator (e.g., a photoinitiator). The polymerizable compound can include a non-polar unit and a polar unit substituted with one or more curable groups (e.g., UV-curable groups). The types of non-polar unit and polar unit used, as well as the ratio of the non-polar unit to the polar unit, can be selected to control the properties of the polymeric material that is prepared from curing of the polymerizable composition. For instance, the non-polar unit can be a hydrophobic molecule, which can improve the stain resistance of the polymeric material. Moreover, the non-polar unit can exhibit little or no hydrogen bonding (e.g., the non-polar unit has few or no functional groups capable of forming hydrogen bonds, such as hydroxyl groups, amine groups, carboxylic acid groups, etc.), which can increase the elasticity of the polymeric material. The polar unit can be a hydrophilic molecule that has been substituted with one or more curable groups to allow the polymerizable compound to be polymerized (e.g., with other polymerizable compounds and/or the reactive diluent) to form the polymeric material. In some embodiments, the ratio of the non-polar unit to the polar unit in the polymerizable compound can control the softness and elasticity of the polymeric material, which in turn can affect the shock absorption properties of the polymeric material (e.g., the polymeric material exhibits low rebound values under impact testing). For example, a higher ratio of the non-polar unit to the polar unit can result in higher elasticity, improved shock absorption, etc. Moreover, a higher ratio of the non-polar unit to the polar unit can reduce the water uptake of the polymeric material, which may be beneficial for improving the stain resistance of the polymeric material.

Additional details and examples of components that may be present in a polymerizable composition of the present technology are provided in Sections I.A.1-1.A.5 below.

### 1. Polymerizable Compounds

The polymerizable compositions of the present disclosure can comprise a polymerizable compound that may react with other polymerizable components (e.g., other polymerizable compounds, a reactive diluent) to produce a polymeric material. The polymerizable compound may be a chain composed of a plurality of repeating units, such as an oligomer or a polymer. The repeating units of the chain may include a plurality of non-polar units, a plurality of polar units, or a combination thereof.

In some embodiments, the polymerizable compound (e.g., oligomer or polymer) has a number average molecular weight of greater than or equal to 500 g/mol, greater than or equal to 1,000 g/mol, greater than or equal to 1,500 g/mol, greater than or equal to 2,000 g/mol, greater than or equal to 5,000 g/mol, greater than or equal to 10,000 g/mol, greater than or equal to 17,000 g/mol, greater than or equal to 35,000 g/mol, or greater than or equal to 50,000 g/mol; and/or a number average molecular weight within a range from 700 g/mol to 50,000 g/mol, from 1,000 g/mol to 30,000 g/mol, from 1000 g/mol to 20,000 g/mol, from 2000 g/mol to 50,000 g/mol, from 2,000 g/mol to 30,000 g/mol, or from 2,000 g/mol to 20,000 g/mol. The number average molecular weight of the polymerizable compound may be determined via gel permeation chromatography (GPC) in accordance with techniques known in the art, e.g., using an Agilent 1260 Infinity II GPC system with VWD+Wyatt DAWN+Wyatt Optilab detectors, an Agilent PLgel 10E3A column (300 mm×7.5 mm×5 m) (or equivalent), an Agilent PLgel Guard (50 mm×7.5 mm×5 m) (or equivalent), tetrahydrofuran as the mobile phase, and a polystyrene standard.

In some embodiments, the concentration of the polymerizable compound in the polymerizable composition is at least 10 wt %, 20 wt %, 30 wt %, 40 wt %, 50 wt %, 60 wt %, 70 wt %, 80 wt %, or 90 wt %, based on the total weight of the polymerizable composition; and/or is no more than 90 wt %, 80 wt %, 70 wt %, 60 wt %, 50 wt %, 40 wt %, 30 wt %, 20 wt %, or 10 wt %, based on the total weight of the polymerizable composition. In some embodiments, the concentration of the polymerizable compound in the polymerizable composition is within a range from 10 wt % to 90 wt %, from 10 wt % to 80%, from 10 wt % to 70%, from 10 wt % to 60 wt %, from 10 wt % to 50 wt %, from 10 wt % to 40 wt %, from 10 wt % to 30 wt %, from 10 wt % to 20 wt %, from 20 wt % to 90 wt %, from 20 wt % to 80 wt %, from 20 wt % to 70 wt %, from 20 wt % to 60 wt %, from 20 wt % to 50 wt %, from 20 wt % to 40 wt %, from 20 wt % to 30 wt %, from 30 wt % to 90 wt %, from 30 wt % to 80 wt %, from 30 wt % to 70 wt %, from 30 wt % to 60 wt %, from 30 wt % to 50 wt %, from 30 wt % to 40 wt %, from 40 wt % to 90 wt %, from 40 wt % to 80 wt %, from 40 wt % to 70 wt %, from 40 wt % to 60 wt %, from 40 wt % to 50 wt %, from 50 wt % to 90 wt %, from 50 wt % to 80 wt %, from 50 wt % to 70 wt %, from 50 wt % to 60 wt %, from 60 wt % to 90 wt %, from 60 wt % to 80 wt %, from 60 wt % to 70 wt %, from 70 wt % to 90 wt %, from 70 wt % to 80 wt %, or from 80 wt % to 90 wt %, based on the total weight of the polymerizable composition. In some embodiments, the polymerizable compound is present at a concentration within a range from 30 wt % to 90 wt % based on the total weight of the polymerizable composition. In some embodiments, the polymerizable compound is present at a concentration within a range from 30 wt % to 70 wt % based on the total weight of the polymerizable composition.

a. Polymerizable Compounds with Interspersed Non-Polar and Polar Units

In some embodiments, the polymerizable compound comprises a chain composed of (e.g., comprising, consisting essentially of, or consisting of) a plurality of non-polar units and a plurality of polar units. The non-polar units may be interspersed with the polar units in the chain, e.g., in a random arrangement, in an alternating arrangement, in a block arrangement, or any other suitable arrangement. In some embodiments, the polymerizable compound is an oligomer or a polymer, and the non-polar units and the polar units are the repeating units of the oligomer/polymer. The non-polar unit can correspond to a first monomer and the polar unit can correspond to a second monomer, where the first and second monomers are copolymerized with each other to form the oligomer/polymer.

In some embodiments, a polymerizable composition is provided, the polymerizable composition comprising:
a) a polymerizable compound (e.g., an oligomer or polymer), optionally having a number average molecular weight of at least 1,000 g/mol, the polymerizable compound comprising:
   i) a non-polar unit, and
   ii) a polar unit substituted with one or more curable groups (e.g., UV-curable groups),
   wherein the ratio of the non-polar unit to the polar unit in the polymerizable compound is at least 1:5 by weight;
b) a reactive diluent comprising C₁-C₂₄ alkyl acrylate, C₁-C₂₄ alkyl methacrylate, C₁-C₂₄ cycloalkyl acrylate, C₁-C₂₄ cycloalkyl methacrylate, heteroalkyl acrylate, heteroalkyl methacrylate, heterocyclyl acrylate, heterocyclyl methacrylate aryl acrylate, or aryl methacrylate; and
c) an initiator (e.g., a photoinitiator).

In some embodiments, a polymerizable composition is provided, the polymerizable composition comprising:
a) a polymerizable compound (e.g., an oligomer or polymer), optionally having a number average molecular weight of at least 1,000 g/mol, the polymerizable composition comprising:
   i) a non-polar unit, and
   ii) a polar unit substituted with one or more curable groups (e.g., UV-curable groups),
   wherein a ratio of the non-polar unit to the polar unit in the polymerizable compound is at least 1:5 by weight;
b) a reactive diluent having a structure of Formula (I):

X—Y Formula (I),
wherein:
X is a linear, branched or cyclic, bicyclic or polycyclic C₅-C₄₀ aliphatic, heterocyclic or aromatic residue of one or more of the group consisting of methyl, ethyl, propyl, butyl, pentyl, hexyl, 2-ethylhexyl, octyl, decanyl, dodecanyl, acetic, propanoic, butanoic, pentanoic, undecanoic, dodecanoic, benzoic acid and corresponding esters, alkyl or aromatic esters, phenyl, benzyl, phenethyl, biphenyl, naphthyl, anthracenyl, pyrenyl, cyclopropyl, cyclobutyl, cyclopentyl, cyclohexyl, 4-isobutylcyclohexyl, cycloheptyl, cyclooctyl, adamantyl, isobornyl, salicyl, syringyl, and cholesteryl, wherein the one or more of the groups are individually linked via an ester, amide, urea, urethane, carbonate, ether, or thioether group, each of which are optionally substituted with one or more C₁-C₆ alkyl, C₁-C₆ alkoxy, C₃-C₇-cycloalkyl, C₆-C₁₀-aryl, C₁-C₆ thioether, halogen, —NO₂, —SO₃H, —CF₃, —OH, —NH₂, —SH, —CN, -trimethoxysilyl, or -triethoxysilyl; and
Y is (meth)acrylate, (meth)acrylamide, vinyl ester, vinyl ether, vinyl amide, N-vinyl compounds, vinyl carbonate, vinyl carbamate, maleimide, itaconate, fumarate, styrene compounds, or a derivative thereof, each of which are optionally substituted with one or more C₁-C₆ alkyl, C₁-C₆ alkoxy, C₁-C₆ thioether, halogen, —NO₂, —SO₃H, —CF₃, —OH, —NH₂, —SH, —CN, -trimethoxysilyl, or -triethoxysilyl; and
c) an initiator (e.g., a photoinitiator).

In some embodiments, the non-polar unit of any of the foregoing comprises aliphatic hydrocarbon, isoprene, butadiene, hydrogenated isoprene, hydrogenated butadiene, an aromatic compound, or hydrophobic siloxane. In some embodiments, the non-polar unit comprises isoprene. In some embodiments, the aromatic compound of the non-polar unit is polyethylene terephthalate.

In some embodiments, the non-polar unit comprises an isoprene unit having a structure of Formula (II):

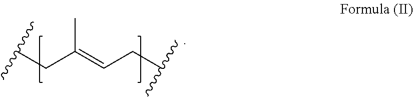

In some embodiments, the polymerizable compound comprises n isoprene units having the structure of Formula (II), where n is an integer from 1 to 10, 1 to 100, 1 to 1,000, or 1 to 10,000.

In some embodiments, the polar unit comprises an isoprene unit that has been functionalized with one or more polar groups, and with one or more curable groups. In some embodiments, the polar unit comprises maleinized isoprene units, which are further functionalized with (meth)acrylates in a second step.

In some embodiments, the polar unit comprises an isoprene unit that has been functionalized with polar groups and UV curable groups, the functionalized isoprene unit having a structure of Formula (III):

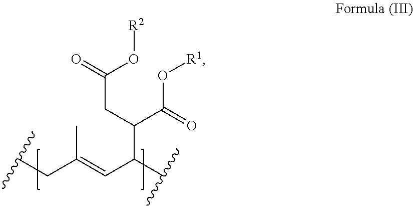

wherein:
R₁ is H, alkyl, cycloalkyl, aryl, or a UV-curable group (e.g., (meth)acrylate); and
R₂ is a UV-curable group (e.g., (meth)acrylate).

In some embodiments, the polymerizable compound comprises m functionalized isoprene units having the structure of Formula (III), where m is an integer from 1 to 10, 1 to 100, 1 to 1,000, or 1 to 10,000.

In some embodiments, the polar unit comprises a functionalized isoprene unit having a structure of Formula (IV):

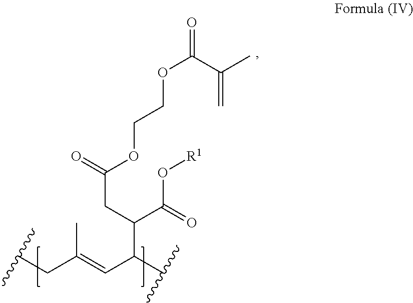

wherein R₁ is H, alkyl, cycloalkyl, aryl, or a UV-curable group (e.g., (meth)acrylate).

In some embodiments, the polymerizable compound comprises m functionalized isoprene units having the structure of Formula (IV), where m is an integer from 1 to 10, 1 to 100, 1 to 1,000, or 1 to 10,000.

In some embodiments, the polymerizable compound comprises a structure of Formula (V):

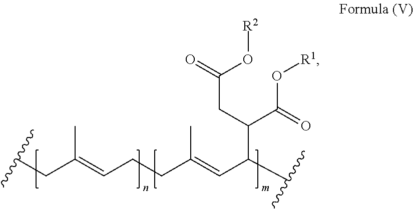

wherein:
R₁ is H, alkyl, cycloalkyl, aryl, or a UV-curable group (e.g., (meth)acrylate);
R₂ is a UV-curable group (e.g., (meth)acrylate);
n is an integer from 1 to 10, 1 to 100, 1 to 1,000, or 1 to 10,000; and
m is an integer from 1 to 10, 1 to 100, 1 to 1,000, or 1 to 10,000.

In some embodiments, the polymerizable compound comprises a structure of Formula (VI):

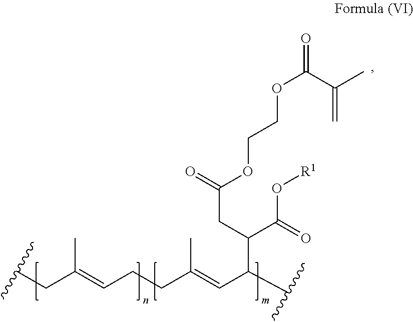

wherein:
R₁ is H, alkyl, cycloalkyl, aryl, or a UV-curable group (e.g., (meth)acrylate);
n is an integer from 1 to 10, 1 to 100, 1 to 1,000, or 1 to 10,000; and
m is an integer from 1 to 10, 1 to 100, 1 to 1,000, or 1 to 10,000.

In some embodiments, a polymerizable compound that is composed of isoprene units (non-polar units) and functionalized isoprene units (polar units) is a curable isoprene resin, such as a UV-curable isoprene resin. Representative examples of UV-curable isoprene resins include those available from Kuraray, such as product numbers UC-203M and UC-102M.

The ratio of the non-polar unit to the polar unit in the polymerizable compound can be varied as desired. In some embodiments, a ratio of the non-polar unit to the polar unit is about 1:2 by weight. In some embodiments, a ratio of the non-polar unit to the polar unit is about 1:1 by weight. In some embodiments, a ratio of the non-polar unit to the polar unit is about 5:1 by weight. In some embodiments, a ratio of the non-polar unit to the polar unit is about 25:1 by weight. In some embodiments, a ratio of the non-polar unit to the polar unit is about 28:1 by weight. In some embodiments, a ratio of the non-polar unit to the polar unit is about 35:1 by weight. In some embodiments, a ratio of the non-polar unit to the polar unit is about 38:1 by weight. In some embodiments, a ratio of the non-polar unit to the polar unit is higher than 1:2 by weight. In some embodiments, a ratio of the non-polar unit to the polar unit is higher than 1:1 by weight. In some embodiments, a ratio of the non-polar unit to the polar unit is higher than 5:1 by weight. In some embodiments, a ratio of the non-polar unit to the polar unit is higher than 20:1 by weight. In some embodiments, a ratio of the non-polar unit to the polar unit is higher than 25:1 by weight. In some embodiments, a ratio of the non-polar unit to the polar unit is higher than 30:1 by weight. In some embodiments, a ratio of the non-polar unit to the polar unit is higher than 35:1 by weight.

b. Polymerizable Compounds with a Non-Polar Chain and Polar Chain Ends

In some embodiments, the polymerizable compound comprises a chain composed of (e.g., comprising, consisting essentially of, or consisting of) a plurality of non-polar units and one or more polar units located at one or more ends of the chain. For example, the chain can be an oligomer or polymer having a plurality of chain ends (e.g., 2, 3, 4, 5, 6, or more), the non-polar units can be the repeating units of the oligomer/polymer, and the polar units can be located at the chain ends of the oligomer/polymer.

In some embodiments, a polymerizable composition is provided, the polymerizable composition comprising:
a) a polymerizable compound (e.g., an oligomer or polymer), optionally having a number average molecular weight of at least 1,000 g/mol, the polymerizable compound comprising:
   i) a multifunctional chain (e.g., di-, tetra-, or hexafunctional) comprising a plurality of non-polar units, and
   ii) a polar unit substituted with one or more curable groups (e.g., UV-curable groups),
   wherein the ratio of the non-polar unit to the polar unit is at least 1:5 by weight;
b) a reactive diluent comprising C₁-C₂₄ alkyl acrylate, C₁-C₂₄ alkyl methacrylate, C₁-C₂₄ cycloalkyl acrylate, C₁-C₂₄ cycloalkyl methacrylate, heteroalkyl acrylate, heteroalkyl methacrylate, heterocyclyl acrylate, heterocyclyl methacrylate aryl acrylate, or aryl methacrylate; and
c) an initiator (e.g., a photoinitiator).

In some embodiments, the multifunctional chain comprises multifunctional aliphatic alcohol, amine, isocyanate, acid, or a combination thereof. In some embodiments, the multifunctional chain comprises aliphatic diol, diamine, diacid, diisocyanate, butadiene diol, hydrogenated butadiene diol, or siloxane diol.

In some embodiments, the multifunctional chain is a difunctional chain (e.g., a chain having two functional ends). In some embodiments, the multifunctional chain is a trifunctional chain (e.g., a chain having three functional ends). In some embodiments, the multifunctional chain is a tetrafunctional chain (e.g., a chain having four functional ends). In some embodiments, the multifunctional chain is a hexafunctional chain (e.g., a chain having six functional ends).

In some embodiments, the polymerizable composition is a dumbbell oligomer or polymer. Types of the dumbbell oligomer/polymer are illustrated below in Scheme 1:

wherein:
a is a chain composed of a plurality of non-polar units; and
b is a polar unit substituted with one or more curable groups.

In some embodiments, the curable group is a UV-curable group, and the UV-curable group is (meth)acrylate, vinyl ether, vinyl ester, or maleimide.

In some embodiments, the UV-curable group has a structure of Formula (X):

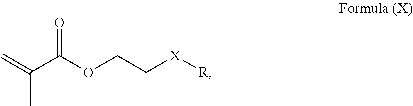

wherein:
R is alkyl, cycloalkyl, aryl; and
X is —COO or —NHCO.

In some embodiments, the polymerizable compound has a structure of Formula (Y):

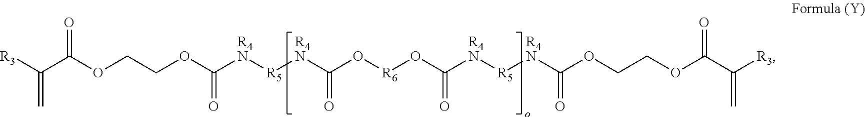

wherein:
R₃ is H or alkyl;
R₄ is H, alkyl, cycloalkyl, or aryl;
R₅ is alkyl, cycloalkyl, or aryl;
R₆ is alkyl, cycloalkyl, hydrogenated poly(butadiene), poly(butadiene), aliphatic polyether, or aliphatic polyester; and
o is an integer from 1 to 10, 1 to 100, 1 to 1,000, or 1 to 10,000.
   In Formula (Y), R₆ is the non-polar unit, the component in brackets represents the chain composed of a plurality of the non-polar units (in this case, the chain is difunctional), and the remaining components of Formula (Y) represent the polar units substituted with one or more UV-curable groups at the ends of the chain.

In some embodiments, the polymerizable compound is a tetrafunctional aliphatic urethane methacrylate (e.g., MIRAMER U3400NT), an aliphatic urethane di(meth)acrylate oligomer (e.g., Ebecryl 8811, SUO-1020NI, MIRAMER U3620NT, BR-374, ETERCURE AM-U206, ETERCURE AM-U308), a polyurethane (meth)acrylate (e.g., SHIKOH UV-3300B, MIRAMER U3620NT, MIRAMER U3195), a polyether urethane (meth)acrylate (e.g., BR-541 MB, BR-573M, BR-1044 MB), a hydrophobic urethane (meth)acrylate such as difunctional aliphatic polybutadiene urethane acrylate (e.g., BR-641E, BR-641TF, BR-641S) or urethane acrylate oligomers modified with hydrogenated polybutadiene (e.g., SUO-H8803), or a polyester urethane (meth)acrylate (e.g., BR-744 BT, BR-7432 GB).

In some embodiments, the polar unit comprises methacrylate or acrylate. In some embodiments, the polar unit comprises methacrylate. In some embodiments, the polar unit comprises acrylate.

In some embodiments, the polar unit comprises diisocyanate or diacid. In some embodiments, the polar unit comprises diisocyanate. In some embodiments, the polar unit comprises diacid. In some embodiments, the polar unit comprises diisocyanate or diacid substituted with methacrylate or acrylate.

In some embodiments, the polar unit comprises isocyanate or acid. In some embodiments, the polar unit comprises isocyanate. In some embodiments, the polar unit comprises acid. In some embodiments, the polar unit comprises isocyanate or acid substituted with methacrylate or acrylate.

The ratio of the non-polar unit to the polar unit in the polymerizable compound can be varied as desired. In some embodiments, a ratio of the non-polar unit to the polar unit is about 1:2 by weight. In some embodiments, a ratio of the non-polar unit to the polar unit is about 1:1 by weight. In some embodiments, a ratio of the non-polar unit to the polar unit is about 5:1 by weight. In some embodiments, a ratio of the non-polar unit to the polar unit is about 25:1 by weight. In some embodiments, a ratio of the non-polar unit to the polar unit is about 28:1 by weight. In some embodiments, a ratio of the non-polar unit to the polar unit is about 35:1 by weight. In some embodiments, a ratio of the non-polar unit to the polar unit is about 38:1 by weight. In some embodiments, a ratio of the non-polar unit to the polar unit is higher than 1:2 by weight. In some embodiments, a ratio of the non-polar unit to the polar unit is higher than 1:1 by weight. In some embodiments, a ratio of the non-polar unit to the polar unit is higher than 5:1 by weight. In some embodiments, a ratio of the non-polar unit to the polar unit is higher than 20:1 by weight. In some embodiments, a ratio of the non-polar unit to the polar unit is higher than 25:1 by weight. In some embodiments, a ratio of the non-polar unit to the polar unit is higher than 30:1 by weight. In some embodiments, a ratio of the non-polar unit to the polar unit is higher than 35:1 by weight.

In some embodiments, a ratio of the multifunctional chain to the polar unit is about 1:2 by weight. In some embodiments, a ratio of the multifunctional chain to the polar unit is about 1:1 by weight. In some embodiments, a ratio of the multifunctional chain to the polar unit is about 4:1 by weight. In some embodiments, a ratio of the multifunctional chain to the polar unit is about 5:1 by weight. In some embodiments, a ratio of the multifunctional chain to the polar unit is at least 1:2 by weight. In some embodiments, a ratio of the multifunctional chain to the polar unit is at least 1:1 by weight. In some embodiments, a ratio of the multifunctional chain to the polar unit is at least 4:1 by weight. In some embodiments, a ratio of the multifunctional chain to the polar unit is at least 5:1 by weight.

### 2. Reactive Diluents

The polymerizable compositions of the present disclosure can further comprise a reactive diluent (e.g., a monomer) that may react with the polymerizable compound to produce a polymeric material. The reactive diluent may serve to reduce the viscosity of the polymerizable composition to a level suitable for fabrication processes (e.g., additive manufacturing processes), as described further below. In some embodiments, the reactive diluent is monofunctional. In some embodiments, the reactive diluent is multifunctional (e.g., difunctional, trifunctional, tetrafunctional, hexafunctional).

Some non-limiting examples for reactive diluents include monofunctional (meth)acrylates, (meth)acrylamides, vinyl esters, and N-vinyl compounds. In some embodiments, the reactive diluent is a methacrylate, such as propyl methacrylate, butyl methacrylate, pentyl methacrylate, hexyl methacrylate, ethyl hexyl methacrylate, adamantyl methacrylate, or thiol-methacrylate. In some embodiments, the reactive diluent is an acrylate, such as propyl acrylate, butyl acrylate, pentyl acrylate, hexyl acrylate, ethyl hexyl acrylate, adamantyl acrylate, or thiol-acrylate.

In some embodiments, the reactive diluent is a (meth)acrylate. Examples of (meth)acrylates that may be used as the reactive diluent include isobornyl (meth)acrylate, cyclohexyl (meth)acrylate, trimethyl-cyclohexyl (meth)acrylate, glycerol formal (meth)acrylate, tricyclodecane methanol mono(meth)acrylate, 4-tert-butylcyclohexyl (meth)acrylate, benzyl (meth)acrylate, phenoxyethyl (meth)acrylate, cyclic trimethylolpropane formal (meth)acrylate. salicylate (meth)acrylate, cholesteryl (meth)acrylate, biphenyl (meth)acrylate, and syringyl (meth)acrylate.

In some embodiments, the reactive diluent is a salicylate (meth)acrylate. In some embodiments, the salicylate (meth)acrylate is 2-(methacryloyloxy)benzoic acid cyclopentyl ester, 2-(methacryloyloxy)benzoic acid cyclohexyl ester, 2-(methacryloyloxy)benzoic acid-2-isopropyl-5-methylcyclohexyl ester, 3-(methacryloyloxy)benzoic acid-2-isopropyl-5-methylcyclohexyl ester, 4-(methacryloyloxy)benzoic acid-2-isopropyl-5-methylcyclohexyl ester, 2-(methacryloyloxy)benzoic acid-3,3,5-trimethylcyclohexyl ester, 2-(acryloyloxy)benzoic acid-3,3,5-trimethylcyclohexyl ester, 2-(methacryloyloxy)benzoic acid decahydronaphthalen-2-yl ester, 2-(methacryloyloxy)benzoic acid-1,3,3-trimethyl-2-bicyclo[2.2.1]heptanyl ester, 2-(methacryloyloxy)benzoic acid-1,7,7-trimethyl-2-bicyclo[2.2.1]heptanyl ester, 2-(methacryloyloxy)benzoic acid-bicyclo[2.2.1]heptan-2-yl methyl ester, 2-(methacryloyloxy)benzoic acid-2-cyclohexylethyl ester, 2-(methacryloyloxy)benzoic acid benzyl ester, 4-(methacryloyloxy)benzoic acid benzoate, 3-(methacryloyloxy)benzoic acid-4-isopropylbenzyl ester, 2-(acryloyloxy)benzoic acid benzyl ester, 2-(methacryloyloxy)benzoic acid phenethyl ester, 4-(methacryloyloxy)-3-methoxybenzoic acid-3-methoxybenzyl ester, 2-(methacryloyloxy)benzoic acid-1-phenylethyl ester, 4-((methacryloyloxy)methyl)benzoic acid cycloheptyl ester, or 2-(methacryloyloxy)benzoic acid cyclohexyl methyl ester.

In some embodiments, the reactive diluent comprises a compound having one of the following structures:

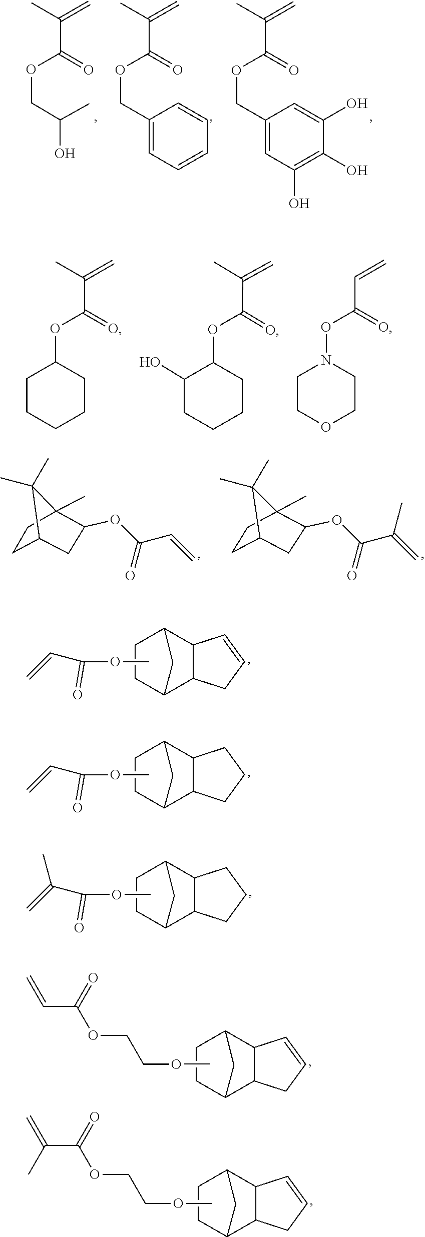

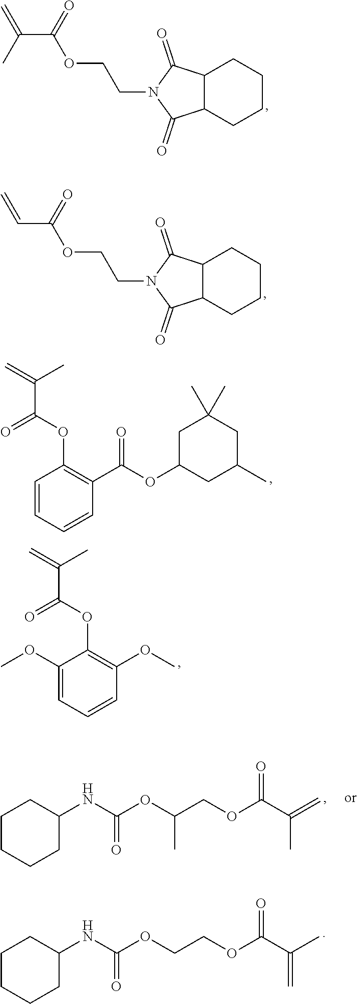

In some embodiments, the reactive diluent comprises a compound having one of the following structures:

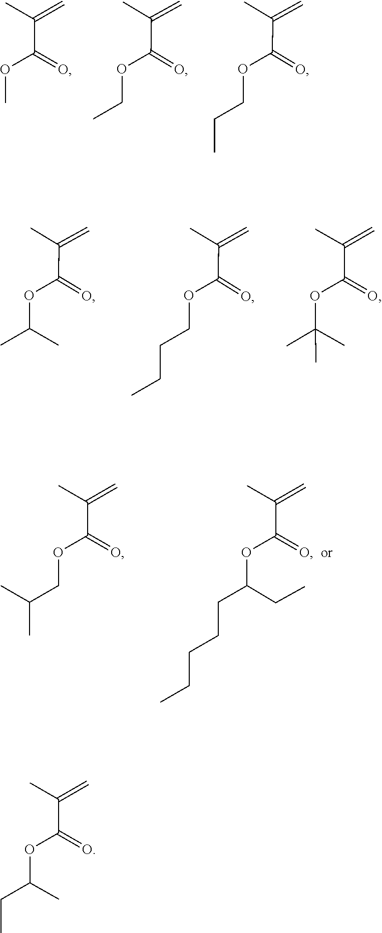

In some embodiments, the reactive diluent is a monomer that forms homopolymers and/or polymer backbones upon curing comprising rigid groups such as cyclic, bicyclic or polycyclic C₅-C₄₀ aliphatic, heterocyclic, or aromatic residues. In some embodiments, the reactive diluent is a monomer that forms homopolymers or polymer backbones upon curing with a T_{g} higher than 25 °C, higher than 40 °C, higher than 60 °C, higher than 70 °C, or higher than 100 °C, and/or a T_{g} within a range from 50 °C to 100 °C, from 80 °C to 120 °C, from 100 °C to 150 °C, from 120 °C to 160 °C, or from 150 °C to 200 °C. In some embodiments, the respective polymer backbones are formed via thermal or photochemical curing reactions, which are polymerization methods known to the person skilled in the field.

In some embodiments, a reactive diluent can comprise an acrylate or methacrylate moiety for incorporation into a polymeric backbone, coupled to a linear or cyclic (e.g., mono-, bi-, or tricyclic) side-chain moiety. Generally, any aliphatic, cycloaliphatic, or aromatic molecule with a mono-functional polymerizable reactive functional group can be used (e.g., including liquid crystalline monomers). In some embodiments, the polymerizable reactive functional group is an acrylate or methacrylate group. In some embodiments, a reactive diluent is a syringol, guaiacol, or vanillin derivative, e.g., homosalic methacrylate (HSMA), syringyl methacrylate (SMA), isobornyl methacrylate (IBOMA), 2-hydroxy cyclohexyl methacrylate (HCMA), isobornyl acrylate (IBOA), 4-acryloylmorpholine (ACMO), etc.

In some embodiments, the reactive diluent is present at a concentration within a range from 10 wt % to 60 wt % based on the total weight of the polymerizable composition. In some embodiments, the concentration of reactive diluent is within a range from 25 wt % to 65 wt %. In some embodiments, the concentration of reactive diluent is within a range from 5 wt % to 90 wt %, 5 wt % to 80 wt %, 5 wt % to 70 wt %, 5 wt % to 60 wt %, 5 wt % to 50 wt %, 5 wt % to 40 wt %, 5 wt % to 30 wt %, 5 wt % to 20 wt %, 5 wt % to 10 wt %, 10 wt % to 70 wt %, 20 wt % to 70 wt %, 30 wt % to 70 wt %, 40 wt % to 70 wt %, 50 wt % to 70 wt %, 50 wt % to 60 wt %, or 30 wt % to 50 wt %. In some embodiments, the concentration of reactive diluent is within a range from 30 wt % to 60 wt %. In some embodiments, the polymerizable composition comprises from 10 wt % to 80 wt % of reactive diluent. In some embodiments, the polymerizable composition comprises from 0.5 wt % to 99.5 wt %, 1 wt % to 99 wt %, 10 wt % to 95 wt %, 20 wt % to 90 wt %, 25 wt % to 60 wt %, or 35 wt % to 50 wt % of the reactive diluent.

A reactive diluent used herein can have a low vapor pressure. In some embodiments, a reactive diluent of the present disclosure can have a low vapor pressure at an elevated temperature and/or a high boiling point, compared to conventional reactive diluents or other polymerizable components used in polymerizable compositions. Such low vapor pressure can be particularly advantageous for use of such a reactive diluent in curable (e.g., photocurable) compositions and additive manufacturing where elevated temperatures (e.g., 50 °C, 60 °C, 70 °C, 80 °C, 90 °C, or higher) may be used. In some embodiments, a reactive diluent can have a vapor pressure of at most about 12 Pa at 60 °C, or lower. In some embodiments, a reactive diluent can have a vapor pressure of at most about 2 Pa to 10 Pa at 60 °C. In some embodiments, a reactive diluent can have a vapor pressure of at most about 2 Pa to 5 Pa at 60 °C. Thus, in some embodiments, a reactive diluent of the present disclosure can have a low mass loss at an elevated temperature. As used herein, a mass loss of a compound at a certain temperature (e.g., 90 °C) for a certain period (e.g., 2 hours) can be used as a measure for volatility of such compounds. Herein, “substantially no volatility” can refer to a mass loss less than 1 wt % at the respective temperature, e.g., at 90 °C for 2 hours. In various instances, a reactive diluent of the present disclosure can have a mass loss less than 1 wt % at the respective temperature at 90 °C after heating at that temperature for 2 hours. In some embodiments, a reactive diluent can have a mass loss of less than about 0.5% after heating at 90 °C for 2 h. In some embodiments, a reactive diluent can have a mass loss within a range from about 0.1% to about 0.45% after heating at 90 °C for 2 h. In some embodiments, a reactive diluent can have a mass loss within a range from about 0.05% to about 0.25% after heating at 90 °C for 2 h.

In some embodiments, the polymerizable composition comprises a first reactive diluent and a second reactive diluent. In some embodiments, the first and/or second reactive diluent comprise an alkyl acrylate, an alkyl methacrylate, a cycloalkyl acrylate, a cycloalkyl methacrylate, a homosalic acrylate, a homosalic methacrylate, or combinations thereof. In some embodiments, the second reactive diluent is a homosalic acrylate, a homosalic methacrylate, or combinations thereof. In some embodiments, the polymerizable composition comprises from 25 wt % to 35 wt % of the first reactive diluent and from 10% to 50% of the second reactive diluent.

In some embodiments, however, no or only low amounts (e.g., 5% w/w or less) of a reactive diluent may be used.

### 3. Initiators

In some embodiments, a polymerizable composition as described herein is a photocurable composition, such as a photocurable resin. Such photocurable resins described herein can further comprise one or more photoinitiators. Such photoinitiators, when activated with light of an appropriate wavelength (e.g., UV or visible light) can initiate a polymerization reaction (e.g., during photocuring) between monomers and themselves and/or other potentially polymerizable components that may be present in the photocurable resin (e.g., polymerizable compounds, reactive diluents), to form a polymeric material as further described herein. Generally, photoinitiators described in the present disclosure can include those that can be activated with light and initiate polymerization of the polymerizable components of the formulation. A “photoinitiator,” as used herein, may generally refer to a compound that can produce radical species and/or promote radical reactions upon exposure to radiation (e.g., UV or visible light). In some embodiments, the photoinitiator increases the speed of the curing step.

In some embodiments, the photoinitiator is a free radical photoinitiator. In some embodiments, the free radical photoinitiator comprises an alpha hydroxy ketone moiety (e.g., 2-hydroxy-2-methylpropiophenone or 1-hydroxycyclohexyl phenyl ketone), an alpha-amino ketone (e.g., 2-benzyl-2-(dimethylamino)-4′-morpholinobutyrophenone or 2-methyl-1-[4-(methylthio)phenyl]-2-morpholinopropan-1-one), 4-methyl benzophenone, an azo compound (e.g., 4,4′-azobis(4-cyanovaleric acid), 1,1′-azobis(cyclohexanecarbonitrile, azobisisobutyronitrile, 2,2′-azobis(2-methylpropionitrile), or 2,2′-azobis(2-methylpropionitrile)), an inorganic peroxide, an organic peroxide, or any combination thereof. In some embodiments, the composition comprises a photoinitiator comprising SpeedCure TPO-L (ethyl(2,4,6-trimethylbenzoyl)phenyl phosphinate), 2,4,6-trimethylbenzoyl diphenyl phosphine oxide (TPO), phenyl bis(2,4,6-trimethylbenzoyl) phosphine oxide (BAPO), and/or polymeric type I photoinitiators such as Ominpol TP.

In some embodiments, a photocurable composition comprises a photoinitiator selected from a benzophenone, a mixture of benzophenone and a tertiary amine containing a carbonyl group which is directly bonded to at least one aromatic ring, and an Irgacure (e.g., Irgacure 907 (2-methyl-1-[4-(methylthio)-phenyl]-2-morpholino-propanone-1) or Irgacure 651 (2,2-dimethoxy-1,2-diphenylethan-1-one). In some embodiments, the photoinitiator comprises an acetophenone photoinitiator (e.g., 4′-hydroxyacetophenone, 4′Ophenoxyacetophenone, 4′-ethoxyaceto-phenone), a benzoin, a benzoin derivative, a benzil, a benzil derivative, a benzophenone (e.g., 4-benzoylbiphenyl, 3,4-(dimethylamino)benzophenone, 2-methylbenzophenone), a cationic photoinitiator (e.g., diphenyliodonium nitrate, (4-iodophenyl)diphenylsulfonium triflate, triphenylsulfonium triflate), an anthraquinone, a quinone (e.g., camphorquinone), a phosphine oxide, a phosphinate, 9,10-phenanthrenequinone, a thioxanthone, any combination thereof, or any derivative thereof.

In some embodiments, the photoinitiator can have a maximum wavelength absorbance within a range from 200 nm to 300 nm, 300 nm to 400 nm, 400 nm to 500 nm, 500 nm to 600 nm, 600 nm to 700 nm, 700 nm to 800 nm, 800 nm to 900 nm, 150 nm to 200 nm, 200 nm to 250 nm, 250 nm to 300 nm, 300 nm to 350 nm, 350 nm to 400 nm, 400 nm to 450 nm, 450 nm to 500 nm, 500 nm to 550 nm, 550 nm to 600 nm, 600 nm to 650 nm, 650 nm to 700 nm, or 700 nm to 750 nm. In some embodiments, the photoinitiator has a maximum wavelength absorbance within a range from 300 nm to 500 nm.

In some embodiments, short wavelengths of UV are used to initiate a polymerization. In some embodiments, a reaction of thiol-enes when no initiators are used can be initiated with UV light at a wavelength less than 400 nm, less than 375 nm, less than 360 nm, less than 350 nm, less than 330 nm, or less than 300 nm. When photoinitiators are used, any wavelength to which the photoinitiator is sensitive to can be used and includes the whole visible spectrum and even into the IR spectrum.

In some embodiments, the photoinitiator is present at a concentration within a range from 0.1 wt % to 2.5 wt %, from 0.25 wt % to 2.5 wt %, or from 0.5 wt % to 2.0 wt % based on the total weight of the polymerizable composition. In some embodiments, the polymerizable composition comprises from 0.01 wt % to 10 wt % of the photoinitiator. In some embodiments, the polymerizable composition comprises from 0.01 wt % to 0.5 wt %, from 0.01 wt % to 1 wt %, from 0.01 wt % to 2 wt %, from 0.01 wt % to 5 wt %, from 0.05 wt % to 1 wt %, from 0.05 wt % to 2 wt %, from 0.05 wt % to 3 wt %, from 0.05 wt % to 4 wt %, from 0.05 wt % to 5 wt %, from 0.05 wt % to 10 wt %, from 0.1 wt % to 1 wt %, from 0.1 wt % to 2 wt %, from 0.1 wt % to 3 wt %, from 0.1 wt % to 4 wt %, from 0.1 wt % to 5 wt %, from 0.1 wt % to 6 wt %, from 0.1 wt % to 7 wt %, from 0.1 wt % to 8 wt %, from 0.1 wt % to 9 wt %, from 0.1 wt % to 10 wt %, from 0.5 wt % to 10 wt %, from 1.0 wt % to 10 wt %, from 5 wt % to 10 wt %, or from 7.5 wt % to 10 wt % of the photoinitiator, based on the total weight of the composition. In some embodiments, the photoinitiator is present at a low concentration, for instance, less than 2 wt %, less than 1 wt %, less than 0.5 wt %, less than 0.25 wt %, or less than 0.1 wt %.

### 4. Example Compositions

In some embodiments, the polymerizable compound, reactive diluent, or both independently comprise alkyl methacrylate or alkyl acrylate or derivatives thereof. In some embodiments, the polymerizable compound, reactive diluent, or both independently comprise propyl methacrylate, propyl acrylate, butyl methacrylate, butyl acrylate, pentyl methacrylate, pentyl acrylate, hexyl methacrylate, hexyl acrylate, ethyl hexyl acrylate, ethyl hexyl methacrylate, adamantyl methacrylate, adamantyl acrylate, vinyl ethers, allyl ethers, allyl silane, vinyl silane, allyl esters, allyl carbonates, vinyl esters, acrylamides, vinyl carbonates, or combinations thereof. In some embodiments, the polymerizable compound, reactive diluent, or both independently comprise HS3,3,5-trimethylcyclohexyl 2-(methacryloxy)benzoate (HSMA), isobornyl methacrylate (IBOMA), or syringyl methacrylate (SMA).

In some embodiments, the polymerizable compound, reactive diluent, or both independently comprise silicone monomers, fluorinated monomers, or combinations thereof. In some embodiments, hydrophobic groups are used as the resulting materials will have low water uptake, which can result in high stain resistance and/or can maintain high and stable performance in aqueous environments.

Additional examples of compounds that may be used as the polymerizable compound and/or the reactive diluent are provided in U.S. Pat. No. 10,781,274, the disclosure of which is incorporated by reference herein in its entirety.

In some embodiments, a polymerizable composition comprising a polymerizable compound (e.g., an oligomer or polymer), an initiator, and a reactive diluent is provided, where the polymerizable compound is present at a concentration within a range from 30 wt % to 70 wt %, the initiator is present at a concentration within a range from 0.5 wt % to 2.0 wt %, and the reactive diluent is present at a concentration within a range from 20 wt % to 50 wt % or within a range from 30 wt % to 70 wt % and comprises a compound having one of the following structures:

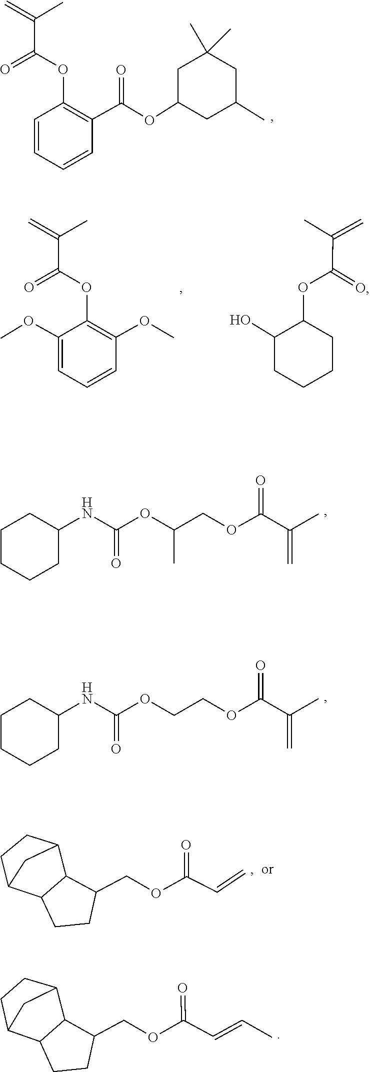

In some embodiments, a polymerizable composition comprising a polymerizable compound (e.g., an oligomer or polymer), an initiator, and a reactive diluent is provided, where the polymerizable compound is present at a concentration within a range from 50 wt % to 80 wt %, the initiator is present at a concentration within a range from 0.5 wt % to 2.0 wt %, and the reactive diluent is present at a concentration within a range from 20 wt % to 50 wt % and comprises a compound having one of the following structures:

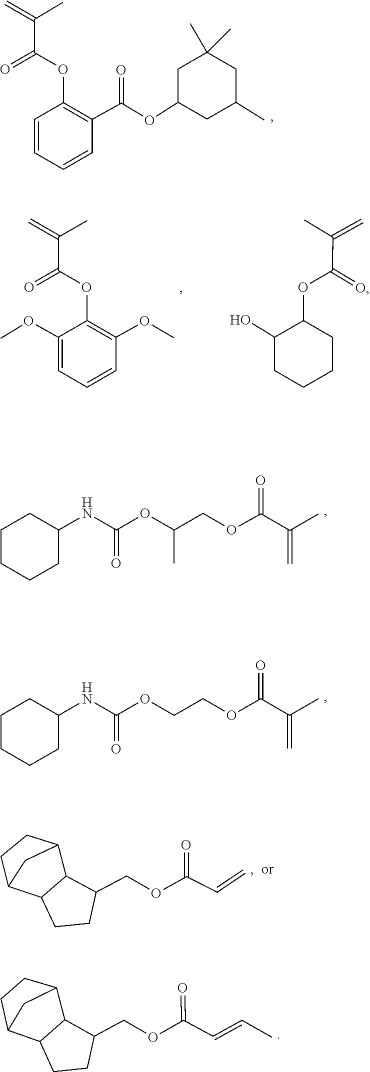

In some embodiments, a polymerizable composition comprising polymerizable compound (e.g., an oligomer), an initiator, and a reactive diluent is provided, where the polymerizable compound comprises hydrogenated polybutadiene present at a concentration within a range from 50 wt % to 85 wt %, the initiator is present at a concentration within a range from 0.5 wt % to 2.0 wt %, and the reactive diluent is present at a concentration within a range from 15 wt % to 50 wt % and comprises a compound having one of the following structures:

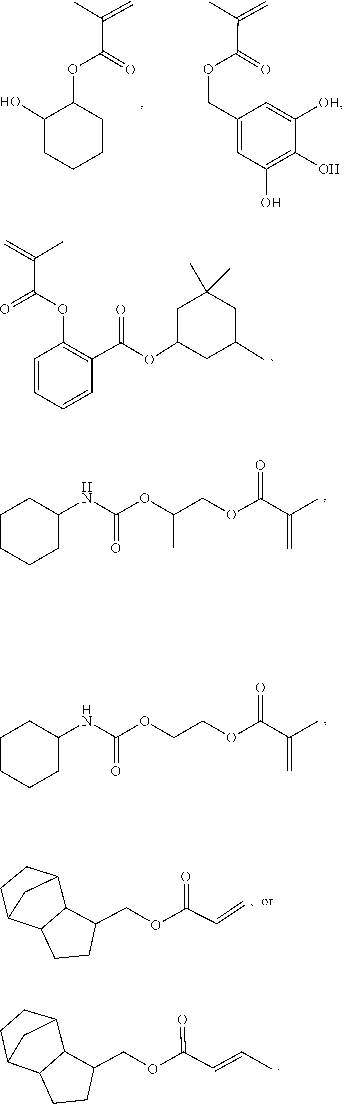

### 5. Additional Components

In some embodiments, the polymerizable composition further comprises one or more additional components (e.g., additives). The one or more additional components may be selected from the group consisting of a crosslinking modifier, a glass transition temperature modifier, a toughness modifier, a polymerization catalyst, a polymerization inhibitor, thermal initiators, a light blocker, a UV absorber, an optical brightener, an opacifier, a plasticizer, a surface energy modifier, an antistatic agent, a wetting agent, a matting agent, an adhesion promoter, a rheology modifier, a thixotropic agent, an antifoaming agent, a pigment, a dye, a filler, an IR-absorbing component, an antioxidant, a dispersing agent, an antibacterial agent, a cyclopolymerizable monomer, a biologically significant chemical, a solvent, and combinations thereof.

In some embodiments, the polymerizable composition further comprises one or more additional components selected from the group consisting of a crosslinking modifier, a glass transition temperature modifier, a toughness modifier, a polymerization catalyst, a polymerization inhibitor, a light blocker, a plasticizer, a surface energy modifier, a pigment, a dye, a filler, a biologically significant chemical, a solvent, and combinations thereof.

In some embodiments, a polymerizable composition of the present disclosure can further comprise a crosslinking modifier (e.g., in addition to a polymerizable compound and/or reactive diluent disclosed herein that can act as a crosslinker, or in instances where the polymerizable compound and/or reactive diluent does not act as a crosslinker), a light blocker, a solvent, a glass transition temperature modifier, or a combination thereof.

In some embodiments, the polymerizable composition comprises from 0 wt % to 25 wt % of a crosslinking modifier, the crosslinking modifier having a number average molecular weight equal to or less than 1,500 Da.

In some embodiments, the polymerizable composition comprises from 0 wt % to 10 wt %, 0 wt % to 9 wt %, 0 wt % to 8 wt %, 0 wt % to 7 wt %, 0 wt % to 6 wt %, 0 wt % to 5 wt %, 0 wt % to 4 wt %, 0 wt % to 3 wt %, 0 wt % to 2 wt %, 0 wt % to 1 wt %, or 0 wt % to 0.5 wt % of the light blocker.

In some embodiments, the polymerizable composition comprises a solvent. In some embodiments, the solvent comprises a nonpolar solvent. In some embodiments, the nonpolar solvent comprises pentane, cyclopentane, hexane, cyclohexane, benzene, toluene, 1,4-dioxane, chloroform, diethyl ether, dichloromethane, a derivative thereof, or a combination thereof. In some embodiments, the solvent comprises a polar aprotic solvent. In some embodiments, the polar aprotic solvent comprises tetrahydrofuran, ethyl acetate, acetone, dimethylformamide, acetonitrile, DMSO, propylene carbonate, a derivative thereof, or a combination thereof. In some embodiments, the solvent comprises a polar protic solvent. In some embodiments, the polar protic solvent comprises formic acid, n-butanol, isopropyl alcohol, n-propanol, t-butanol, ethanol, methanol, acetic acid, water, a derivative thereof, or a combination thereof. In some embodiments, the polymerizable composition comprises less than 90% of the solvent by weight.

In some embodiments, the additional component (e.g., a crosslinking modifier, a polymerization catalyst, a polymerization inhibitor, a glass transition temperature modifier, a light blocker, a plasticizer, a solvent, a surface energy modifier, a pigment, a dye, a filler, or a biologically significant chemical) is functionalized so that it can be incorporated into the polymeric material so that it cannot readily be extracted from the final cured material. In some embodiments, the polymerization catalyst, polymerization inhibitor, light blocker, plasticizer, surface energy modifier, pigment, dye, and/or filler, are functionalized to facilitate their incorporation into the cured polymeric material.

In some embodiments, a polymerizable composition herein comprises a component in addition to a polymerizable compound and/or reactive diluent described herein that can alter the glass transition temperature (T_{g}) of the cured polymeric material. In such instances, a glass transition temperature modifier (also referred to herein as a T_{g} modifier or a glass transition modifier) can be present in the polymerizable composition at a concentration within a range from about 0 wt % to about 50 wt %, based on the total weight of the composition. The T_{g} modifier can have a high glass transition temperature, which leads to a high heat deflection temperature, which can be beneficial or necessary to use a material at elevated temperatures. In some embodiments, the polymerizable composition comprises from 0 wt % to 80 wt %, 0 wt % to 75 wt %, 0 wt % to 70 wt %, 0 wt % to 65 wt %, 0 wt % to 60 wt %, 0 wt % to 55 wt %, 0 wt % to 50 wt %, 1 wt % to 50 wt %, 2 wt % to 50 wt %, 3 wt % to 50 wt %, 4 wt % to 50 wt %, 5 wt % to 50 wt %, 10 wt % to 50 wt %, 15 wt % to 50 wt %, 20 wt % to 50 wt %, 25 wt % to 50 wt %, 30 wt % to 50 wt %, 35 wt % to 50 wt %, 0 wt % to 40 wt %, 1 wt % to 40 wt %, 2 wt % to 40 wt %, 3 wt % to 40 wt %, 4 wt % to 40 wt %, 5 wt % to 40 wt %, 10 wt % to 40 wt %, 15 wt % to 40 wt %, or 20 wt % to 40 wt % of a T_{g} modifier. In some embodiments, the polymerizable composition comprises from 0 wt % to 50 wt % of a T_{g} modifier.

In some embodiments, the number average molecular weight of the T_{g} modifier is within a range from 0.4 kDa to 5 kDa. In some embodiments, the number average molecular weight of the T_{g} modifier is within a range from 0.1 kDa to 5 kDa, from 0.2 kDa to 5 kDa, from 0.3 kDa to 5 kDa, from 0.4 kDa to 5 kDa, from 0.5 kDa to 5 kDa, from 0.6 kDa to 5 kDa, from 0.7 kDa to 5 kDa, from 0.8 kDa to 5 kDa, from 0.9 kDa to 5 kDa, from 1.0 kDa to 5 kDa, from 0.1 kDa to 4 kDa, from 0.2 kDa to 4 kDa, from 0.3 kDa to 4 kDa, from 0.4 kDa to 4 kDa, from 0.5 kDa to 4 kDa, from 0.6 kDa to 4 kDa, from 0.7 kDa to 4 kDa, from 0.8 kDa to 4 kDa, from 0.9 kDa to 4 kDa, from 1 kDa to 4 kDa, from 0.1 kDa to 3 kDa, from 0.2 kDa to 3 kDa, from 0.3 kDa to 3 kDa, from 0.4 kDa to 3 kDa, from 0.5 kDa to 3 kDa, from 0.6 kDa to 3 kDa, from 0.7 kDa to 3 kDa, from 0.8 kDa to 3 kDa, from 0.9 kDa to 3 kDa, or from 1 kDa to 3 kDa.

A polymerizable compound and/or reactive of the present disclosure (which can, in some cases, act by itself as a T_{g} modifier) and a separate T_{g} modifier compound can be miscible and compatible in the methods described herein. When used in the subject compositions, the T_{g} modifier may provide for high T_{g} and strength values, sometimes at the expense of elongation at break. In some embodiments, a toughness modifier may provide for high elongation at break and toughness via strengthening effects. In some embodiments, the polymerizable composition comprises high amounts of toughness modifiers, while maintaining high values for strength and T_{g}.

In some embodiments, the polymerizable composition includes one or more of a crosslinking modifier, a T_{g} modifier, a toughness modifier, a filler, cyclopolymerizable monomers, or combinations thereof, in amounts within a range from 1 wt % to 80 wt %, from 2 wt % to 50 wt %, from 5 wt % to 30 wt %, or from 10 wt % to 20 wt % based on the total weight of the polymerizable composition.

In some embodiments, the polymerizable composition includes one or more of a polymerization catalyst, a thermal initiator, a plasticizer, a solvent, or combinations thereof, in amounts within a range from 0.001 wt % to 10 wt %, from 0.01 wt % to 5 wt %, from 0.02 wt % to 2 wt %, or from 0.02 wt % to 0.5 wt % based on the total weight of the polymerizable composition.

In some embodiments, the polymerizable composition includes one or more of a light blocker, a UV absorber, an optical brightener, an opacifier, a surface energy modifier, an antistatic agent, a wetting agent, a matting agent, an adhesion promoter, a rheology modifier, a thixotropic agent, an antifoaming agent, a pigment, a dye, a dispersing agent, or combinations thereof, in amounts within a range from 0.001 wt % to 5 wt %, from 0.01 wt % to 1 wt %, from 0.02 wt % to 0.5 wt %, or from 0.02 wt % to 0.1 wt % based on the total weight of the polymerizable composition.

In some embodiments, the polymerizable composition includes one or more of a polymerization inhibitor, an IR-absorbing component, an antioxidant, an antibacterial agent, a biologically significant chemical, or combinations thereof, in amounts within a range from 0.001 wt % to 2 wt %, from 0.001 wt % to 1 wt %, from 0.01 wt % to 0.5 wt %, or from 0.01 wt % to 0.1 wt % based on the total weight of the polymerizable composition.

In some embodiments, the polymerizable composition comprises at least one light absorber, such as a pigment or a dye. The light absorber can be selected from the group consisting of inorganic particles (e.g., titanium dioxide, carbon black), organic UV light absorbers (e.g., benzophenone derivatives, benzotriazole derivatives, triazine derivatives, thioxanthones), hindered amine light-stabilizers (e.g., Chimassorb, Tinuvin, and/or Uvinul products). The light absorber can be present in amounts within a range from 0.001 wt % to 2 wt %, from 0.01 wt % to 1 wt %, from 0.02 wt % to 0.5 wt %, or from 0.02 wt % to 0.1 wt % based on the total weight of the polymerizable composition. In some embodiments, the polymerizable composition comprises at least one IR-absorbing component, such in amounts within a range from 0.001 wt % to 2 wt %, from 0.002 wt % to 0.5 wt %, from 0.005 wt % to 0.1 wt %, or from 0.005 wt % to 0.05 wt % based on the total weight of the polymerizable composition.

In some embodiments, the polymerizable composition comprises at least one antifoaming agent, such as silicone-based compounds (e.g., polydimethylsiloxanes, polyether siloxanes), mineral oils, waxes, and specialized non-silicone polymers (e.g., non-ionic high molecular weight surface-active polymers such as poly(N-alkylsubstituted acrylamides), poly(alkylsubstituted acrylates), poly(ethylene oxide)/poly(ethylene glycol) derivatives, modified polysaccharides, amide oxime polymers, polyphosphonates). The antifoaming agent can be present in amounts within a range from 0.001 wt % to 5 wt %, from 0.01 wt % to 3 wt %, or from 0.02 wt % to 2 wt % based on the total weight of the polymerizable composition.

In some embodiments, the polymerizable composition comprises at least one antioxidant, such as an antioxidant selected from vitamins (e.g., vitamin C (ascorbic acid), vitamin E (tocopherol), vitamin A), minerals (e.g., selenium, zinc, copper, and manganese, which act as cofactors for antioxidant enzymes), polyphenols (e.g., flavonoids, phenolic acids, lignans), and carotenoids (e.g., beta-carotene, lycopene, lutein, cryptoxanthins), and/or other compounds (e.g., glutathione, coenzyme Q10 (CoQ10), uric acid). The antioxidant can be present in amount within a range from 0.001 wt % to 2 wt %, from 0.001 wt % to 0.5 wt %, from 0.002 wt % to 0.1 wt %, or from 0.005 wt % to 0.05 wt % based on the total weight of the polymerizable composition.

### B. Properties of Polymerizable Compositions

A polymerizable composition herein (e.g., a photocurable resin) can be characterized by one or more properties that make it suitable for use in a fabrication process, such as an additive manufacturing process. For example, the additive manufacturing process can involve forming a layer of the polymerizable composition on a carrier plate or film (e.g., using a recoater blade). Thus, the viscosity of the polymerizable composition can be sufficiently low at the printing temperature of the additive manufacturing process to facilitate formation of a thin, substantially uniform layer.

In some embodiments, a polymerizable composition of the present disclosure can be capable of being additively manufactured at a printing temperature greater than 25 °C. In some cases, the printing temperature is at least about 30 °C, 40 °C, 50 °C, 60 °C, 80 °C, or 100 °C. As described herein, a photopolymerizable monomer of this disclosure that can be part of the polymerizable composition (e.g., a reactive diluent) can have a low vapor pressure and/or mass loss at the printing temperature, thereby providing improved printing conditions compared to conventional resins used in additive manufacturing. In some embodiments, the printing temperature is within a range from 0 °C to 25 °C, from 25 °C to 40 °C, from 40 °C to 100 °C, or from 20 °C to 150 °C. In some embodiments, the printing temperature is within a range from 10 °C to 200 °C, from 15 °C to 175 °C, from 20 °C to 150 °C, from 25 °C to 125 °C, or from 30 °C to 100 °C. In some embodiments, the printing temperature is within a range from 20 °C to 150 °C.

In some embodiments, the polymerizable composition has a viscosity within a range from 10 cP to 70,000 cP, from 30 cP to 50,000 cP, from 30 cP to 40,000 cP, from 30 cP to 30,000 cP, from 30 cP to 20,000 cP, from 30 cP to 10,000 cP, from 30 cP to 5,000 cP, from 100 cP to 30,000 cP, or from 500 cP to 10,000 cP at a printing temperature.

In some embodiments, the polymerizable composition has a viscosity less than 20,000 cP at a printing temperature. In some embodiments, the polymerizable composition has a viscosity less than or equal to 100,000 cP, less than or equal to 90,000 cP, less than or equal to 80,000 cP, less than or equal to 70,000 cP, less than or equal to 60,000 cP, less than or equal to 50,000 cP, less than or equal to 40,000 cP, less than or equal to 35,000 cP, less than or equal to 30,000 cP, less than or equal to 25,000 cP, less than or equal to 20,000 cP, less than or equal to 15,000 cP, less than or equal to 10,000 cP, less than or equal to 5,000 cP, less than or equal to 4,000 cP, less than or equal to 3,000 cP, less than or equal to 2,000 cP, less than or equal to 1,000 cP, less than or equal to 750 cP, less than or equal to 500 cP, less than or equal to 250 cP, less than or equal to 100 cP, less than or equal to 90 cP, less than or equal to 80 cP, less than or equal to 70 cP, less than or equal to 60 cP, less than or equal to 50 cP, less than or equal to 40 cP, less than or equal to 30 cP, less than or equal to 20 cP, or less than or equal to 10 cP at a printing temperature.

In some embodiments, the polymerizable composition has a viscosity at the printing temperature of more than 2,000 cP. In some embodiments, the polymerizable composition has a viscosity at the printing temperature of more than 10,000 cP.

In some embodiments, the polymerizable composition has a viscosity within a range from 30 cP to 50,000 cP at a printing temperature, wherein the printing temperature is within a range from 20 °C to 150 °C.

In some embodiments, the polymerizable composition has a viscosity within a range from 1 cP to 10,000 cP at a temperature within a range from 15 °C to 100 °C. In some embodiments, the polymerizable composition has a viscosity within a range from 10 cP to 1,000 cP at a temperature within a range from 25 °C to 90 °C. In some embodiments, the polymerizable composition has a viscosity within a range from 100 cP to 500 cP at a temperature within a range from 30 °C to 60 °C. In some embodiments, the polymerizable composition has a viscosity greater than 5,000 cP at a temperature within a range from 15 °C to 30 °C. In some embodiments, the polymerizable composition has a viscosity within a range from 5,000 to 10,000 cp at a temperature within a range from 15 °C to 30 °C.

In some embodiments, the polymerizable composition has a viscosity less than or equal to 30,000 cP, less than or equal to 25,000 cP, less than or equal to 20,000 cP, less than or equal to 19,000 cP, less than or equal to 18,000 cP, less than or equal to 17,000 cP, less than or equal to 16,000 cP, less than or equal to 15,000 cP, less than or equal to 14,000 cP, less than or equal to 13,000 cP, less than or equal to 12,000 cP, less than or equal to 11,000 cP, less than or equal to 10,000 cP, less than or equal to 9,000 cP, less than or equal to 8,000 cP, less than or equal to 7,000 cP, less than or equal to 6,000 cP, or less than or equal to 5,000 cP at 25 °C. In some embodiments, the polymerizable composition has a viscosity less than 15,000 cP at 25 °C.

In some embodiments, the polymerizable composition includes a reactive diluent can reduce the viscosity of the polymerizable composition, as described above. In such cases, a reactive diluent can reduce the viscosity of the polymerizable composition by at least about 5% compared to a composition that does not comprise the reactive diluent. In some embodiments, a reactive diluent can reduce the viscosity of a polymerizable composition by at least about 5%, 10%, 20%, 30%, 40%, or 50%.

In some embodiments, a polymerizable composition herein has a melting temperature (Tₘ) greater than room temperature. In some embodiments, the polymerizable composition has a melting temperature greater than 20 °C, greater than 25 °C, greater than 30 °C, greater than 35 °C, greater than 40 °C, greater than 45 °C greater than 50 °C, greater than 55 °C, greater than 60 °C, greater than 65 °C, greater than 70 °C, greater than 75 °C, or greater than 80 °C. In some embodiments, the polymerizable composition has a melting temperature within a range from 20 °C to 250 °C, from 30 °C to 180 °C, from 40 °C to 160 °C, or from 50 °C to 140 °C. In some embodiments, the polymerizable composition has a melting temperature greater than 60 °C. In some embodiments, the polymerizable composition has a melting temperature within a range from 80 °C to 110 °C. In some embodiments, a polymerizable composition can have a melting temperature of about 80 °C before polymerization; after polymerization, the resulting polymeric material can have a melting temperature of about 100 °C. In some embodiments, at least a portion of the polymerizable composition melts at a temperature within a range from about 60 °C to about 0 °C.

In certain instances, it may be advantageous that a polymerizable composition is in a liquid phase at an elevated temperature. As an example, a conventional resin can comprise polymerizable components that may be viscous at a process temperature, and thus can be difficult to use in the fabrication of objects (e.g., using additive manufacturing). As a solution for that technical problem, the present disclosure provides polymerizable compositions comprising photopolymerizable components such as monomers, oligomers, and/or polymers described herein that can melt at an elevated temperature, e.g., at a temperature of fabrication (e.g., a printing temperature during additive manufacturing), and can have a decreased viscosity at the elevated temperature, which can make such compositions more applicable and usable for uses such as additive manufacturing. Hence, in some embodiments, provided herein are polymerizable compositions that are a liquid at an elevated temperature. In some embodiments, the elevated temperature is at or above the melting temperature of the polymerizable composition. In some embodiments, the elevated temperature is a temperature within a range from about 40 °C to about 100 °C, from about 60 °C to about 100 °C, from about 80 °C to about 100 °C, from about 40 °C to about 150 °C, or from about 150 °C to about 350 °C. In some embodiments, the elevated temperature is a temperature above about 40 °C, above about 60 °C, above about 80 °C, or above about 100 °C.

In some embodiments, a polymerizable composition herein is a liquid at an elevated temperature with a viscosity less than about 50,000 cP, less than about 2,000 cP, less than about 10,000 cP, less than about 5,000 cP, or less than about 1,000 cP. In some embodiments, a polymerizable composition herein is a liquid at a temperature within a range from about 40 °C to about 100 °C. In some embodiments, a polymerizable composition herein is a liquid at an elevated temperature of above about 40 °C with a viscosity less than about 20,000 cP. In some embodiments, a polymerizable composition herein is a liquid at an elevated temperature of above about 40 °C with a viscosity less than about 1,000 cP.

In some embodiments, a polymerizable composition herein can have a melting temperature less than 100 °C in order to be liquid and, thus, processable at the temperatures usually employed in currently available additive manufacturing techniques. In some embodiments, at least a portion of a polymerizable composition herein has a melting temperature below about 100 °C, below about 90 °C, below about 80 °C, below about 70 °C, or below about 60 °C. In some embodiments, at least a portion of a polymerizable composition herein melts at an elevated temperature between about 100 °C and about 20 °C, between about 90 °C and about 20 °C, between about 80 °C and about 20 °C, between about 70 °C and about 20 °C, between about 60 °C and about 20 °C, between about 60 °C and about 10 °C, or between about 60 °C and about 0 °C.

In some embodiments, a polymerizable composition herein (as well as its polymerizable compounds) can be biocompatible, bioinert, or a combination thereof. In various instances, the photopolymerizable components of a polymerizable composition herein can have biocompatible and/or bioinert metabolic (e.g., hydrolysis) products.

A polymerizable composition of the present disclosure can comprise less than about 20 wt % or less than about 10 wt % hydrogen bonding units. In some embodiments, a polymerizable composition herein comprises less than about 15 wt %, less than about 10 wt %, less than about 9 wt %, less than about 8 wt %, less than about 7 wt %, less than about 6 wt %, less than about 5 wt %, less than about 4 wt %, less than about 3 wt %, less than about 2 wt %, or less than about 1 wt % hydrogen bonding units.

### C. Polymeric Materials

In some embodiments, the present disclosure provides polymeric materials for use in objects such as dental appliances (e.g., mouthguards). The polymeric material can be part of the bulk material or substrate of the object. Alternatively or in addition, the polymeric material can be part of a polymeric coating on one or more surfaces of the object. Thus, any reference herein to a “polymeric material” may refer to a polymeric substrate of an object, a polymeric coating on an object, or both, unless otherwise evident from context. Such polymeric materials can be generated by curing a polymerizable composition as described herein, e.g., by exposing such a composition to electromagnetic radiation of appropriate wavelength. For example, a polymeric material herein may be generated by photocuring a photocurable resin described herein. Such photocurable resins can comprise one or more polymerizable compounds of the present disclosure.

In some embodiments, the polymeric material comprises one or more polymer types that may have formed, during curing, from the polymerizable compositions, polymerizable compounds (e.g., polymers or oligomers), reactive diluents (e.g., monomers), and/or any other polymerizable component described herein. In some embodiments, such one or more polymer types can include one or more of a homopolymer, a linear copolymer, a block copolymer, an alternating copolymer, a periodic copolymer, a statistical copolymer, a random copolymer, a gradient copolymer, a branched copolymer, a brush copolymer, a comb copolymer, a dendrimer, or any combination thereof. In some embodiments, the polymeric material comprises a random copolymer.

In some embodiments, the polymeric material comprises poly(ethylene) glycol (PEG), poly(ethylene) glycol diacrylate, PEG-THF, polytetrahydrofuran, poly(tert-butyl acrylate), poly(ethylene-co-maleic anhydride), poly(butadiene), hydrated poly(butadiene), poly(isoprene), hydrated poly(isoprene), poly(siloxane), poly(dimethylsiloxane), poly(propylene), poly(ethylene-co-vinyl acetate), any derivative thereof, or any combination thereof.

In some embodiments, the polymeric material comprises an acrylate, a methacrylate, an acrylamide, a methacrylamide, an acrylonitrile, a bisphenol acrylate, a carbohydrate, a fluorinated acrylate, a maleimide, 4-acetoxyphenethyl acrylate, acryloyl chloride, 4-acryloylmorpholine, 2-(acryloyloxy)ethyl]-trimethylammonium chloride, 2-(4-benzoyl-3-hydroxyphenoxy)ethyl acrylate, benzyl 2-propylacrylate, butyl acrylate, tert-butyl acrylate, 2[(butylamino)carbonyl]-oxy]ethyl acrylate, tert-butyl 2-bromoacrylate, 2-carboxyethyl acrylate, 2-chloroethyl acrylate, 2-(diethylamino)-ethyl acrylate, di(ethylene glycol) ethyl ether acrylate, 2-(dimethylamino)ethyl acrylate, 3-(dimethylamino)propyl acrylate, dipentaerythriol penta-/hexa-acrylate, ethyl acrylate, 2-ethylacryloyl chloride, ethyl 2-(bromomethyl)acrylate, ethyl cis-(beta-cyano)acrylate, ethylene glycol dicyclopentenyl ether acrylate, ethylene glycol methyl ether acrylate, ethylene glycol phenyl ether acrylate, ethyl 2-ethylacrylate, 2-ethylexyl acrylate, ethyl 2-propylacrylate, ethyl 2-(trimethylsilylmethyl)acrylate, hexyl acrylate, 4-hydroxybutyl acrylate, 2-hydroxyethyl acrylate, 2-hydroxy-3-phenoxypropyl acrylate, hydroxypropyl acrylate, isobornyl acrylate, isobutyl acrylate, isodecyl acrylate, isooctyl acrylate, lauryl acrylate, methyl 2-acetamidoacrylate, methyl acrylate, a methylene malonate (e.g., dibutyl methylene malonate, dihexyl methylene malonate, or dicyclohexyl methylene malonate), a methylene malonate macromerer (e.g., a polyester of 2-methylenemalonate such as Forza B3000 XP), methyl α-bromoacrylate, methyl 2-(bromo-methyl)acrylate, methyl 2-(chloromethyl)acrylate, methyl 3-hydroxy-2-methylenebutyrate, methyl 2-(trifluoromethyl)acrylate, octadecyl acrylate, pentabromobenzyl acrylate, penta-bromophenyl acrylate, pentafluorophenyl acrylate, poly(ethylene glycol) diacrylate, poly-(ethylene glycol) methyl ether acrylate, poly(propylene glycol) acrylate, epoxidized soybean oil acrylate, 3-sulfopropyl acrylate, tetrahydrofuryl acrylate, 2-tetrahydropyranyl acrylate, 3-(trimethoxysilyl)propyl acrylate, 3,5,5-trimethylhexyl acrylate, 10-undecenyl acrylate, urethane acrylate, urethane acrylate methacrylate, tricylcodecane diacrylate, isobornyl acrylate, a methacrylate, allyl methacrylate, benzyl methacrylate, (2-boc-amino)ethyl methacrylate, tert-butyl methacrylate, 9H-carbazole-9-ethylmethacrylate, 3-chloro-2-hydroxypropyl methacrylate, cyclohexyl methacrylate, 1,10-decamethylene glycol dimethacrylate, ethylene glycol dicyclopentenyl ether methacrylate, ethylene glycol methyl ether methacrylate, 2-ethylhexyl methacrylate, furfuryl methacrylate, glycidyl methacrylate, glycosyloxyethyl methacrylate, hexyl methacrylate, hydroxybutyl methacrylate, 2-hydroxy-5-N-methacrylamidobenzoic acid, isobutyl methacrylate, methacryloyl chloride, methyl methacrylate, mono-2-methacryloyloxy)ethyl succinate, 2-N-morpholinoethyl methacrylate, 1-naphthyl methacrylate, pentabromophenyl methacrylate, phenyl methacrylate, pentabromophenyl methacrylate, TEMPO methacrylate, 3-sulfopropyl methacrylate, triethylene glycol methyl ether methacrylate, 2-[(1′,1′,1′-trifluoro-2′-(trifluoromethyl)-2′Ohdroxy)propyl]-3-norbornyl methacrylate, 3,3,5-trimethylcyclohexyl methacrylate, (trimethylsilyl)methacrylate, vinyl methacrylate, isobornyl methacrylate, bisphenol A dimethacrylate, an Omnilane OC, tert-butyl acrylate, isodecyl acrylate, tricylcodecane diacrylate, a polyfunctional acrylate, N,N′-methylenebisacrylamide, 3-(acryloyloxy)-2-hydroxypropyl) methacrylate, bis[2-(methacryloyloxy)ethyl]phosphate, 1,3-butanediol diacrylate, 1,4-butanediol diacrylate, diurethane dimethacrylate, N,N′-ethylenebis(acrylamide), glycerol 1,3-diglycerolate diacrylate, 1,6-hexanediol diacrylate, hydroxypivalyl hydroxypivalate bis[6-(acryloyloxy)hexanoate], neopentyl glycol diacrylate, pentaerythritol diacrylate, 1,3,6-triacryloyl hexahydro-1,3,5-triazine, trimethlolpropane ethoxylate, tris[2-(acryloyloxy)ethyl]isocyanurate, any derivative thereof, or a combination thereof.

In some embodiments, the polymeric material herein can comprise one or more reactive functional groups that can allow for further modification of the polymeric material, such as additional polymerization (e.g., post-curing). In some embodiments, the polymeric material comprises a plurality of reactive functional groups, and the reactive functional groups can be located at one or both terminal ends of the polymeric material, in-chain, at a pendant (e.g., a side group attached to the polymer backbone), or any combination thereof. Non-limiting examples of reactive functional groups include free radically polymerizable functionalities, photoactive groups, groups facilitating step growth polymerization, thermally reactive groups, and/or groups that facilitate bond formation (e.g., covalent bond formation). In some embodiments, the reactive functional groups comprise an acrylate, a methacrylate, an acrylamide, a vinyl group, a vinyl ether, a thiol, an allyl ether, a norbornene, a vinyl acetate, a maleate, a fumarate, a maleimide, an epoxide, a ring-strained cyclic ether, a ring-strained thioether, a cyclic ester, a cyclic carbonate, a cyclic silane, a cyclic siloxane, a hydroxyl, an amine, an isocyanate, a blocked isocyanate, an acid chloride, an activated ester, a Diels-Alder reactive group, a furan, a cyclopentadiene, an anhydride, a group favorable toward photodimerization (e.g., an anthracene, an acenaphthalene, or a coumarin), a group that photodegrades into a reactive species (e.g., Norrish Type 1 and 2 materials), an azide, a derivative thereof, or a combination thereof.

In some embodiments, the polymeric material herein is a polymeric coating on a substrate, which may be a polymeric substrate formed from a polymerizable composition herein or another substrate. In some embodiments, the polymeric coating has a thickness of at least about 50 μm, 100 μm, 250 μm, 500 μm, 1 mm, 2 mm, and/or not more than 3 mm or 4 mm. In some embodiments, the polymeric coating has a thickness of at least 20 μm, 40 μm, 60 μm, 80 μm, 100 μm, 120 μm, 140 μm, 160 μm, 180 μm, or 200 μm; and/or not more than 0.5 mm, 1 mm, 2 mm, 3 mm, 3.5 mm, 4 mm, 4.5 mm, 5 mm, 5.5 mm, 6 mm, or 7 mm. In some embodiments, the polymeric coating has a thickness within a range from 1 μm to 10 μm, from 5 μm to 30 μm, from 5 μm to 50 μm, from 10 μm to 100 μm, or from 50 μm to 200 μm.

In some embodiments, the polymeric coating is selected such that it imparts the one or more following characteristics to the surface of the substrate/object: hydrophobic, neutral, or hydrophilic character; transparent or opaque appearance; colored or colorless appearance; low surface energy, neutral, or high surface energy; and/or stainable or stain resistant characteristics.

In some embodiments, the coating imparts one or more of wear resistance, scratch resistance, stain resistance, barrier properties, color, ease of laser marking or ink jetting, antifouling properties, antibacterial properties, antifungal properties, antimicrobial properties, pharmacological properties, release of compounds, odor prevention, closing of pores, a desired surface finish (e.g., glossy surface, matte surface, slick surface, gripping surface), etc.

### D. Properties of Polymeric Materials

A polymeric material (e.g., a polymeric substrate, polymeric coating, or both) of this disclosure formed from the polymerization of a polymerizable composition disclosed herein can provide advantageous characteristics compared to conventional polymeric materials. In some embodiments, a polymeric material can also have low amounts of water uptake and can be solvent resistant. In some embodiments, a polymeric material can be characterized by one or more of the properties selected from the group consisting of elongation at break, storage modulus, tensile modulus, tear resistance, rebound, shock absorption, compression set, stress remaining, glass transition temperature, water uptake, hardness, color, transparency, hydrophobicity, lubricity, surface texture, percent crystallinity, phase composition ratio, phase domain size, and phase domain morphology. Further, as described herein, the polymeric materials provided herein can be used for a multitude of applications, including additive manufacturing, to form materials having favorable properties of elasticity, shock absorption, and/or stiffness. Specifically, a polymeric material of this disclosure can provide excellent shock absorption, flexural modulus, elastic modulus, elongation at break, or a combination thereof.

In some embodiments, the polymeric material has an ultimate tensile strength within a range from 1 MPa to 100 MPa, from 5 MPa to 80 MPa, from 10 MPa to 60 MPa, from 10 MPa to 50 MPa, from 10 MPa to 45 MPa, from 15 MPa to 80 MPa, from 20 MPa to 60 MPa, from 25 MPa to 40 MPa, from 30 MPa to 45 MPa, or from 30 MPa to 40 MPa after 24 hours in a wet environment at 37 °C.

In some embodiments, the polymeric material is characterized by a storage modulus within a range from 0.1 MPa to 4000 MPa, 1 MPa to 3000 MPa, or 5 MPa to 1000 MPa after 24 hours in a wet environment at 37 °C.

In some embodiments, a polymeric material herein can comprise or consist of a high toughness (e.g., through a tough polymer matrix) and the difference (or delta) between the elastic modulus measured at different strain rates (e.g., at 1.7 mm/min and 510 mm/min) can be low, e.g., lower than 80%, 70%, 60%, 50%, 40%, or lower than 30%, which can be an indication for a polymeric phase separation within the material.

In some embodiments, the polymeric material is characterized by an elongation at break greater than 20%, 30%, 40%, and/or an elongation at break within a range from 5% to 250%, 20% to 250%, or 40% to 250% before and after 24 hours in a wet environment at 37 °C.

In some embodiments, a polymeric material can have a low amount of hydrogen bonding which can facilitate a decreased uptake of water in comparison with conventional polymeric materials having greater amounts of hydrogen bonding. Thus, in some instances, a polymeric material herein can comprise less than about 10 wt %, less than about 9 wt %, less than about 8 wt %, less than about 7 wt %, less than about 6 wt %, less than about 5 wt %, less than about 4 wt %, less than about 3 wt %, less than about 2 wt %, less than about 1 wt %, or less than about 0.5 wt % water when fully saturated at use temperature (e.g., about 20 °C, 25 °C, 30 °C, or 35 °C). In some instances, the use temperature can include the temperature of a human mouth (e.g., approximately 35 °C to 40 °C). The use temperature can be a temperature within a range from −100 °C. to 250 °C, 0 °C to 90 °C, 0 °C to 80 °C, 0 °C to 70 °C, 0 °C to 60 °C, 0 °C to 50 °C, 0 °C to 40 °C, 0 °C to 30 °C, 0 °C to 20 °C, 0 °C to 10 °C, 20 °C to 90 °C, 20 °C to 80 °C, 20 °C to 70 °C, 20 °C to 60 °C, 20 °C to 50 °C, 20 °C to 40 °C, 20 °C to 30 °C, or below 0 °C.

In some embodiments, the polymeric material is characterized by a water uptake of less than 20 wt %, less than 15 wt %, less than 10 wt %, less than 5 wt %, less than 4 wt %, less than 3 wt %, less than 2 wt %, less than 1 wt %, less than 0.5 wt %, less than 0.25 wt %, or less than 0.1 wt % when measured after 24 hours in a wet environment at 37 °C.

In some embodiments, the polymeric material has greater than 30%, 40%, 50%, 60%, 80%, 90%, or 99% conversion of double bonds to single bonds compared to the polymerizable composition, as measured by FTIR.

In some embodiments, at least 40%, 50%, 60%, or 70% of visible light passes through the polymeric material after 24 hours in a wet environment at 37 °C.

In some embodiments, the polymeric material herein can comprise one or more polymeric phases, wherein at least one polymeric phase of the one or more polymeric phases is a crystalline phase. In some embodiments, the polymeric material herein can comprise one or more polymeric phases, wherein at least one polymeric phase of the one or more polymeric phases is an amorphous phase.

In some embodiments, the polymeric material has a glass transition temperature of at least about 40 °C, 50 °C, 60 °C, 80 °C, 90 °C, 100 °C, 110 °C, or 120 °C. In some embodiments, the polymeric material has a glass transition temperature of less than 40 °C, less than 25 °C, less than 0 °C, less than −20 °C, or less than −50 °C. In some embodiments, the polymeric material includes one or more amorphous phases, and the one or more amorphous phases can have a glass transition temperature of at least about 30 °C, 40 °C, 50 °C, 60 °C, 70 °C, 80 °C, 90 °C, 100 °C, or 110 °C.

In some embodiments, the polymeric material has a melting temperature equal to or greater than about 20 °C, 30 °C, 40 °C, 50 °C, 60 °C, 70 °C, 80 °C, 90 °C, 100 °C, 120 °C, or 150 °C.

In some embodiments, the polymeric material is biocompatible, bioinert, or a combination thereof.

Some embodiments provide a polymeric material (e.g., a polymeric substrate or a polymeric coating) formed from the polymerizable composition of any one of the embodiments disclosed herein, the polymeric material having one or more of the following characteristics:
(A) a storage modulus greater than or equal to 10 MPa;
(B) an elongation at break greater than or equal to 5% before and after 24 hours in a wet environment at 37 °C;
(C) a water uptake of less than 2 wt % when measured after 24 hours in a wet environment at 37 °C;
(D) transmission of at least 30% of visible light through the polymeric material after 24 hours in a wet environment at 37 °C; and/or
(E) comprises a plurality of polymeric phases, wherein at least one polymeric phase of the one or more polymeric phases has a T_{g} of at least 60 °C, 80 °C, 90 °C, 100 °C, or 110 °C.
   In some embodiments, the polymeric material has at least two, three, four, or all characteristics of (A), (B), (C), (D), and (E).

In some embodiments, a polymeric material (e.g., a polymeric substrate or a polymeric coating) of the present disclosure can have one or more of the following characteristics:
(A) a flexural modulus greater than or equal to 5 MPa, 10 MPa, 100 MPa, or 200 MPa;
(B) an elastic modulus greater than or equal to 5 MPa, 10 MPa, 250 MPa, 350 MPa, 450 MPa, 550 MPa, and/or within a range from about 500 and 1500 MPa, about 550 to about 1000 MPa, or about 550 MPa to about 1500 MPa;
(C) an elongation at break greater than or equal to 5% before and after 24 hours in a wet environment at 37 °C;
(D) a water uptake of less than 25 wt % when measured after 24 hours in a wet environment at 37 °C;
(E) transmission of at least 30% of visible light through the polymeric material after 24 hours in a wet environment at 37 °C; and/or
(F) comprises a plurality of polymeric phases, wherein at least one polymeric phase of the one or more polymeric phases has a T_{g} of at least 60 °C, 80 °C, 90 °C, 100 °C, or 110 °C.
   In some embodiments, the polymeric material has at least two, three, four, five, or all characteristics of (A), (B), (C), (D), (E) and (F).

In some embodiments a polymeric material (e.g., a polymeric substrate or a polymeric coating) of the present disclosure can have one or more of the following characteristics:
(A) a storage modulus lower than or equal to 1000 MPa;
(B) a hardness of greater than or equal to 30 Shore A remaining after 24 hours in a wet environment at 37 °C;
(C) an elongation at break greater than or equal to 50% before and after 24 hours in a wet environment at 37 °C;
(D) a water uptake of less than 10 wt % when measured after 24 hours in a wet environment at 37 °C; and/or
(E) transmission of at least 30% of visible light through the polymeric material after 24 hours in a wet environment at 37 °C.
   In some embodiments, such polymeric material can be characterized by at least two, three, four, or all characteristics of (A), (B), (C), (D), and (E).

### E. Methods of Forming Polymeric Materials

The present disclosure provides methods for producing polymeric materials (e.g., a polymeric coating) using polymerizable compositions described herein. For example, a method can include polymerizing (e.g., photocuring) a polymerizable composition (e.g., a photocurable resin) to obtain an optionally crosslinked polymer. As discussed above, the polymerizable composition can comprise at least one species of a polymerizable compound described herein and optionally one or more additional components selected from the group consisting of telechelic polymers, telechelic oligomers, polymerizable monomers (e.g., reactive diluents), polymerization initiators, polymerization inhibitors, solvents, fillers, antioxidants, pigments, colorants, surface modifiers, and mixtures thereof. The method can comprise a step of mixing the polymerizable composition, optionally after heating, with a reactive diluent before inducing polymerization by heating and/or irradiating the composition; wherein the reactive diluent is selected from the polymerizable monomers and mixtures thereof described herein.

In some embodiments, provided herein are methods for forming a polymeric material by photocuring a polymerizable composition. For example, a method of forming a polymeric material can comprise: (i) providing a polymerizable composition of the present disclosure; (ii) exposing the polymerizable composition to a light source; and (iii) photocuring the polymerizable composition to form the polymeric material. In some embodiments, the method can be performed in accordance with an additive manufacturing process, e.g., as described in Section II below. For example, the polymeric material can be formed in an additive manufacturing process for fabricating an object such as a dental appliance, e.g., as described in Sections III and IV below.

In some embodiments, the photocuring comprises a single curing step. In some embodiments, the photocuring comprises a plurality of curing steps. In some embodiments, the photocuring comprises at least one curing step which exposes the polymerizable composition to light. Exposing the polymerizable composition to light can initiate and/or facilitate photopolymerization. In some embodiments, a photoinitiator can be used as part of the polymerizable composition to accelerate and/or initiate photopolymerization. In some embodiments, the polymerizable composition is exposed to UV light, visible light, IR light, or any combination thereof. In some embodiments, the cured polymeric material is formed from the polymerizable composition using at least one step comprising exposure to a light source, wherein the light source comprises UV light, visible light, and/or IR light. In some embodiments, the light source comprises a wavelength within a range from 10 nm to 200 nm, from 200 nm to 350 nm, from 350 nm to 450 nm, from 450 nm to 550 nm, from 550 nm to 650 nm, from 650 nm to 750 nm, from 750 nm to 850 nm, from 850 nm to 1000 nm, or from 1000 nm to 1500 nm.

In some embodiments, a method of forming a polymeric material from a polymerizable composition described herein can further comprise initiating and/or enhancing formation of crystalline phases in the forming polymeric material. In some embodiments, the triggering comprises cooling the cured material, adding seeding particles to the polymerizable composition, providing a force to the cured material, providing an electrical charge to the polymerizable composition, or any combination thereof. In some embodiments, polymer crystals can yield upon application of a strain (e.g., a physical strain, such as twisting or stretching a material). The yielding may include unraveling, unwinding, disentangling, dislocation, coarse slips, and/or fine slips in the crystallized polymer. In some embodiments, the methods disclosed herein further comprise the step of growing polymer crystals. As described further herein, polymer crystals comprise the crystallizable polymeric material.

Thus, in some embodiments, a method of forming a polymeric material from a polymerizable composition described herein can comprise inducing phase separation in the forming polymeric material (e.g., during photocuring), wherein such phase separation can yield polymeric materials that comprise one or more amorphous phases, one or more crystalline phases, or both one or more amorphous phases and one or more crystalline phases.

In some embodiments, a method of forming a polymeric coating on an object is provided, where the polymeric coating is formed from a polymerizable composition described herein. The method can include (i) applying a polymerizable composition of the present disclosure onto an object; (ii) exposing the polymerizable composition to a light source; and (iii) photocuring the polymerizable composition to form the polymeric coating on the object. In some embodiments, the object to which the coating is applied is a dental appliance, e.g., as described in Sections III and IV below.

Coating adhesion may be facilitated by providing functional groups in the polymerizable composition that bond with the object being coated. In some embodiments, the bonding is polar, dipole, hydrogen, pi-pi stacking, ionic, ligand, coordination, covalent bonding, or combinations thereof. In some embodiments, the bonding is covalent. Covalent bonding may be facilitated by using functional groups that react with functional groups on the surface of the object. In some embodiments, amines, enes, epoxides, cyclic esters, cyclic ethers, thiols, hydroxyls, isocyanates, silanols, and/or other functional groups form covalent bonds with an object. In some embodiments, the formation of covalent bonds occurs upon contact of the polymerizable composition with the object. In some embodiments, the bonding occurs later after the polymerizable composition contacts the object (e.g., minutes later, hours later, or not until upon activation with an energy source such as heat, light, or other). In some embodiments, the bonding is initiated when the coated object is exposed to a reagent (e.g., water, oxygen, or amine) or exposed to a catalyst (via air, sprayed, or liquid dipped). In some embodiments, the reaction that forms covalent bonds is a condensation of silanols, related titanates, or combinations thereof. In some embodiments, the condensation is initiated using room temperature vulcanization methods.

In some embodiments, polymerizable compositions for coatings are applied using various methods such as spray coating (e.g., electrostatic spraying), fog coating, dip coating, or combinations thereof. In some embodiments, fog coatings are useful in that the fog can be created by pressure and a small nozzle, or with an ultrasonic humidifier. In such fogs, the object to be coated is placed in the fog. In some embodiments, the object can be rotated in different orientations to facilitate even coverage and/or blowers can move the fog around to part. In some embodiments, such methods can be useful for obtaining an even coating onto the object by varying the amount of time spent in the fog, the density of the fog (e.g., droplet concentration), and/or the size of the droplets. In some embodiments, fog and ultrasonic methods require low viscosity to form small droplets.

In some embodiments, dip coatings are used and can involve low viscosity liquids that make it easy to fling off or spin off the excess liquid. In some embodiments, a polymerizable composition is heated as a liquid to reduce the viscosity. In some embodiments, the method includes steps of controlling the viscosity of the polymerizable composition as a liquid to control the thickness of the initial liquid layer that stays with the object when removed from the dip bath (e.g., the polymeric coating).

In some embodiments, the polymerizable composition is heated and the object to be coated is cooled. In some embodiments, when the object is dipped into the polymerizable composition, a layer of the polymerizable composition and/or polymeric coating forms at or on the surface of the object. In some embodiments, the thickness of the polymeric coating is controlled using a variety of methods, including controlling the time spent in the polymerizable composition (e.g., the dipping time), the temperature of the polymerizable composition, and/or the temperature of the object. Similarly, parameters for other techniques (e.g., spray coating, fog coating) may be modified to achieve desirable results. For example, in some embodiments, excess polymerizable composition (e.g., as a liquid) can be centrifuged off the object or left on the object, depending on the amount left on the object and the desired coating thickness. In some embodiments, freeze coatings are used for very low viscosity liquids as most of the unfrozen liquid can run off very quickly and may not require spinning or shaking off of excess liquid.

Some embodiments do not require shaking or flinging excess coating liquid off the object. Other embodiments may require such action to obtain a uniform coating. In some embodiments, centrifugal methods are particularly useful when performed at different angles or orientations of the object and/or by a multiaxial centrifuge. In some embodiments, the g-force used depends on the viscosity and/or temperature. In some embodiments, the applied g-force, the centrifugation time, and the temperature are used to control the amount of polymerizable composition, and thus the thickness of the polymeric coating, that remains on the object.

In some embodiments, a freeze coating method is used, and a cold solvent spray or dip/wash is used to remove any non-solidified coating (the temperature of the solvent may be near but below the melting temperature of the solidified coating to prevent it from being removed while the liquid portion of the coating is removed). In some embodiments, the solvent is evaporated, and the coating material recovered for reuse.

In some embodiments, a method for coating an object includes one or more of the following steps: an object (pre- or post-cure) is coated with a liquid polymerizable composition; the excess coating liquid is removed; the coating is allowed to cure; the object is marked with an identification marking (e.g., laser marked or marked with an ink jet printer); and/or a solvent wash, extraction, and/or sterilization step occurs. In some embodiments, the order of operations can be different than the above.

### F. Methods of Use and Associated Devices

The present disclosure provides methods for synthesizing the polymerizable compounds of the present disclosure, methods of using compositions (e.g., polymerizable compositions and polymeric materials) comprising such compounds, as well as methods for using the compositions in various types of objects. Moreover, the present disclosure provides objects that comprise a polymeric material of the present disclosure. For instance, the bulk material or substrate of the object can be composed of the polymeric material, the object can include a coating composed of the polymeric material, or a combination thereof. As described herein, such polymeric material can comprise, incorporated in its polymeric structure, one or more species of polymerizable compounds of this disclosure.

In some embodiments, the present disclosure provides a method of additive manufacturing using the polymerizable compositions described herein. The method can include fabricating an object from a polymerizable composition as described herein according to an additive manufacturing process. The additive manufacturing process can include providing a polymerizable composition (e.g., a photocurable resin), and applying energy (e.g., light) to the polymerizable composition to form a polymeric material (e.g., via photocuring), where at least a portion of the object is composed of the polymeric material.

In some embodiments, a method herein comprises the step of fabricating an object using an additive manufacturing system or device, wherein the additive manufacturing system or device facilitates curing (e.g., photocuring) of the polymerizable composition. For example, the additive manufacturing system or device can include an energy source (e.g., a light source) that produces the energy (e.g., light) to which the polymerizable composition is exposed for curing. In some embodiments, the curing of the polymerizable composition produces a cured polymeric material. In some embodiments, a polymerizable composition is cured using an additive manufacturing system or device to produce the cured polymeric material.

In some embodiments, the method further comprises heating the polymerizable composition to a processing temperature, such as a printing temperature. In some embodiments, the processing temperature is within a range from about 50 °C to about 120 °C. In some embodiments, the processing temperature is within a range from about 90 °C to about 110 °C, from about 100 °C to about 120 °C, from about 105 °C to about 115 °C, or from about 108 °C to about 110 °C. In some embodiments, the processing temperature is less than 80 °C. In some embodiments, the processing temperature is less than 40 °C, less than 35 °C, less than 30 °C, or less than 27 °C. In some embodiments, the methods disclosed herein for forming a polymeric material are part of a high temperature lithography-based photopolymerization process, wherein the polymerizable composition is heated to an elevated printing temperature (e.g., from about 50 °C to about 120 °C, such as from about 90 °C to about 120 °C).

In some embodiments, the additive manufacturing process is a layer-by-layer process, such that the object is composed of a plurality of layers of the polymeric material. One embodiment provides a method for preparing an object by an additive manufacturing process, comprising: providing a polymerizable composition according to the embodiments disclosed herein; exposing the polymerizable composition to radiation; polymerizing the polymerizable composition layer-by-layer based on a predefined design, thereby polymerizing the polymerizable composition to form a polymeric material; and fabricating the object with the polymeric material.

In some embodiments, the method further comprises post-processing of the object after additive manufacturing. The post-processing can include a step of cleaning the cured polymeric material. In some embodiments, the cleaning of the cured polymeric material includes removing uncured polymerizable composition via centrifugation. In some embodiments, the centrifugation uses tension, compression, or a combination of tension and compression. In some embodiments, the cleaning of the cured polymeric material includes washing and/or rinsing the cured polymeric material with a solvent, which can remove uncured polymerizable composition and/or undesired impurities from the cured polymeric material. In some embodiments, the cleaning of the cured polymeric material further comprises chemical cleaning and/or extracting leachable components from the polymeric material via chemical processes using organic solvents, water, CO₂, (e.g., liquid CO₂), etc.

In some embodiments, the present disclosure provides a method of fabricating a coated object using the polymerizable compositions described herein. The method can include providing an object, applying a polymerizable composition (e.g., a photocurable resin) to the object, and applying energy (e.g., light) to the polymerizable composition to form a polymeric coating on the object (e.g., via photocuring). The object may be fabricated via any additive manufacturing process or any other suitable process. For instance, the object may be fabricated from a second polymerizable composition, which may or may not be the same as the polymerizable composition used for the polymeric coating. The polymerizable composition may be applied to the object using any suitable technique, such as dip coating, spray coating, fog coating, etc.

In some embodiments, the polymeric coating is covalently bound to the surface of the object. In some embodiments, the object has not undergone a curing step. In some embodiments, the object has undergone a curing step. In some embodiments, the object is partially cured. In some embodiments, the applying of the polymerizable composition, the applying of the energy, or both are performed under an inert atmosphere. In some embodiments, the applying of the polymerizable composition, the applying of the energy, or both are performed under an atmosphere that includes less than 5% oxygen. In some embodiments, the applying of the polymerizable composition, the applying of the energy, or both are not performed under an atmosphere that includes less than 5% oxygen.

In some embodiments, the present disclosure provides methods for using the polymerizable compounds, polymerizable compositions comprising such compounds, as well as polymeric materials produced from such compositions, for the fabrication of a medical device. In some embodiments, the medical device is a dental appliance, such as a mouthguard (e.g., sportsguard, nightguard), aligner, retainer, palatal expander, bite splint, bite positioner, dental spacer, etc.

A “mouthguard” may refer to a protective device for a user's mouth that covers the teeth and (optionally the gingiva) to prevent and/or reduce injury to the maxillofacial region such as the teeth, lips, gingiva, etc. The disclosed mouthguards can be used for sports, to treat teeth grinding, or as a part of certain dental procedures. The mouthguards can be also described as a mouth protector, sportsguard, mouth piece, gumshield, gumguard, nightguard, occlusal splint, bite splint, bite plane, bite positioners, or jaw positioners. The disclosed mouthguards can be used as a carrier for intraoral sensors for tracking patient data, including but not limited to temperature, pH values, chemical indicators, bite forces, grinding forces, and/or acceleration during sports activities or impact events.

A “dental aligner” or “aligner” may refer to an orthodontic device for correcting teeth alignment. Such devices may be transparent and/or composed of plastic.

Additional examples and details of mouthguards and other dental appliances that may be fabricated according to the methods of the present technology are provided in Sections III and IV below.

In some embodiments, a method for fabricating a dental appliance from a polymerizable composition described herein is provided. The method can include additive manufacturing of the dental appliance from the polymerizable composition. The method can include forming a polymeric coating (e.g., a protective coating) on the dental appliance from the polymerizable composition. The method can include receiving a file containing instructions for fabrication of the dental appliance from the polymerizable composition.

Fabrication of a dental appliance from the polymerizable compositions described herein can confer many advantages. For instance, such dental appliances may exhibit improved shock absorption, force dissipation, strength, durability, hardness, resilience, fatigue resistance, tear resistance, fracture resistance, thermal stability, antimicrobial properties, stain resistance, etc., compared to dental appliances formed from conventional materials (e.g., ethylene-vinyl acetates, polyurethanes, conventional resins for additive manufacturing). In some embodiments, the polymerizable compositions described herein are well-suited for the fabrication of mouthguards for protecting a patient's teeth from impacts, bruxism, abrasion, clenching, etc., e.g., as described in Section IV below. For example, polymeric materials prepared from the polymerizable compositions described herein can have properties that are configured to dissipate forces applied to an object to be protected (e.g., a subject's teeth and/or maxillofacial region), such as by absorbing kinetic energy via controlled deformation, conversion of kinetic energy into heat, redirecting the applied force away from the object, and/or distributing the applied force over a greater surface area.

In some embodiments, a dental appliance formed from the polymerizable compositions herein exhibits shock absorption properties. Shock absorption can be measured, for example, using rebound or drop testing of a sample (e.g., having a thickness within a range from 2 mm to 4 mm) at a suitable impact energy (e.g., an impact energy of 0.5 J, 1.13 J, 8 J, or more) using a suitable impactor geometry (e.g., an impactor having an edge-hemisphere with a diameter within a range from 10 mm to 15 mm, a spherical impactor with a diameter within a range from 20 mm to 250 mm, or a flat impactor), where lower rebound values are indicative of greater shock absorption. In some embodiments, the dental appliances herein have a rebound value less than or equal to 30%, 25%, 20%, 15%, 10%, or 5%. In some embodiments, the resulting absorbed and/or dissipated energy from the impact event is greater than or equal to 70%, 75%, 80%, 85%, 90%, or 95%. In some embodiments, a shock absorbing ability of a dental appliance formed from the polymerizable composition is greater than or equal to 20% and less than or equal to 70%, less than or equal to 80%, less than or equal to 90%, or less than or equal to 100%.

In some embodiments, a dental appliance formed from the polymerizable compositions herein dissipates applied forces by distributing the forces over a greater surface area, thus reducing the stress experience at any single location on the dental appliance, thereby reducing the likelihood of localized damage. For example, the dental appliances herein can be configured to direct impact forces away from vulnerable areas (e.g., the front teeth and molars). This redirection may be particularly beneficial for contact sports, where blunt force trauma may result in severe dental injuries. Improved force distribution may be achieved by increasing the thickness of the dental appliance at or near the locations of vulnerable areas and/or by adding shock absorbing features at or near the locations of vulnerable areas. Improved force distribution may also be achieved by increasing the modulus (e.g., elastic modulus, tensile modulus, flexural modulus) and/or hardness of the dental appliance, and/or by applying a hard coating to the dental appliance.

In some embodiments, a dental appliance formed from the polymerizable compositions herein has an elastic modulus greater than or equal to 5 MPa, 10 MPa, 20 MPa, 50 MPa, 100 MPa, 250 MPa, 350 MPa, 450 MPa, or 550 MPa; and/or an elastic modulus within a range from 0.5 MPa to 500 MPa, from 2 MPa to 250 MPa, or from 10 MPa to 150 MPa.

In some embodiments, a dental appliance formed from the polymerizable compositions herein has a tensile modulus greater than or equal to 1 MPa, 2 MPa, 5 MPa, 10 MPa, 20 MPa, 50 MPa, 100 MPa, or 200 MPa. In some embodiments, a dental appliance (e.g., mouthguard) formed from the polymerizable compositions herein has a tensile strength greater than or equal to 1 MPa, 2 MPa, 5 MPa, 8 MPa, 10 MPa, 12 MPa, 20 MPa, 25 MPa, 50 MPa.

In some embodiments, a dental appliance formed from the polymerizable compositions herein has a Shore A hardness greater than or equal to 30 A, 50 A, 60 A, 70 A, 80 A, 90 A, or 100 A, and/or a Shore A hardness within a range from 30 A to 100 A, 40 A to 100 A, from 50 A to 90 A, from 50 A to 95 A, from 55 A to 95 A, from 60 A to 95 A, from 70 A to 100 A, or from 75 A to 90 A.

In some embodiments, improved force distribution may also be achieved by providing a multi-material dental appliance including a harder (e.g., Shore A hardness from 80 A to 95 A) and/or stiffer (e.g., elastic modulus from 50 MPa to 500 MPa) outer material, and a softer (e.g., Shore A hardness from 40 A to 80 A) and/or more elastic (e.g., elastic modulus from 0.5 MPa to 50 MPa) inner material.

Impact force distribution may be measured, for example, via an impact force transmission test using a flat impactor (e.g., 40×40 mm²) with a weight of 2.5 kg. By adjusting the drop height of the impactor, the applied energy may be determined. For example, the applied energy may be 2 J, 4 J, 5 J, or 10 J, and the measured transmitted impact force may be smaller than 10 kN, 7.5 kN, 5 kN, or 2 kN.

In some embodiments, a dental appliance formed from the polymerizable compositions herein exhibits sufficient deformation control to avoid excessive displacement in response to applied forces. This may be advantageous to prevent the dental appliance from collapsing or folding in a manner that could impede breathing or cause oral injuries. In some instances, a crosslinked photopolymer (e.g., a thermoset polymer) may provide superior deformation control, with limited or no plastic and/or permanent deformation.

In some embodiments, a dental appliance formed from the polymerizable compositions herein exhibits sufficient elasticity to return to its original shape after deformation due to applied forces. This allows the dental appliance to absorb dynamic forces without sustaining permanent deformation. For example, impact testing may be performed, and the impact area may be evaluated prior and after the impact event to assess any changes in the overall material thickness, and/or any visible damage (e.g., marks, cracks, holes. In some embodiments, after impact testing, the dental appliances herein exhibit a change in overall thickness that is less than or equal to 1 mm, 0.5 mm, 0.2 mm, 0.1 mm, or 0.05 mm, and/or do not exhibit any visible damage.

In some embodiments, a dental appliance formed from the polymerizable compositions herein exhibits sufficient resilience to recover its original shape after compression. This allows the dental appliance to maintain its protective function after multiple impacts. Rebound resilience tests may be performed to measure the percentage of impact energy that a material returns elastically. Materials with low rebound resilience can exhibit superior performance in terms of shock absorption and/or vibration damping. Additional factors such as vibration control, bounce properties, and/or fatigue resistance along with environmental conditions may also be taken into consideration. In some embodiments, the dental appliances herein exhibit a rebound resilience of no greater than 50%, 40%, 30%, 25%, 20%, 15%, 10%, or 5%.

In some embodiments, a dental appliance formed from the polymerizable compositions herein exhibits sufficient fatigue resistance to retain its structural integrity and avoid degradation after repeated impacts or loading. Impact fatigue resistance can be measured, for example, as using cyclic rebound tests of 10 cycles to 100 cycles. In some embodiments, the dental appliances herein exhibit no more than 10% to 50% shock absorption loss over the tested cycles. Fatigue resistance can be measured, for example, using standard coupon shapes in a fatigue tester to measure cycles to failure in cyclic bending, tension, and/or torsional loading. Alternatively, fatigue resistance can be measured in the final, printed form as the number of cycles to failure during repeated insertion/removal cycles on a dentition model, or in a dentition-to-device grinding load configuration. In some embodiments, the dental appliances herein exhibit from 50 load cycles to 1000 load cycles before failure (e.g., for high-load cycles), or from 100 load cycles to 10,000 load cycles before failure (e.g., for low-load cycles).

In some embodiments, a dental appliance formed from the polymerizable compositions herein exhibits sufficient fracture resistance to avoid cracking, breaking, or otherwise fracturing under applied forces (e.g., high impact conditions), thereby preserving structural integrity. In some embodiments, the dental appliances herein exhibit sufficient tear resistance to avoid tearing under stress, thereby providing consistent protection over the lifespan of the appliance. This may be accomplished, for example, through the use of multilayered designs with harder, stiffer, and/or denser outer layers. In some embodiments, the dental appliances herein have a tear resistance greater than or equal to 20 kN/m, 30 kN/m, 40 kN/m, 50 kN/m, 60 kN/m, 70 kN/m, 80 kN/m, 90 kN/m, or 100 kN/m, e.g., as determined in accordance with IS034.

In some embodiments, a dental appliance formed from the polymerizable compositions herein is thermally stable, e.g., due to photopolymerization of the material. Thermal stability can be significant to avoid creep and/or deteriorating mechanical properties at body temperature. Thermal stability may be achieved through the use of materials with a high decomposition temperature (Td). In some embodiments, the dental appliances herein have a Td of at least 60 °C, 100 °C, 150 °C, 200 °C, or 250 °C; and/or a Td within a range from 50 °C to 300 °C, from 80 °C to 250 °C, from 100 °C to 200 °C.

In some embodiments, a dental appliance formed from the polymerizable compositions herein includes antimicrobial properties to reduce or prevent the buildup of bacteria and/or other pathogens. This can reduce the risk of infections and/or other oral health complications associated with prolonged use. Antimicrobial properties may be achieved, for example, by providing an antimicrobial coating on the surface of the appliance and/or by incorporating antimicrobial additives into the polymerizable composition used to fabricate the appliance.

In some embodiments, a dental appliance formed from the polymerizable compositions herein has a water uptake of less than 20 wt %, 15 wt %, 10 wt %, 5 wt %, 4 wt %, 3 wt %, 2 wt %, 1 wt %, 0.5 wt %, 0.25 wt %, or 0.1 wt %, e.g., when measured after 24 hours in a wet environment at 37 °C. In some embodiments, a dental appliance formed from the polymerizable compositions herein has a 1 day water uptake of at least less than 1 wt %, at least less than 0.5 wt %, at least less than 0.01 wt %, at least less than 0.05 wt %, at least less than 0.005 wt %, or at least less than 0.001 wt % as determined in accordance with ISO62.

In some embodiments, an elongation at break of a dental appliance formed from the polymerizable compositions herein is greater than or equal to 20%, greater than or equal to 40%, greater than or equal to 60%, greater than or equal to 80%, greater than or equal to 100%, greater than or equal to 110%, greater than or equal to 120%, or greater than or equal to 130%. In some embodiments, a dental appliance formed from the polymerizable compositions herein has an elongation at break greater than 20%, 50%, 80%, 100%, 150%, 200%, 500% or 1000%; and/or an elongation at break within a range from 50% to 1000%, from 100% to 500%, or from 150% to 300%, e.g., before and after 24 hours in a wet environment at 37 °C.

In some embodiments, a dental appliance formed from the polymerizable compositions herein has a glass transition temperature less than or equal to 50 °C, 40 °C, 25 °C, 0 °C, −20 °C, −30 °C, −40 °C, −50 °C, −60 °C, or −100 °C. In some embodiments, a dental appliance formed from the polymerizable compositions herein has multiple glass transitions and at least one of those glass transitions is at a temperature less than or equal to 50 °C, 40 °C, 25 °C, 0 °C, −20 °C, −30 °C, −40 °C, −50 °C, −60 °C, or −100 °C.

In some embodiments, a dental appliance formed from the polymerizable compositions herein has a retention in use and/or minimum force for displacement of greater than or equal to 1 N, 5 N, 10 N, or 20 N.

In some embodiments, a dental appliance formed from the polymerizable compositions herein is composed of multiple layers. In such embodiments, the peel strength of the bond between any two layers of the appliance can be greater than or equal to 1 N/mm, 2 N/mm, 4 N/mm, 5 N/mm, or 10 N/mm.

In some embodiments, an adhesive force of a dental appliance formed from the polymerizable compositions herein is less than or equal to 2.0 N, or less than or equal to 1.5 N.

In some embodiments, a dental appliance formed from the polymerizable compositions herein is free from tin (Sn), aluminum (Al), antimony (Sb), arsenic (As), barium (Ba), boron (B), cadmium (Cd), chromium III (Cr III), chromium VI (Cr VI), cobalt (Co), copper (Cu), lead (Pb), manganese (Mn), mercury (Hg), nickel (Ni), selenium (Se), strontium (Sr), and/or zinc (Zn), or is substantially free from these elements (e.g., below a limit of 0.1 mg/kg).

Further embodiments of the present disclosure provide a method of repositioning a patient's teeth using such dental appliances, comprising: generating a treatment plan for the patient, the plan comprising a plurality of intermediate tooth arrangements for moving teeth along a treatment path from an initial tooth arrangement toward a final tooth arrangement; producing an dental appliance according to the embodiments disclosed herein, or an dental appliance comprising a polymeric material according to the embodiments disclosed herein; and moving on-track, with the dental appliance, at least one of the patient's teeth toward an intermediate tooth arrangement or the final tooth arrangement.

In some embodiments, the treatment plan is generated using an intraoral scan of the patient's teeth.

In some embodiments, the method further comprises tracking progression of the patient's teeth along the treatment path after administration of the dental appliance to the patient, the tracking comprising comparing a current arrangement of the patient's teeth to a planned arrangement of the patient's teeth.

In some embodiments, greater than 60% of the patient's teeth are on track with the treatment plan after 2 weeks of treatment.

In some embodiments, the dental appliance has a retained repositioning force to the at least one of the patient's teeth after 2 days that is at least 10%, at least 20%, at least 30%, at least 40%, at least 50%, at least 60%, or at least 70% of the repositioning force initially provided to the at least one of the patient's teeth.

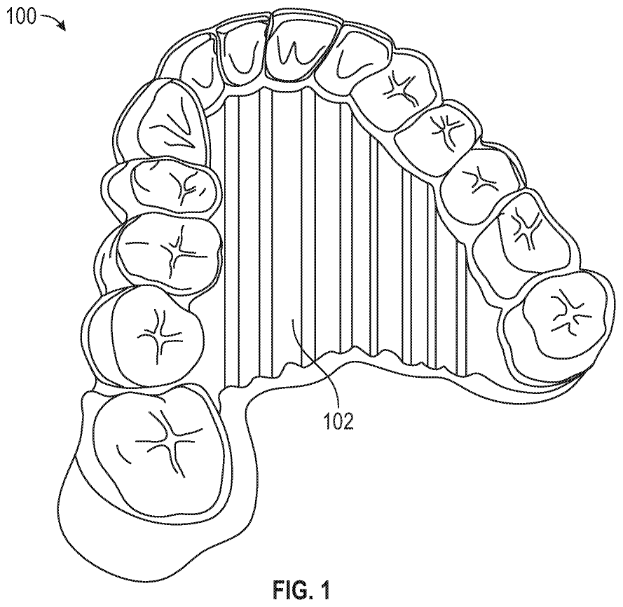

FIG. 1 illustrates a mouthguard 100 prepared from a polymerizable composition in accordance with embodiments of the present technology (the mouthguard 100 is depicted together with support structures 102 connecting the mouthguard 100 to a build platform for additive manufacturing). In some embodiments, the mouthguard 100 formed from the polymerizable composition has a good chemical stability, good long-term stability, low yellowing, high stain resistance, and good protective performance (e.g., improved tear resistance, water uptake, rebound resilience, and absorbed energy).

In other embodiments, however, the methods herein can be used for fabrication of other types of objects, such as devices used in industries such as transportation (e.g., planes, trains, boats, automobiles), hobbyist applications, prototyping, medical applications, art and design, microfluidics, and molds, among others.

### II. Overview of Additive Manufacturing Technology

In some embodiments, the present technology provides methods using additive manufacturing to produce an object from the polymerizable compositions and polymeric materials described in Section I above. In some embodiments, the methods disclosed herein use additive manufacturing to produce an object comprising, consisting essentially of, or consisting of the cured polymeric materials described herein.

Additive manufacturing (also referred to herein as “3D printing”) includes a variety of technologies which fabricate 3D objects directly from digital models through an additive process. For example, additive manufacturing can be used to directly fabricate orthodontic appliances (e.g., aligners, palatal expanders, retainers, attachment placement devices, attachments), restorative objects (e.g., crowns, veneers, implants), and/or other dental appliances (e.g., oral sleep apnea appliances, mouthguards). Additional examples of dental appliances and associated methods that are applicable to the present technology are described in Section III below.

In some embodiments, additive manufacturing includes depositing a precursor material (e.g., a polymeric resin) onto a build platform. The precursor material can be cured, polymerized, melted, sintered, fused, and/or otherwise solidified to form a portion of the object and/or to combine the portion with previously formed portions of the object. In some embodiments, the additive manufacturing techniques provided herein build up the object geometry in a layer-by-layer fashion, with successive layers being formed in discrete build steps. Alternatively or in combination, the additive manufacturing techniques described herein can allow for continuous build-up of an object geometry.

The systems, methods, and devices described herein are suitable for use with a wide variety of additive manufacturing techniques. Examples of additive manufacturing techniques include, but are not limited to, the following: (1) vat photopolymerization, in which an object is constructed from a vat or other bulk source of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, an additive manufacturing process can use a combination of two or more additive manufacturing techniques.

For example, the additively manufactured object can be fabricated using a vat photopolymerization process in which light is used to selectively cure a vat or other bulk source of a curable material (e.g., a polymeric resin). Each layer of curable material can be selectively exposed to light in a single exposure or by scanning a beam of light across the layer. Specific techniques that can be used herein can include SLA, DLP, and TPIP. Vat photopolymerization can be performed in a “top-down” or “bottom-up” approach, depending on the relative locations of the material source, light source, and build platform.

Photopolymerization can occur when a polymerizable composition herein is exposed to radiation (e.g., UV or visible light) of a wavelength sufficient to initiate polymerization. The wavelengths of radiation useful to initiate polymerization may depend on the photoinitiator used. “Light” as used herein can include any wavelength and power capable of initiating polymerization. Some wavelengths of light include ultraviolet or visible light. UV light sources include UVA (wavelengths from about 400 nm to about 320 nm), UVB (wavelengths from about 320 nm to about 290 nm), and UVC (wavelengths from about 290 nm to about 100 nm). Any suitable light source may be used, including laser sources. The light source may be broadband or narrowband, or a combination thereof. The light source may provide continuous or pulsed light during the process. Both the length of time the system is exposed to the light and the intensity of the light can be varied to produce the ideal reaction conditions.

In some embodiments, the additively manufactured object is fabricated using high temperature lithography (also known as “hot lithography”). High temperature lithography can include any photopolymerization process that involves heating a photopolymerizable material (e.g., a polymeric resin). For example, high temperature lithography can involve heating the material to a temperature of at least 30 °C, 40 °C, 50 °C, 60 °C, 70 °C, 80 °C, 90 °C, 100 °C, 110 °C, or 120 °C. In some embodiments, the material is heated to a temperature within a range from 50 °C to 120 °C, from 90 °C to 120 °C, from 100 °C to 120 °C, from 105 °C to 115 °C, or from 105 °C to 110 °C. It is noted other temperature ranges may be used without departing from the scope and substance of the concepts described herein. The heating can lower the viscosity of the photopolymerizable material before and/or during curing, and/or increase reactivity of the photopolymerizable material. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa-s, 10 Pa-s, 15 Pa-s, 20 Pa-s, 30 Pa-s, 40 Pa-s, or 50 Pa-s at 20 °C. Representative examples of high-temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In some embodiments, the additively manufactured object is fabricated using continuous liquid interphase production (also known as “continuous liquid interphase printing”) in which the object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Continuous liquid interphase printing can achieve fabrication speeds about 25 times to about 100 times faster than other direct fabrication methods, and speeds about 1000 times faster can be achieved with the incorporation of cooling systems. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, a continuous additive manufacturing method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety. In another example, a continuous additive manufacturing method can involve extruding a composite material composed of a curable liquid material surrounding a solid strand. The composite material can be extruded along a continuous three-dimensional path in order to form the object. Such methods are described in U.S. Pat. No. 10,162,624 and U.S. Patent Publication No. 2014/0061974, the disclosure of which is incorporated herein by reference in its entirety. In yet another example, a continuous additive manufacturing method can utilize a “heliolithography” approach in which the liquid photopolymer is cured with focused radiation while the build platform is continuously rotated and raised. Accordingly, the object geometry can be continuously built up along a spiral build path. Such methods are described in U.S. Pat. No. 10,162,264 and U.S. Patent Publication No. 2014/0265034, the disclosures of which are incorporated herein by reference in their entirety.

In a further example, the additively manufactured object can be fabricated using a volumetric additive manufacturing (VAM) process in which an entire object is produced from a 3D volume of resin in a single print step, without requiring layer-by-layer build up. During a VAM process, the entire build volume is irradiated with energy, but the projection patterns are configured such that only certain voxels will accumulate a sufficient energy dosage to be cured. Representative examples of VAM processes that may be incorporated into the present technology include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting holographic light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present technology are described in U.S. Pat. No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Patent Application No. 63/181,645, the disclosures of each of which are incorporated herein by reference in their entirety.

In yet another example, the additively manufactured object can be fabricated using a powder bed fusion process (e.g., selective laser sintering) involving using a laser beam to selectively fuse a layer of powdered material according to a desired cross-sectional shape in order to build up the object geometry. As another example, the additively manufactured object can be fabricated using a material extrusion process (e.g., fused deposition modeling) involving selectively depositing a thin filament of material (e.g., thermoplastic polymer) in a layer-by-layer manner in order to form an object. In yet another example, the additively manufactured object can be fabricated using a material jetting process involving jetting or extruding one or more materials onto a build surface in order to form successive layers of the object geometry.

The additively manufactured object can be made of any suitable material or combination of materials. As discussed above, in some embodiments, the additively manufactured object is made partially or entirely out of a polymeric material, such as a curable polymeric resin. The resin can be composed of one or more monomer components that are initially in a liquid state. The resin can be in the liquid state at room temperature (e.g., 20 °C) or at an elevated temperature (e.g., a temperature within a range from 50 °C to 120 °C). When exposed to energy (e.g., light), the monomer components can undergo a polymerization reaction such that the resin solidifies into the desired object geometry. Representative examples of curable polymeric resins and other materials suitable for use with the additive manufacturing techniques herein are described in International Publication Nos. WO 2019/006409, WO 2020/070639, and WO 2021/087061, the disclosures of each of which are incorporated herein by reference in their entirety.

Optionally, the additively manufactured object can be fabricated from a plurality of different materials (e.g., at least two, three, four, five, or more different materials). The materials can differ from each other with respect to composition, curing conditions (e.g., curing energy wavelength), material properties before curing (e.g., viscosity), material properties after curing (e.g., stiffness, strength, transparency), and so on. In some embodiments, the additively manufactured object is formed from multiple materials in a single manufacturing step. For instance, a multi-tip extrusion apparatus can be used to selectively dispense multiple types of materials from distinct material supply sources in order to fabricate an object from a plurality of different materials. Examples of such methods are described in U.S. Pat. Nos. 6,749,414 and 11,318,667, the disclosures of which are incorporated herein by reference in their entirety. Alternatively or in combination, the additively manufactured object can be formed from multiple materials in a plurality of sequential manufacturing steps. For instance, a first portion of the object can be formed from a first material in accordance with any of the fabrication methods herein, then a second portion of the object can be formed from a second material in accordance with any of the fabrication methods herein, and so on, until the entirety of the object has been formed.

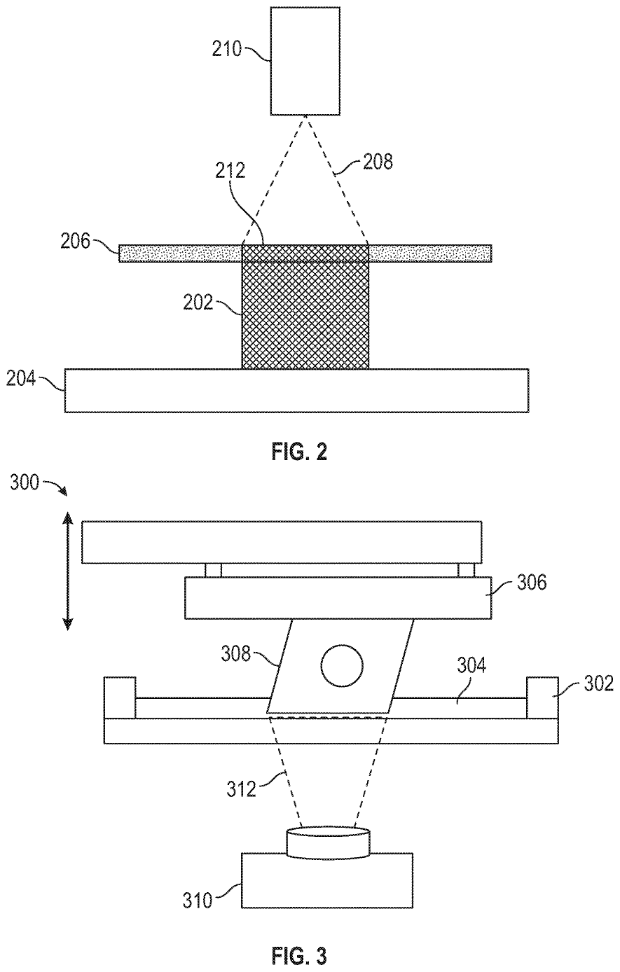

FIG. 2 is a partially schematic diagram providing a general overview of an additive manufacturing process, in accordance with embodiments of the present technology. As shown in FIG. 2, an object 202 is fabricated on a build platform 204 from a series of cured material layers, with each layer having a geometry corresponding to a respective cross-section of the object 202. To fabricate an individual object layer, a layer of curable material 206 (e.g., polymerizable resin) is brought into contact with the build platform 204 (when fabricating the first layer of the object 202) or with the previously formed portion of the object 202 on the build platform 204 (when fabricating subsequent layers of the object 202). In some embodiments, the curable material 206 is formed on and supported by a substrate (not shown), such as a film. Energy 208 (e.g., light) from an energy source 210 (e.g., a laser, projector, or light engine) is then applied to the curable material 206 to form a cured material layer 212 on the build platform 204 or on the object 202. The remaining curable material 206 can then be moved away from the build platform 204 (e.g., by lowering the build platform 204, by moving the build platform 204 laterally, by raising the curable material 206, and/or by moving the curable material 206 laterally), thus leaving the cured material layer 212 in place on the build platform 204 and/or object 202. The fabrication process can then be repeated with a fresh layer of curable material 206 to build up the next layer of the object 202.

The illustrated embodiment shows a “top down” configuration in which the energy source 210 is positioned above and directs the energy 208 down toward the build platform 204, such that the object 202 is formed on the upper surface of the build platform 204. Accordingly, the build platform 204 can be incrementally lowered relative to the energy source 210 as successive layers of the object 202 are formed. In other embodiments, however, the additive manufacturing process of FIG. 2 can be performed using a “bottom up” configuration in which the energy source 210 is positioned below and directs the energy 208 up toward the build platform 204, such that the object 202 is formed on the lower surface of the build platform 204. Accordingly, the build platform 204 can be incrementally raised relative to the energy source 210 as successive layers of the object 202 are formed.

Although FIG. 2 illustrates a representative example of an additive manufacturing process, this is not intended to be limiting, and the embodiments described herein can be adapted to other types of additive manufacturing systems (e.g., vat-based systems) and/or other types of additive manufacturing processes (e.g., material jetting, binder jetting, material extrusion, powder bed fusion, sheet lamination, directed energy deposition).

FIG. 3 is a partially schematic diagram of an additive manufacturing device 300, in accordance with embodiments of the present technology. The device 300 may be used in a high temperature lithography additive manufacturing process. The device 300 includes a vat 302 configured to hold a curable material 304 (e.g., a photopolymer), a build platform 306 configured to support an object 308 to be fabricated from the curable material 304, and a light source 310 (e.g., a light engine). The vat 302 and/or build platform 306 may both be heated to reduce the viscosity of the curable material 304. To fabricate an individual object layer, the build platform 306 can be lowered toward the vat 302 until the distance between the surface of the build platform 306 (when fabricating the first layer of the object 308) or the surface of the object 308 (when fabricating subsequent layers of the object 308) and the bottom surface of the vat 302 corresponds to a desired layer thickness. Light 312 from the light source 310 can then be applied to the thin layer of curable material 304 between the bottom surface of the vat 302 and the surface of the build platform 306 or object 308, thereby forming a cured material layer on the build platform 306 or on the object 308. The vat 302 can be at least partially transparent to allow the light 312 to pass through the vat 302 and into the curable material 304. The build platform 306 can then be raised to separate the cured material layer from the bottom surface of the vat 302 and to allow fresh curable material 304 to fill the space between the cured material layer and the bottom surface of the vat 302. The fabrication process can then be repeated to build up the next layer of the object 308.

The direct fabrication approaches described herein can provide various advantages compared to other manufacturing approaches. For instance, in contrast to indirect fabrication, direct fabrication permits production of a dental appliance without utilizing any molds or templates for shaping the appliance, thus reducing the number of manufacturing steps involved and improving the resolution and accuracy of the final appliance geometry. Additionally, direct fabrication permits precise control over the three-dimensional geometry of the appliance, such as the appliance thickness. Complex structures and/or auxiliary components can be formed integrally as a single piece with the appliance shell in a single manufacturing step, rather than being added to the shell in a separate manufacturing step. In some embodiments, direct fabrication is used to produce appliance geometries that would be difficult to create using alternative manufacturing techniques, such as appliances with very small or fine features, complex geometric shapes, undercuts, interproximal structures, shells with variable thicknesses, and/or internal structures (e.g., for improving strength with reduced weight and material usage). For example, in some embodiments, the direct fabrication approaches herein permit fabrication of a dental appliance with feature sizes of less than or equal to about 5 μm, or within a range from about 5 μm to about 50 μm, or within a range from about 20 μm to about 50 μm.

In some embodiments, the direct fabrication techniques described herein can be used to produce dental appliances with substantially isotropic material properties, e.g., substantially the same or similar strengths along all directions. In some embodiments, the direct fabrication approaches herein permit production of a dental appliance with a strength that varies by no more than about 25%, about 20%, about 15%, about 10%, about 5%, about 1%, or about 0.5% along all directions. Additionally, the direct fabrication approaches herein can be used to produce dental appliances at a faster speed compared to other manufacturing techniques. In some embodiments, the direct fabrication approaches herein allow for production of a dental appliance in a time interval less than or equal to about 1 hour, about 30 minutes, about 25 minutes, about 20 minutes, about 15 minutes, about 10 minutes, about 5 minutes, about 4 minutes, about 3 minutes, about 2 minutes, about 1 minutes, or about 30 seconds. Such manufacturing speeds allow for rapid “chair-side” production of customized appliances, e.g., during a routine appointment or checkup.

In some embodiments, the direct fabrication methods described herein implement process controls for various system parameters of a direct fabrication system or device in order to ensure that the resultant appliances are fabricated with a high degree of precision. Such precision can be beneficial for ensuring accurate delivery of a desired force system to the teeth in order to effectively elicit tooth movements. Process controls can be implemented to account for process variability arising from multiple sources, such as the material properties, system parameters, environmental variables, and/or post-processing parameters.

Material properties may vary depending on the properties of raw materials, purity of raw materials, and/or process variables during mixing of the raw materials. In many embodiments, resins or other materials for direct fabrication are manufactured with tight process control to ensure little variability in photo-characteristics, material properties (e.g., viscosity, surface tension), physical properties (e.g., modulus, strength, elongation), and/or thermal properties (e.g., glass transition temperature, heat deflection temperature). Process control for a material manufacturing process can be achieved with screening of raw materials for physical properties and/or control of temperature, humidity, and/or other process parameters during the mixing process. By implementing process controls for the material manufacturing procedure, reduced variability of process parameters and more uniform material properties for each batch of material can be achieved. Residual variability in material properties can be compensated with process control on the system, as discussed further herein.

The additive manufacturing processes herein can be implemented by any suitable fabrication system or device. The system can implement one or more system parameters, such as curing parameters. For DLP-based curing systems, curing parameters can include power, curing time, and/or grayscale of the full image. For laser-based curing systems, curing parameters can include power, speed, beam size, beam shape and/or power distribution of the beam. For inkjet printing systems, curing parameters can include material drop size, viscosity, and/or curing power. These system parameters can be monitored and adjusted on a regular basis (e.g., some parameters at every 1-x layers and some parameters after each build) as part of the process control on the fabrication system. Process control can be achieved by including a sensor on the system that measures power and/or other system parameters every layer or every few seconds and automatically adjusts them with a feedback loop. For DLP systems, grayscale can be measured and calibrated before, during, and/or at the end of each build, and/or at predetermined time intervals (e.g., every n^{th} build, once per hour, once per day, once per week), depending on the stability of the system. In addition, material properties and/or photo-characteristics can be provided to the fabrication system, and a system process control module can use these parameters to adjust system parameters (e.g., power, time, grayscale) to compensate for variability in material properties. By implementing process controls for the fabrication system, reduced variability in appliance accuracy and residual stress can be achieved.

In some embodiments, environmental variables (e.g., temperature, humidity, sunlight or exposure to other energy/curing source) are maintained in a tight range to reduce variability in appliance thickness and/or other properties. Optionally, system parameters can be adjusted to compensate for environmental variables.

In some embodiments, post-processing of appliances includes cleaning, post-curing, annealing, extraction, and/or support removal processes. Relevant post-processing parameters can include purity of the cleaning agent, cleaning pressure, cleaning forces and/or temperature, cleaning time, post-curing energy and/or time, and/or consistency of support removal process. These parameters can be measured and adjusted as part of a process control scheme. In addition, appliance physical properties can be varied by modifying the post-processing parameters. Adjusting post-processing system parameters can provide another way to compensate for variability in material properties and/or system properties.

### III. Dental Appliances and Associated Methods

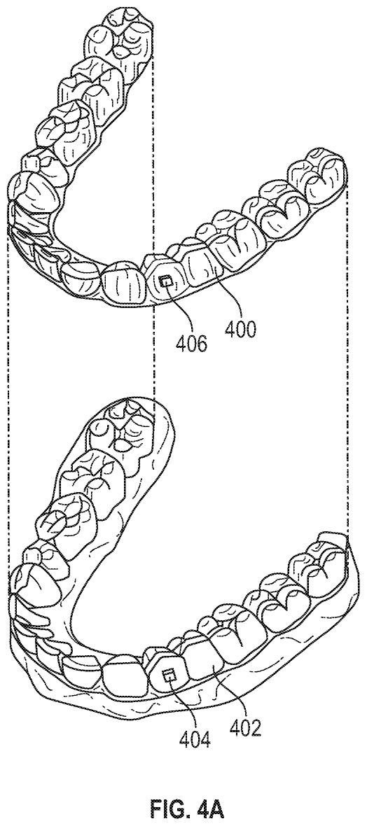

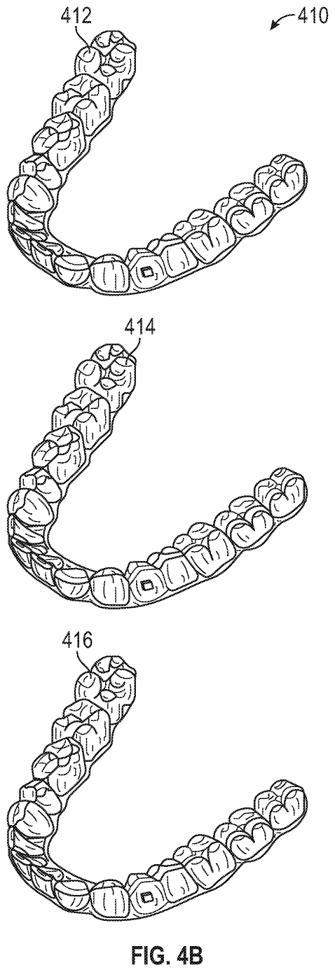

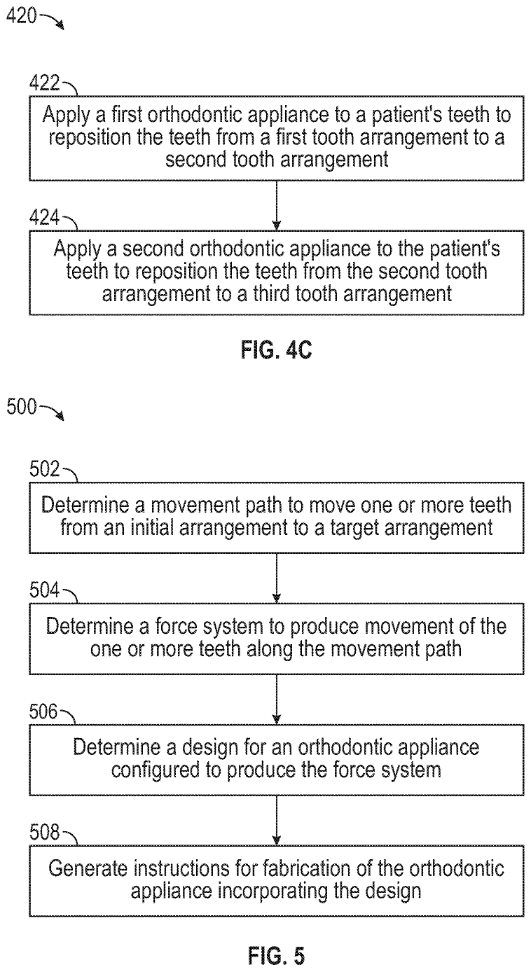

FIG. 4A illustrates a representative example of a tooth repositioning appliance 400 configured in accordance with embodiments of the present technology. The appliance 400 can be manufactured using any of the compositions, methods, and devices described herein. The appliance 400 (also referred to herein as an “aligner”) can be worn by a patient in order to achieve an incremental repositioning of individual teeth 402 in the jaw. The appliance 400 can include a shell (e.g., a continuous polymeric shell or a segmented shell) having teeth-receiving cavities that receive and resiliently reposition the teeth. The appliance 400 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 400 can fit over all teeth present in an upper or lower jaw, or less than all of the teeth. The appliance 400 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 400 can be a generic appliance configured to receive the teeth, but not necessarily shaped to match the topography of the patient's teeth. In some cases, only certain teeth received by the appliance 400 are repositioned by the appliance 400 while other teeth can provide a base or anchor region for holding the appliance 400 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 400 in place over the teeth. In some cases, however, it may be desirable or necessary to provide individual attachments 404 or other anchoring elements on teeth 402 with corresponding receptacles 406 or apertures in the appliance 400 so that the appliance 400 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 4B illustrates a tooth repositioning system 410 including a plurality of appliances 412, 414, 416, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 410 can include a first appliance 412 corresponding to an initial tooth arrangement, one or more intermediate appliances 414 corresponding to one or more intermediate arrangements, and a final appliance 416 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 4C illustrates a method 420 of orthodontic treatment using a plurality of appliances, in accordance with embodiments of the present technology. The method 420 can be practiced using any of the appliances or appliance sets described herein. In block 422, a first orthodontic appliance is applied to a patient's teeth in order to reposition the teeth from a first tooth arrangement to a second tooth arrangement. In block 424, a second orthodontic appliance is applied to the patient's teeth in order to reposition the teeth from the second tooth arrangement to a third tooth arrangement. The method 420 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

The configuration of the orthodontic appliances herein can be determined according to a treatment plan for a patient, e.g., a treatment plan involving successive administration of a plurality of appliances for incrementally repositioning teeth. Computer-based treatment planning and/or appliance manufacturing methods can be used in order to facilitate the design and fabrication of appliances. For instance, one or more of the appliance components described herein can be digitally designed and fabricated with the aid of computer-controlled manufacturing devices (e.g., computer numerical control (CNC) milling, computer-controlled additive manufacturing). The computer-based methods presented herein can improve the accuracy, flexibility, and convenience of appliance fabrication.

FIG. 5 illustrates a method 500 for designing an orthodontic appliance, in accordance with embodiments of the present technology. The method 500 can be applied to any embodiment of the orthodontic appliances described herein. Some or all of the steps of the method 500 can be performed by any suitable data processing system or device, e.g., one or more processors configured with suitable instructions.

In block 502, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 504, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 504 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 506, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systemes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 508, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 500 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 500 may be performed with any suitable fabrication system or device, such as the embodiments described herein. Some of the steps may be optional, e.g., the process of block 504 can be omitted, such that the orthodontic appliance is designed based on the desired tooth movements and/or determined tooth movement path, rather than based on a force system. Moreover, the order of the steps can be varied as desired.

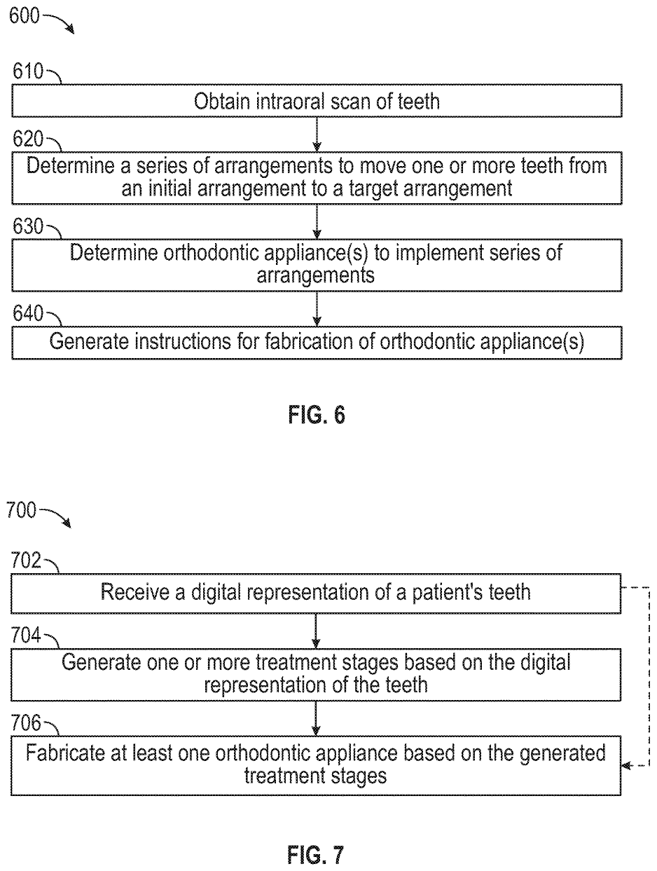

FIG. 6 illustrates a method 600 for digitally planning an orthodontic treatment, in accordance with embodiments of the present technology. The method 600 can be applied to any embodiment of the orthodontic appliances described herein. Some or all of the steps of the method 600 can be performed by any suitable data processing system or device, e.g., one or more processors configured with suitable instructions.

In block 610, an intraoral scan of a patient's teeth is obtained. The intraoral scan can be an intraoral scan of the patient's teeth or mouth tissue (e.g., using wax bites, direct contact scanning, x-ray imaging, tomographic imaging, sonographic imaging, and other techniques for obtaining information about the position and structure of the teeth, jaws, gums and other orthodontically relevant tissue). From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

In block 620, a series of arrangements to move one or more teeth from an initial arrangement to a target arrangement is determined. The initial arrangement can be determined from the intraoral scan as discussed above. The target arrangement of the teeth (e.g., a desired and intended result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 630, a determination of orthodontic appliance(s) to implement the series of arrangements is made. The determination may be made using knowledge related to a force system that can be used to produce movement of one or more teeth along the movement path. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully formed suture. Thus, in juvenile patients and others without fully closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients will typically require lower forces to expand the suture than older patients, as the suture has not yet fully formed.

Accordingly, an optional additional step for block 640 may be determining a configuration of an arch or palate expander design for an orthodontic appliance to produce the force system. Determination of the arch or palate expander design, appliance geometry, material composition, and/or properties can be performed using a treatment or force application simulation environment. A simulation environment can include, e.g., computer modeling systems, biomechanical systems, or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from several vendors can be used, including finite element analysis packages from ANSYS, Inc., of Canonsburg, PA, and SIMULIA(Abaqus) software products from Dassault Systemes of Waltham, MA.

Optionally, one or more arch or palate expander designs can be selected for testing or force modeling. As noted above, a desired tooth movement, as well as a force system required or desired for eliciting the desired tooth movement, can be identified. Using the simulation environment, a candidate arch or palate expander design can be analyzed or modeled for determination of an actual force system resulting from use of the candidate appliance. One or more modifications can optionally be made to a candidate appliance, and force modeling can be further analyzed as described, e.g., to iteratively determine an appliance design that produces the desired force system.

In block 640, instructions for fabrication of the orthodontic appliance(s) (optionally incorporating an arch or palate expander design) are generated. The instructions can be configured to control a fabrication system or device to produce the orthodontic appliance(s). In some embodiments, the instructions are configured for manufacturing the orthodontic appliance(s) using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance(s), e.g., by thermoforming.

In some embodiments, the method 600 may comprise additional steps: 1) the upper arch and palate of the patient is scanned intraorally to generate three-dimensional data of the palate and upper arch; and/or 2) the three-dimensional shape profile of the appliance is determined to provide a gap and teeth engagement structures as described herein.

Although the above steps show a method 600 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 600 may be performed with any suitable fabrication system or device, such as the embodiments described herein. Some of the steps may be optional, and the order of the steps can be varied as desired.

FIG. 7 illustrates a method 700 for digitally planning an orthodontic treatment and/or design or fabrication of an appliance, in accordance with embodiments. The method 700 can be applied to any of the treatment procedures described herein and can be performed by any suitable data processing system.

In block 702, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 704, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 706, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 7, design and/or fabrication of an orthodontic appliance, and perhaps a particular orthodontic treatment, may include use of a representation of the patient's teeth (e.g., including receiving a digital representation of the patient's teeth (block 702)), followed by design and/or fabrication of an orthodontic appliance based on a representation of the patient's teeth in the arrangement represented by the received representation.

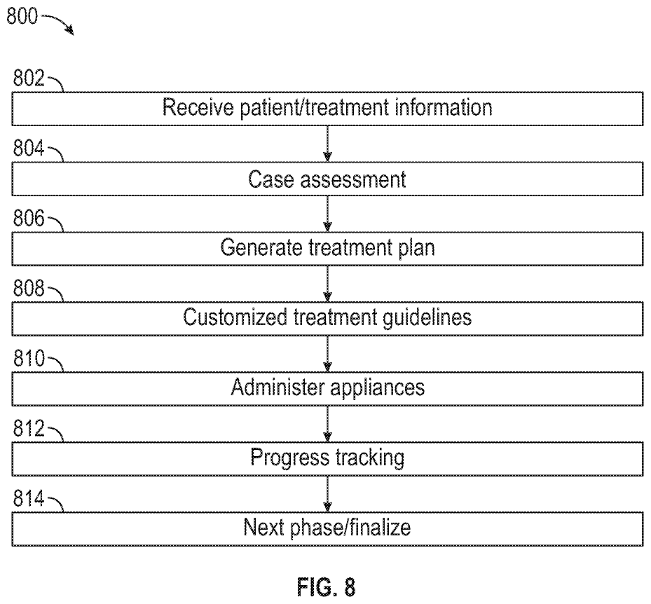

FIG. 8 illustrates a method 800 for generating and administering an orthodontic treatment, in accordance with embodiments of the present technology. Individual embodiments of the method 800 are discussed in further detail below. The method 800 includes receiving information regarding the orthodontic condition of the patient and/or treatment information (block 802), generating an assessment of the case (block 804), and generating a treatment plan for repositioning the patient's teeth (block 806). Briefly, the patient/treatment information (block 802) includes data comprising an initial arrangement of the patient's teeth, which includes obtaining an impression or scan of the patient's teeth prior to the onset of treatment and can further include identification of one or more treatment goals selected by the practitioner and/or patient. A case assessment can be generated (block 804) to assess the complexity or difficulty of moving the particular patient's teeth in general, or specifically corresponding to identified treatment goals, and may further include practitioner experience and/or comfort level in administering the desired orthodontic treatment. In some cases, however, the assessment can include simply identifying treatment options (e.g., appointment planning, progress tracking, etc.) that are of interest to the patient and/or practitioner. The information and/or corresponding treatment plan (block 806) includes identifying a final or target arrangement of the patient's teeth that is desired, as well as a plurality of planned successive or intermediate tooth arrangements for moving the teeth along a treatment path from the initial arrangement toward the selected final or target arrangement.

The method 800 further includes generating customized treatment guidelines (block 808). The treatment plan may include multiple phases of treatment, with a customized set of treatment guidelines generated that correspond to a phase of the treatment plan. The guidelines can include detailed information on timing and/or content (e.g., specific tasks) to be completed during a given phase of treatment and can be of sufficient detail to guide a practitioner, including a less experienced practitioner or practitioner relatively new to the orthodontic treatment process, through the phase of treatment. Since the guidelines are designed to specifically correspond to the treatment plan and provide guidelines on activities specifically identified in the treatment information and/or generated treatment plan, the guidelines can be customized. The customized treatment guidelines are then provided to the practitioner to help instruct the practitioner in how to deliver a given phase of treatment. As set forth above, appliances can be generated based on the planned arrangements and can be provided to the practitioner and ultimately administered to the patient (block 810). The appliances can be provided and/or administered in sets or batches of appliances, such as 2, 3, 4, 5, 6, 7, 8, 9, or more appliances, but are not limited to any administrative scheme. Appliances can be provided to the practitioner concurrently with a given set of guidelines, or appliances and guidelines can be provided separately.

After the treatment according to the plan begins and following administration of appliances to the patient, treatment progress tracking, e.g., by teeth matching, is done to assess a current and actual arrangement of the patient's teeth compared to a planned arrangement (block 812). If the patient's teeth are determined to be “on-track” and progressing according to the treatment plan, then treatment progresses as planned and treatment progresses to the next stage of treatment (block 814). If the patient's teeth have substantially reached the initially planned final arrangement, then treatment progresses to the final stages of treatment (block 814). Where the patient's teeth are determined to be tracking according to the treatment plan, but have not yet reached the final arrangement, the next set of appliances can be administered to the patient.

The threshold difference values of a planned position of teeth to actual positions selected as indicating that a patient's teeth have progressed on-track are provided below in Table 1. If a patient's teeth have progressed at or within the threshold values, the progress is on-track. If a patient's teeth have progressed beyond the threshold values, the progress is off-track.

TABLE 1

| Type Movement | Difference Actual/Planned | |
|---|---|---|
| Rotations | | |
| Upper Central Incisors | 9 | degrees |
| Upper Lateral Incisors | 11 | degrees |
| Lower Incisors | 11 | degrees |
| Upper Cuspids | 11 | degrees |
| Lower Cuspids | 9.25 | degrees |
| Upper Bicuspids | 7.25 | degrees |
| Lower First Bicuspid | 7.25 | degrees |
| Lower Second Bicuspid | 7.25 | degrees |
| Molars | 6 | degrees |
| Extrusion | | |
| Anterior | 0.75 | mm |
| Posterior | 0.75 | mm |
| Intrusion | | |
| Anterior | 0.75 | mm |
| Posterior | 0.75 | mm |
| Angulation | | |
| Anterior | 5.5 | degrees |
| Posterior | 3.7 | degrees |
| Inclination | | |
| Anterior | 5.5 | degrees |
| Posterior | 3.7 | degrees |
| Translation | | |
| BL Anterior | 0.7 | mm |
| BL Posterior Cuspids | 0.9 | mm |
| MD Anterior | 0.45 | mm |
| MD Cuspids | 0.45 | mm |
| MD Posterior | 0.5 | mm |

The patient's teeth are determined to be on track by comparison of the teeth in their current positions with teeth in their expected or planned positions, and by confirming the teeth are within the parameter variance disclosed in Table 1. If the patient's teeth are determined to be on track, then treatment can progress according to the existing or original treatment plan. For example, a patient determined to be progressing on track can be administered one or more subsequent appliances according to the treatment plan, such as the next set of appliances. Treatment can progress to the final stages and/or can reach a point in the treatment plan where bite matching is repeated for a determination of whether a patient's teeth are progressing as planned or if the teeth are off track.

In some embodiments, as further disclosed herein, this disclosure provides methods of treating a patient using an additively manufactured orthodontic appliance. In some embodiments, the method of repositioning a patient's teeth (or, in some embodiments, a singular tooth) comprises: generating a treatment plan for the patient, the plan comprising a plurality of intermediate tooth arrangements for moving teeth along a treatment path from an initial arrangement toward a final arrangement; producing an additively manufactured orthodontic appliance; and moving on-track, with the orthodontic appliance, at least one of the patient's teeth toward an intermediate arrangement or a final tooth arrangement. On-track performance can be determined, e.g., from Table 1, above.

In some embodiments, the method further comprises tracking the progression of the patient's teeth along the treatment path after administration of the orthodontic appliance. In some embodiments, the tracking comprises comparing a current arrangement of the patient's teeth to a planned arrangement of the teeth. As a non-limiting example, following the initial administration of the orthodontic appliance, a period of time passes (e.g., two weeks), a comparison of the now-current arrangement of the patient's teeth (i.e., at two weeks of treatment) can be compared with the teeth arrangement of the treatment plan. In some embodiments, the progression can also be tracked by comparing the current arrangement of the patient's teeth with the initial configuration of the patient's teeth. The period of time can be, for example, greater than 3 days, greater than 4 days, greater than 5 days, greater than 6 days, greater than 7 days, greater than 8 days, greater than 9 days, greater than 10 days, greater than 11 days, greater than 12 days, greater than 13 days, greater than 2 weeks, greater than 3 weeks, greater than 4 weeks, or greater than 2 months. In some embodiments, the period can be from at least 3 days to at most 4 weeks, from at least 3 days to at most 3 weeks, from at least 3 days to at most 2 weeks, from at least 4 days to at most 4 weeks, from at least 4 days to at most 3 weeks, or from at least 4 days to at most 2 weeks. In some embodiments, the period can restart following the administration of a new orthodontic appliance.

In some embodiments, greater than 50%, greater than 55%, greater than 60%, greater than 65%, greater than 70%, greater than 75%, greater than 80%, greater than 85%, greater than 90%, greater than 91%, greater than 92%, greater than 93%, greater than 94%, greater than 95%, greater than 96%, greater than 97%, greater than 98%, or greater than 99% of the patient's teeth are on track with the treatment plan after a period of time of using an orthodontic appliance as disclosed further herein. In some embodiments, the period is 3 days, 4 days, 5 days, 6 days, 7 days, 8 days, 9 days, 10 days, 11 days, 12 days, 13 days, 2 weeks, 3 weeks, 4 weeks, or greater than 4 weeks.

As disclosed further herein, orthodontic appliances disclosed herein have advantageous properties, such as increased durability, and an ability to retain resilient forces to a patient's teeth for a prolonged period. In some embodiments of the method disclosed above, the additively manufactured orthodontic appliance has a retained repositioning force (e.g., the repositioning force after the orthodontic appliance has been applied to or worn by the patient over a period of time), and the retained repositioning force to at least one of the patient's teeth after the period of time is at least 10%, at least 20%, at least 30%, at least 40%, at least 50%, at least 55%, at least 60%, at least 65%, at least 70%, at least 75%, at least 80%, at least 85%, at least 90%, at least 95%, at least 96%, at least 97%, at least 98%, or at least 99% of the repositioning force initially provided to the at least one of the patient's teeth (i.e., with initial application of the orthodontic appliance). In some embodiments, the period is 1 day, 2 days, 3 days, 4 days, 5 days, 6 days, 7 days, 8 days, 9 days, 10 days, 11 days, 12 days, 13 days, 2 weeks, 3 weeks, 4 weeks, or greater than 4 weeks. In some embodiments, the repositioning force applied to at least one of the patient's teeth is present for a time period of less than 24 hours, from about 24 hours to about 2 months, from about 24 hours to about 1 month, from about 24 hours to about 3 weeks, from about 24 hours to about 14 days, from about 24 hours to about 7 days, from about 24 hours to about 3 days, from about 3 days to about 2 months, from about 3 days to about 1 month, from about 3 days to about 3 weeks, from about 3 days to about 14 days, from about 3 days to about 7 days, from about 7 days to about 2 months, from about 7 days to about 1 month, from about 7 days to about 3 weeks, from about 7 days to about 2 weeks, or greater than 2 months. In some embodiments, the repositioning force applied to at least one of the patient's teeth is present for about 24 hours, for about 3 days, for about 7 days, for about 14 days, for about 2 months, or for more than 2 months.

In some embodiments, the orthodontic appliances disclosed herein can provide on-track movement of at least one of the patient's teeth. On-track movement has been described further herein, e.g., at Table 1. In some embodiments, the orthodontic appliances disclosed herein can be used to achieve on-track movement of at least one of the patient's teeth to an intermediate tooth arrangement. In some embodiments, the orthodontic appliances disclosed herein can be used to achieve on-track movement of at least one of the patient's teeth to a final tooth arrangement.

In some embodiments, prior to moving, with the orthodontic appliance, at least one of the patient's teeth toward an intermediate arrangement or a final tooth arrangement, the orthodontic appliance has characteristics which are retained following the use of the orthodontic appliance. In some embodiments, prior to the moving step, the orthodontic appliance comprises a first flexural modulus. In some embodiments, after the moving step, the orthodontic appliance comprises a second flexural modulus. In some embodiments, the second flexural modulus is at least 99%, at least 98%, at least 97%, at least 96%, at least 95%, at least 94%, at least 93%, at least 92%, at least 91%, at least 90%, at least 85%, at least 80%, at least 75%, at least 70%, at least 65%, at least 60%, at least 50%, or at least 40% of the first flexural modulus. In some embodiments, the second flexural modulus is greater than 50% of the first flexural modulus. In some embodiments, this comparison is performed following a period of time in which the appliance is applied. In some embodiments, the period is 3 days, 4 days, 5 days, 6 days, 7 days, 8 days, 9 days, 10 days, 11 days, 12 days, 13 days, 2 weeks, 3 weeks, 4 weeks, or greater than 4 weeks.

In some embodiments, prior to the moving step, the orthodontic appliance comprises a first elongation at break. In some embodiments, after the moving step, the orthodontic appliance comprises a second elongation at break. In some embodiments, the second elongation at break is at least 99%, at least 98%, at least 97%, at least 96%, at least 95%, at least 94%, at least 93%, at least 92%, at least 91%, at least 90%, at least 85%, at least 80%, at least 75%, at least 70%, at least 65%, at least 60%, at least 50%, or at least 40% of the first elongation at break. In some embodiments, the second elongation at break is greater than 50% of the first elongation at break. In some embodiments, this comparison is performed following a period in which the appliance is applied. In some embodiments, the period is 3 days, 4 days, 5 days, 6 days, 7 days, 8 days, 9 days, 10 days, 11 days, 12 days, 13 days, 2 weeks, 3 weeks, 4 weeks, or greater than 4 weeks.

The appliances with the polymerizable compositions disclosed herein provide improved durability, strength, and flexibility, which in turn improve the rate of on-track progression in treatment plans. In some embodiments, greater than 60%, greater than 70%, greater than 80%, greater than 90%, or greater than 95% of patients treated with the orthodontic appliances disclosed herein (e.g., an aligner) are classified as on-track in a given treatment stage. In some embodiments, greater than 60%, greater than 70%, greater than 80%, greater than 90%, or greater than 95% of patients treated with the orthodontic appliances disclosed herein (e.g., an aligner) have greater than 50%, greater than 55%, greater than 60%, greater than 65%, greater than 70%, greater than 75%, greater than 80%, greater than 85%, greater than 90%, or greater than 95% of their tooth movements classified as on-track.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

The various embodiments of the orthodontic appliances presented herein can be fabricated in a wide variety of ways. In some embodiments, the orthodontic appliances herein (or portions thereof) can be produced using direct fabrication, such as additive manufacturing techniques and/or subtractive manufacturing techniques (e.g., milling). Alternatively or in combination, some embodiments of the orthodontic appliances herein (or portions thereof) can be produced using indirect fabrication techniques, such as by thermoforming over a positive or negative mold. Indirect fabrication of an orthodontic appliance can involve producing a positive or negative mold of the patient's dentition in a target arrangement (e.g., by additive or subtractive manufacturing) and thermoforming one or more sheets of material over the mold to generate an appliance shell.

The direct fabrication approaches provided herein are compatible with a wide variety of materials, including but not limited to one or more of the following: a polyester, a co-polyester, a polycarbonate, a thermoplastic polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate, a styrenic block copolymer (SBC), a silicone rubber, an elastomeric alloy, a thermoplastic elastomer (TPE), a thermoplastic vulcanizate (TPV) elastomer, a polyurethane elastomer, a block copolymer elastomer, a polyolefin blend elastomer, a thermoplastic co-polyester elastomer, a thermoplastic polyamide elastomer, a thermoset material, or combinations thereof.

The materials used for direct fabrication can be provided in an uncured form (e.g., as a liquid, resin, powder) and can be cured (e.g., by photopolymerization, light curing, gas curing, laser curing, cross-linking) to form an orthodontic appliance or a portion thereof. The properties of the material before curing may differ from the properties of the material after curing. Once cured, the materials herein can exhibit sufficient strength, stiffness, durability, biocompatibility, etc., for use in an orthodontic appliance. The post-curing properties of the materials used can be selected according to the desired properties for the corresponding portions of the appliance.

In some embodiments, relatively rigid portions of the orthodontic appliance can be formed via direct fabrication using one or more of the following materials: a polyester, a co-polyester, a polycarbonate, a thermoplastic polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, and/or a polytrimethylene terephthalate.

In some embodiments, relatively elastic portions of the orthodontic appliance can be formed via direct fabrication using one or more of the following materials: a styrenic block copolymer (SBC), a silicone rubber, an elastomeric alloy, a thermoplastic elastomer (TPE), a thermoplastic vulcanizate (TPV) elastomer, a polyurethane elastomer, a block copolymer elastomer, a polyolefin blend elastomer, a thermoplastic co-polyester elastomer, and/or a thermoplastic polyamide elastomer.

### IV. Dental Appliances for Protecting Teeth

In some embodiments, the compositions and methods herein may be used for dental appliances that are worn on a subject's teeth to protect the teeth and/or maxillofacial region (e.g., jaws, temporomandibular joints) from injury. For example, the dental appliances herein can be configured to protect the teeth and/or maxillofacial region from injuries due to impacts, such as by absorbing or otherwise dissipating impact forces, thereby reducing the risk of dental and/or skeletal fractures, concussions, and/or soft tissue injuries. As another example, the dental appliances herein can be configured to protect the teeth and/or maxillofacial region from injuries due to bruxism, abrasion, and/or clenching, thereby reducing the risk of tooth wear, dental fractures, gingival recession, and/or temporomandibular joint disorders. The dental appliances described herein can include appliance features, materials, and biomechanical properties that reduce or otherwise mitigate forces on the teeth and/or maxillofacial region. Optionally, the appliance features, materials, and biomechanical properties of the dental appliances herein can also be configured to achieve other functions, such as controlling jaw positioning, improving comfort and/or reducing interference with other activities (e.g., speech, breathing), and/or applying forces to the teeth (e.g., for tooth repositioning or tooth retention). For example, it may be desirable for a sportsguard to protect the teeth while also allowing for effective communication, particularly for team sports where communication may impact game strategy and safety.

In some embodiments, the dental appliances described herein are fabricated partially or entirely via an additive manufacturing process. As discussed further herein, additive manufacturing may be advantageous for fabrication of dental appliances with accurate, customized, and/or highly complex geometries, such as variable thicknesses, controlled offsets from the teeth and/or gingiva, shock absorbing structures, air channels, contoured surfaces for engaging the teeth of the opposite jaw, etc.

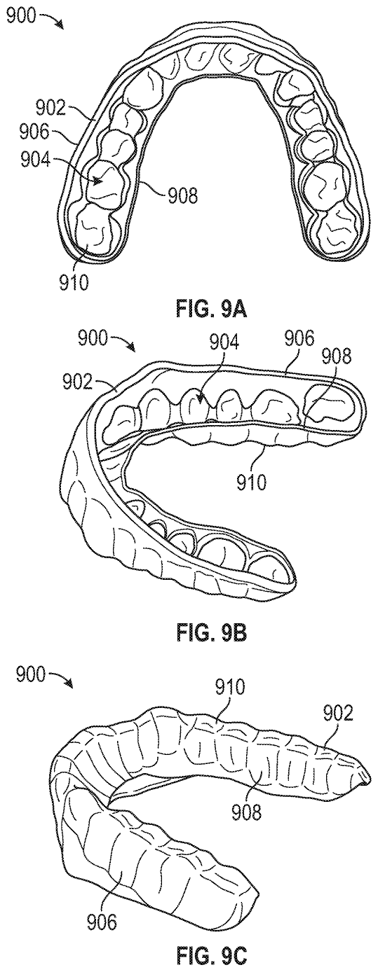

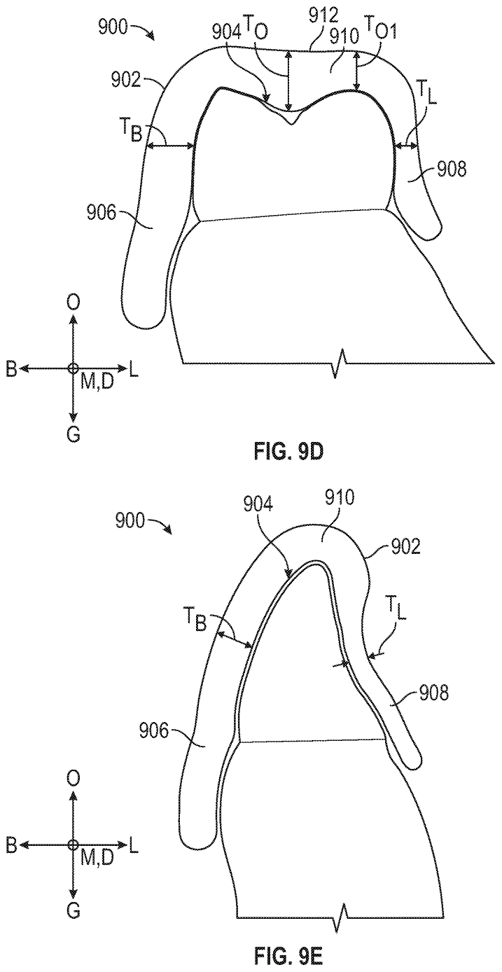

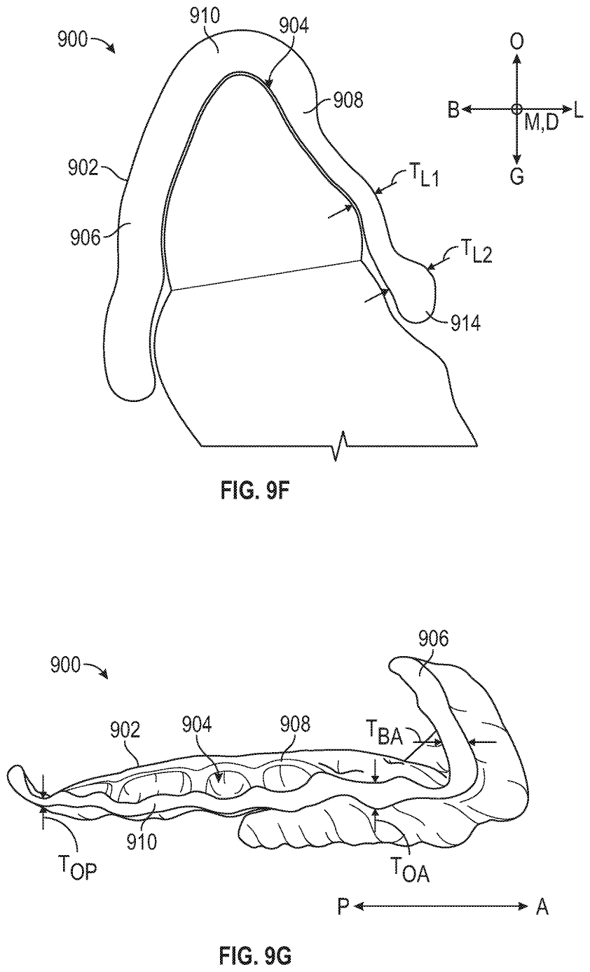

FIGS. 9A-9G illustrate a dental appliance 900 for protecting a subject's teeth, in accordance with embodiments of the present technology. Specifically, FIG. 9A is a top view of the dental appliance 900, FIGS. 9B and 9C are perspective view of the dental appliance 900, and FIGS. 9D-9G illustrate various cross-sectional views of the dental appliance 900. The dental appliance 900 can be a mouthguard that is configured to be worn on the teeth of the subject's jaw (e.g., the upper jaw or the lower jaw) to protect the teeth and/or maxillofacial region from injury. For example, the dental appliance 900 can be a sportsguard that protects the teeth and/or maxillofacial region from forces during physical activities such as contact sports. As another example, the dental appliance 900 can be a nightguard that protects the teeth and/or maxillofacial region from forces due to bruxism during sleep.

Referring first to FIGS. 9A-9C, the dental appliance 900 includes a shell 902 including a plurality of cavities 904 that are configured to receive the subject's teeth. For example, the shell 902 can include a cavity 904 for each tooth received by the dental appliance 900, such that each tooth is positioned within a respective cavity 904 when the dental appliance 900 is worn. In some embodiments, the cavities 904 are configured to apply forces to the received teeth, e.g., if the dental appliance 900 is intended to perform other functions in addition to protecting the teeth, such as repositioning the teeth from a first arrangement to a second arrangement (similar to an aligner or palatal expander) or maintaining the teeth in a current arrangement (similar to a retainer). In other embodiments, the cavities 904 are configured to apply substantially no forces to the received teeth, e.g., if the dental appliance 900 is intended to serve solely as a protective device.

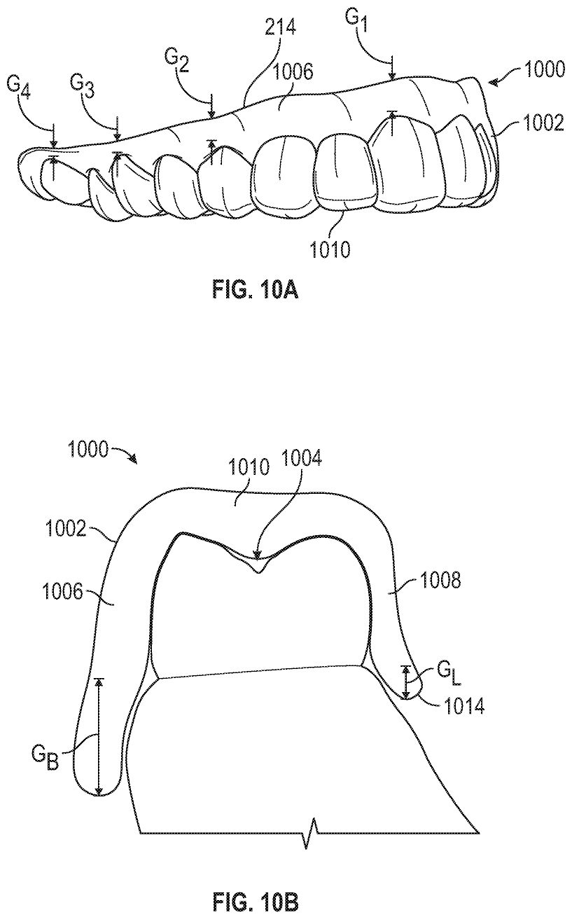

In the illustrated embodiment, the shell 902 includes a buccal wall 906 that is configured to be positioned proximate to the buccal surfaces of the teeth received within the cavities 904, a lingual wall 908 that is configured to be positioned proximate to the lingual surfaces of the teeth received within the cavities 904, and an occlusal wall 910 that is configured to be positioned proximate to the occlusal surfaces of the teeth received within the cavities 904. In some embodiments, the buccal wall 906 and/or lingual wall 908 extend over and cover a portion of the gingiva at the buccal and/or lingual sides of the received teeth, respectively, e.g., as described further below with respect to FIGS. 10A and 10B. Alternatively, the buccal wall 906 and/or lingual wall 908 may terminate at or before the gingival margin of the received teeth, such that the gingiva at the buccal and/or lingual sides of the received teeth, respectively, remain exposed. The gingival edges of the buccal wall 906 and/or lingual wall 908 may be rounded and/or smoothed (e.g., polished) to enhance comfort and reduce the risk of soft tissue injuries, such as abrasions, lacerations, etc., to the oral mucosa. Optionally, the buccal wall 906 can include a notch formed in the gingival edge at or proximate to the midline to accommodate the labial frenulum.

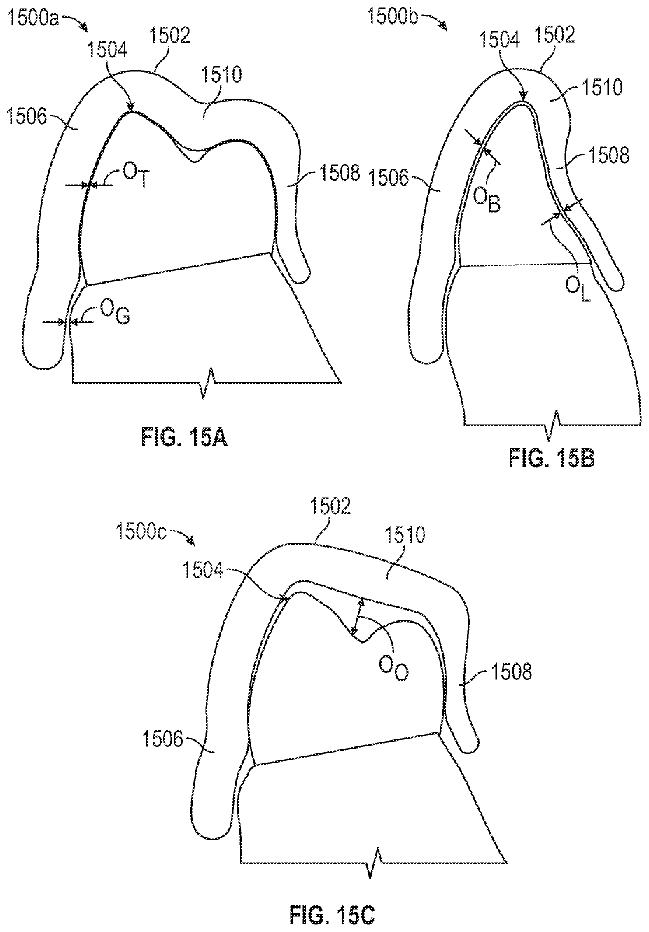

Each of the buccal wall 906, lingual wall 908, and occlusal wall 910 can include an inner surface that faces toward the received teeth and an outer surface that faces away from the received teeth. The buccal wall 906, lingual wall 908, and occlusal wall 910 can collectively define the plurality of cavities 904. Specifically, the geometry of the inner surface of the buccal wall 906 can define the buccal surface profile of the cavities 904, the geometry of the inner surface of the lingual wall 908 can define the lingual surface profile of the cavities 904, and the geometry of the inner surface of the occlusal wall 910 can define the occlusal surface profile of the cavities 904. The inner surface of the buccal wall 906, lingual wall 908, and/or occlusal wall 910 may contact the underlying surfaces of the teeth and gingiva when the shell 902 is worn, or may be spaced apart from the underlying teeth and gingiva by a predetermined offset distance, e.g., as discussed further below with respect to FIGS. 15A-15C.

The shell 902 (including the buccal wall 906, lingual wall 908, and the occlusal wall 910) can be composed partially or entirely out of a material that is configured to protect the teeth from injuries, e.g., due to impact forces, abrasion, clenching, etc. For example, the material can be configured to dissipate forces applied to the teeth, such as by absorbing kinetic energy via controlled deformation, conversion of kinetic energy into heat, redirecting the applied force away from the teeth, and/or distributing the applied force over a greater surface area. In some embodiments, the amount of force that is transmitted to the teeth received by the dental appliance 900 is reduced by a value within a range from 5% to 99%, or from 30% to 90%, compared to the force applied to the dental appliance 900. In some embodiments, the reduction value is at least 10%, 25%, 50%, 60%, 70%, 80%, 85%, or 90%. Additional examples and details of materials that may be used in the dental appliance 900 are provided in Section I above.

In some embodiments, the shell 902 (including the buccal wall 906, lingual wall 908, and the occlusal wall 910) is fabricated partially or entirely via an additive manufacturing process. For example, the additive manufacturing can be a layer-by-layer process in which energy is selectively applied to a layer of a precursor material to cure, polymerize, fuse, sinter, or otherwise solidify the precursor material into a layer of the shell 902. This process can be repeated to build up the geometry of the shell 902, such the shell 902 is composed partially or entirely of a plurality of additively manufactured layers. For example, the precursor material can be a curable material (e.g., a polymerizable resin), and the applied energy can cure the curable material such that the shell 902 is composed of a plurality of layers of cured material, where the cured material is configured to protect the teeth from injuries. Additional examples and details of additive manufacturing processes that may be used to fabricate the dental appliance 900 are provided in Sections I-III above.

The use of additive manufacturing techniques allows for significant flexibility in and control over the geometry of the shell 902. For example, the shell 902 can include a plurality of portions having different thicknesses. These variable thickness portions can be designed to protect the teeth and/or maxillofacial region while also reducing discomfort and/or interference with other activities (e.g., breathing, speech). For instance, the locations of the variable thickness portions may be based on the expected locations and/or magnitudes of applied forces, e.g., portions of the shell 902 that are expected to receive more and/or larger forces may have a greater thickness, while portions of the shell 902 that are expected to receive fewer and/or smaller forces may have a reduced thickness. Alternatively or in addition, the locations of the variable thickness portions may be based on comfort and/or convenience, e.g., portions of the shell 902 proximate to locations that are likely to affect comfort, breathing, and/or speech (e.g., portions proximate to the tongue, palate, and/or trachea) may have a reduced thickness, while portions of the shell 902 proximate to locations that are unlikely to affect comfort, breathing, and/or speech may have a greater thickness. Alternatively or in addition, the locations of the variable thickness portions may be based on other considerations, such as the subject's anatomy, the locations of features to be incorporated into the dental appliance 900 (e.g., bite planes, controlled offset distances), etc.

FIG. 9D is a cross-sectional view of a portion of the dental appliance 900 on a tooth of a subject, and FIG. 9E is a cross-sectional view of a portion of the dental appliance 900 on another tooth of the subject. As shown in FIGS. 9D and 9E, each tooth is received within a respective cavity 904 of the shell 902, where the geometry of the cavity 904 is defined by the geometry of the buccal wall 906, lingual wall 908, and occlusal wall 910 of the shell 902. The buccal wall 906 can have a thickness T_{B}, the lingual wall 908 can have a thickness T_{L}, and the occlusal wall 910 can have a thickness T_{O}. The thickness values T_{B}, T_{L}, and T_{O} may correspond to the distance between the inner and outer surface of the corresponding wall of the shell 902, and may refer to the maximum thickness or average thickness of that wall.

In the illustrated embodiment, the lingual wall 908 is thinner than the buccal wall 906, such that the lingual thickness T_{L} is less than the buccal thickness T_{B}. For example, the lingual thickness T_{L} may be no more than 90%, 80%, 70%, 60%, 50%, 40%, 30%, 20%, or 10% of the buccal thickness T_{B}. Alternatively or in combination, the lingual wall 908 may be thinner than the occlusal wall 910, such that the lingual thickness T_{L} is less than the occlusal thickness T_{O}. For example, the lingual thickness T_{L} may be no more than 90%, 80%, 70%, 60%, 50%, 40%, 30%, 20%, or 10% of the occlusal thickness T_{O}. A thinner lingual wall 908 may be advantageous to improve comfort and/or reduce interference with speech, breathing, etc. A thicker buccal wall 906 may be advantageous to provide enhanced protection against external forces (e.g., impact forces against the maxillofacial region). A thicker occlusal wall 910 may be advantageous to provide enhanced protection against forces that cause the teeth of the patient's jaws to contact each other (e.g., vertically-directed impact forces, forces arising from clenching or bruxism).

In some embodiments, the buccal wall 906 is thinner than the occlusal wall 910, such that the buccal thickness T_{B} is less than the occlusal thickness T_{O}. For example, the buccal thickness T_{B} may be no more than 90%, 80%, 70%, 60%, 50%, 40%, 30%, 20%, or 10% of the occlusal thickness T_{O}. In other embodiments, the occlusal wall 910 is thinner than the buccal wall 906, such that the occlusal thickness T_{O} is less than the buccal thickness T_{B}. For example, the occlusal thickness T_{O} may be no more than 90%, 80%, 70%, 60%, 50%, 40%, 30%, 20%, or 10% of the buccal thickness T_{B}. Optionally, the buccal wall 906 may have substantially the same thickness as the occlusal wall 910, such that the buccal thickness T_{B} is substantially equal to the occlusal thickness T_{O}.

Although FIGS. 9D and 9E illustrate embodiments in which the lingual wall 908 is thinner than the buccal wall 906 and the occlusal wall 910, this is not intended to be limiting, and many different configurations of wall thicknesses for the dental appliance 900 are possible. In other embodiments, for example, the buccal wall 906 may be thinner than the lingual wall 908, such that the buccal thickness T_{B} is less than the lingual thickness T_{L}. For example, the buccal thickness T_{B} may be no more than 90%, 80%, 70%, 60%, 50%, 40%, 30%, 20%, or 10% of the lingual thickness T_{L}. Alternatively, the buccal wall 906 may have substantially the same thickness as the lingual wall 908, such that the buccal thickness T_{B} is substantially equal to the lingual thickness T_{L}. Moreover, in some embodiments, the occlusal wall 910 is thinner than the lingual wall 908, such that the occlusal thickness T_{O} is less than the lingual thickness T_{L}. For example, the occlusal thickness T_{O} may be no more than 90%, 80%, 70%, 60%, 50%, 40%, 30%, 20%, or 10% of the lingual thickness T_{L}. Alternatively, the occlusal wall 910 may have substantially the same thickness as the lingual wall 908, such that the occlusal thickness T_{O} is substantially equal to the lingual thickness T_{L}.

The thickness of a particular portion of the shell 902 (e.g., the buccal wall 906, lingual wall 908, or occlusal wall 910) may be the same throughout that portion, e.g., the entire portion has a uniform thickness. Alternatively, the thickness of a particular portion of the shell 902 (e.g., the buccal wall 906, lingual wall 908, or occlusal wall 910) may be different throughout that portion, e.g., the portion has a variable thickness. In embodiments where the portion has a variable thickness, the thickness may vary along one or more directions, such as an occlusal-gingival direction, an anterior-posterior direction, a buccal-lingual direction, a mesial-distal direction, etc. In some embodiments, the maximum thickness of the portion is 1.05×, 1.1×, 1.2×, 1.5×, 2×, 3×, 4×, or 5× greater than the minimum thickness of the portion.

For example, referring again to FIG. 9D, the occlusal wall 910 of the shell 902 may have a variable thickness. The thickness of the occlusal wall 910 may vary along a buccal-lingual axis BL of the dental appliance 900, a mesial-distal axis MD of the dental appliance 900, or a combination thereof. In the illustrated embodiment, the occlusal wall 910 has a variable thickness along the buccal-lingual axis BL as indicated by the two different occlusal thicknesses T_{O} and T_{O1} depicted in FIG. 9D. Specifically, the variable thickness of the occlusal wall 910 arises from the outer surface of the occlusal wall 910 being flattened (e.g., to provide a substantially flat bite plane 912 for contact with the teeth of the opposing jaw) while the inner surface of the occlusal wall 910 conforms to the contours of the occlusal surface of the received tooth (e.g., the inner surface includes troughs and peaks corresponding to the cusps and valleys of the teeth, respectively). Accordingly, the thickness of the occlusal wall 910 will vary according to the variations in distance between the inner and outer surfaces of the occlusal wall 910, e.g., the occlusal wall 910 has a greater thickness T_{O} at the locations of the valleys in the tooth, and has a reduced thickness TOi at the locations of the cusps in the tooth.

In other embodiments, however, the occlusal wall 910 may be configured differently than the example shown in FIG. 9D. For instance, the thickness of the occlusal wall 910 may be independent of the locations of the valleys and cusps of the received tooth, the thickness of the occlusal wall 910 may increase or decrease monotonically, the occlusal wall 910 may have a uniform thickness along the buccal-lingual axis BL, etc.

FIG. 9F is a cross-sectional view of a portion of the dental appliance 900 on another tooth of the subject. In some embodiments, the lingual wall 908 and/or the buccal wall 906 of the shell 902 may each independently have a variable thickness. For example, the thickness of the lingual wall 908 and/or the buccal wall 906 may vary along a gingival-occlusal axis GO of the dental appliance 900, along a mesial-distal axis MD of the dental appliance 900, or a combination thereof. In the illustrated embodiment, the thickness of the lingual wall 908 varies along a gingival-occlusal axis GO of the dental appliance 900, e.g., as indicated by the two different lingual thicknesses T_{L1} and T_{L2} depicted in FIG. 9F. Specifically, the gingival portion of the lingual wall 908 may be thicker than the occlusal portion of the lingual wall 908, such that the shell 902 has a thickened gingival edge 914 (also known as a “cutline” or “trimline”) on its lingual side. For example, the gingival edge 914 may have a thickness within a range from 1 mm to 2 mm.

In some embodiments, the gingival portion of the occlusal wall 910 is thicker than the occlusal portion of the occlusal wall 910, such that the shell 902 has a thickened gingival edge 914 on its buccal side, in addition or alternatively to having a thickened gingival edge 914 on its lingual side. The presence of the thickened gingival edge(s) 914 may improve durability of the dental appliance 900 and/or reduce the likelihood of breakage, particularly since significant bending forces may be applied to the gingival edge(s) 914 when removing the dental appliance 900 from the teeth and/or placing the dental appliance 900 on the teeth.

In other embodiments, however, the lingual wall 908 and/or the occlusal wall 910 may be configured differently than the example shown in FIG. 9F. For instance, the lingual wall 908 and/or the occlusal wall 910 may have a thinner gingival portion and a thicker occlusal portion, the lingual wall 908 and/or the occlusal wall 910 may have a uniform thickness along the gingival-occlusal axis GO, etc.

FIG. 9G is a cross-sectional view of the dental appliance 900. In some embodiments, the thickness of the buccal wall 906, lingual wall 908, and/or occlusal wall 910 varies along an anterior-posterior axis AP of the dental appliance 900. For example, as shown in FIG. 9G, the occlusal wall 910 can have a thicker anterior portion (e.g., as indicated by thickness T_{OA}) and a thinner posterior portion (e.g., as indicated by thickness T_{OP}). Alternatively or in addition, the buccal wall 906 can have a thicker anterior portion (e.g., as indicated by thickness TBA) and a thinner posterior portion (not shown). Alternatively or in addition, the lingual wall 908 can have a thicker anterior portion and a thinner posterior portion. Thicker anterior portions may be beneficial for increased protection of the anterior teeth, since anterior teeth may be more exposed to external forces (e.g., impact forces) compared to posterior teeth, while thinner posterior portions may be beneficial for improved comfort. In some embodiments, the anterior portion corresponds to the cavities 904 that receive one or more anterior teeth (e.g., central incisors, lateral incisors, and/or canines), and the posterior portion corresponds to the cavities 904 that receive one or more posterior teeth (e.g., premolars, molars).

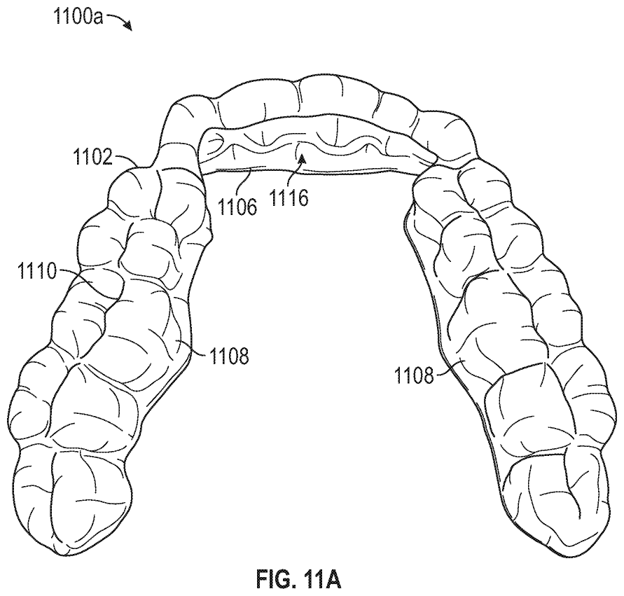

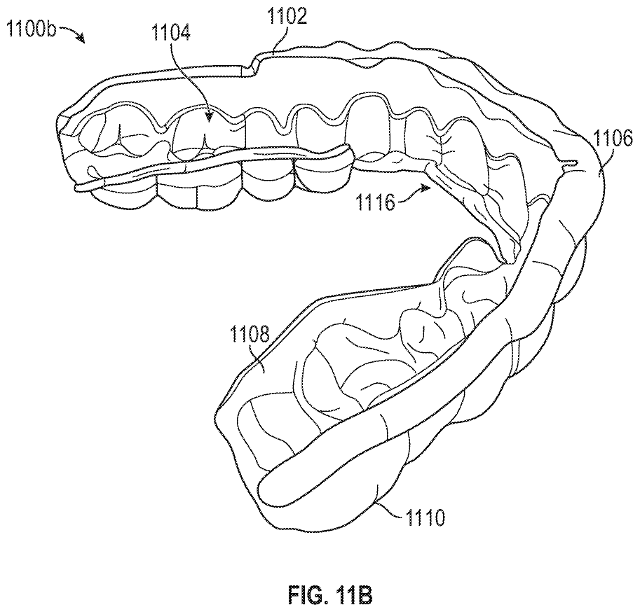

In other embodiments, however, the buccal wall 906, lingual wall 908, and/or occlusal wall 910 may be configured differently than the example shown in FIG. 9G. For example, the buccal wall 906, lingual wall 908, and/or occlusal wall 910 may have thinner anterior portions and thicker posterior portions; the buccal wall 906, lingual wall 908, and/or occlusal wall 910 may have a uniform thickness along the anterior-posterior axis AP; etc. Optionally, one or more of the buccal wall 906, lingual wall 908, and/or occlusal wall 910 may be partially or completely omitted, e.g., as described further below in connection with FIGS. 11A and 111B.

In some embodiments, the buccal wall 906 of the dental appliance 900 has a thickness within a range from 0.5 mm to 10 mm, 1 mm to 10 mm, 1 mm to 8 mm, 1 mm to 5 mm, 1 mm to 3 mm, 1 mm to 2 mm, 2 mm to 10 mm, 2 mm to 8 mm, 2 mm to 5 mm, 2 mm to 3 mm, 3 mm to 10 mm, 3 mm to 8 mm, 3 mm to 5 mm, 5 mm to 10 mm, 5 mm to 8 mm, or 8 mm to 10 mm. The thickness of the buccal wall 906 can be at least 1 mm, 2 mm, 3 mm, 4 mm, 5 mm, 6 mm, 7 mm, 8 mm, 9 mm, or 10 mm.

In some embodiments, the occlusal wall 910 has a thickness within a range from 0.5 mm to 10 mm, 1 mm to 10 mm, 1 mm to 8 mm, 1 mm to 5 mm, 1 mm to 3 mm, 1 mm to 2 mm, 2 mm to 10 mm, 2 mm to 8 mm, 2 mm to 5 mm, 2 mm to 3 mm, 3 mm to 10 mm, 3 mm to 8 mm, 3 mm to 5 mm, 5 mm to 10 mm, 5 mm to 8 mm, or 8 mm to 10 mm. The thickness of the occlusal wall 910 can be at least 1 mm, 2 mm, 3 mm, 4 mm, 5 mm, 6 mm, 7 mm, 8 mm, 9 mm, or 10 mm.

In some embodiments, the lingual wall 908 has a thickness within a range from 0.5 mm to 10 mm, 0.5 mm to 3 mm, 1 mm to 10 mm, 1 mm to 8 mm, 1 mm to 5 mm, 1 mm to 3 mm, 1 mm to 2 mm, 2 mm to 10 mm, 2 mm to 8 mm, 2 mm to 5 mm, 2 mm to 3 mm, 3 mm to 10 mm, 3 mm to 8 mm, 3 mm to 5 mm, 5 mm to 10 mm, 5 mm to 8 mm, or 8 mm to 10 mm. The thickness of the lingual wall 908 can be less than or equal to 10 mm, 9 mm, 8 mm, 7 mm, 6 mm, 5 mm, 4 mm, 3 mm, 2 mm, 1 mm, or 0.5 mm. In some embodiments, the thickness of the lingual wall 108 is no more than 2 mm or 1 mm to provide easier articulation and clearer speech.

In some embodiments, each cavity 904 of the shell 902 has a different respective thickness profile for the buccal wall 906, lingual wall 908, and/or occlusal wall 910 defining that cavity 904. The thickness profile for a cavity 904 may be determined based on any of the following considerations: the anatomy of the received tooth; the location of the received tooth in the jaw (e.g., whether the tooth is an anterior or posterior tooth); whether the cavity 904 is located at a portion of the shell 902 that is expected to be subjected to significant forces (in which case increased thickness may be desirable); whether the cavity 904 is located at a portion of the shell 902 that affects retention of the shell 902 on the teeth (in which case increased thickness may be desirable); whether the cavity 904 is located at a portion of the shell 902 that affects comfort, breathing, speech, etc. (in which case reduced thickness may be desirable); and/or whether the cavity 904 is located at a portion of the shell 902 that is intended to apply forces to teeth (in which case increased thickness may be desirable). The overall thickness distribution across the shell 902 may be varied and/or customized as desired, e.g., for groups of teeth (e.g., per side, per quadrant), for each tooth individually, or for subregions of an individual tooth.

FIGS. 10A-17B illustrate additional features of dental appliances for protecting a subject's teeth, in accordance with embodiments of the present technology. Any of the features of the dental appliances of FIGS. 10A-17B may be incorporated into the dental appliance 900 of FIGS. 9A-9G, and/or may be combined with each other. The dental appliances of FIGS. 10A-17B may be generally similar to the dental appliance 900 of FIGS. 9A-9G, such that like numbers (e.g., shell 902 versus shell 1002) are used to identify similar or identical structures, and the following discussion of the embodiments of FIGS. 10A-17B will focus on those features that differ from the embodiments described in connection with FIGS. 9A-9G.

FIGS. 10A and 10B illustrate a dental appliance 1000 for protecting a subject's teeth with variable gingival coverage, in accordance with embodiments of the present technology. Specifically, FIG. 10A is a side view of the dental appliance 1000 and FIG. 10B is a cross-sectional view of a portion of the dental appliance 1000 on a tooth.

Referring to FIGS. 10A and 10B together, the dental appliance 1000 may be generally similar to the dental appliance 900 of FIGS. 9A-9G. For example, the dental appliance 1000 can be a mouthguard (e.g., sportsguard, nightguard) that is configured to be worn on the teeth of the subject's jaw (e.g., the upper jaw or the lower jaw) to protect the teeth and/or maxillofacial region from injury. The dental appliance 1000 includes a shell 1002 having a plurality of cavities 1004 for receiving the teeth. The shell 102 can include a buccal wall 1006, a lingual wall 1008, and an occlusal wall 1010 that define the cavities 1004. As described further herein, the shell 1002 (including the buccal wall 1006, lingual wall 1008, and the occlusal wall 1010) can be composed partially or entirely out of a material that is configured to protect the teeth from injuries, and/or can be fabricated partially or entirely via an additive manufacturing process.

In the illustrated embodiment, at least a portion of the shell 1002 extends over and covers the gingiva of the subject when the shell 1002 is worn on the teeth, also referred to herein as “gingival coverage.” For example, at least a portion of the buccal wall 1006 and/or the lingual wall 1008 may provide gingival coverage for the gingiva on the buccal and lingual sides of the jaw, respectively. The amount of gingival coverage may correspond to the distance between the gingival margin of the tooth and closest location on the gingival edge 1014 of the shell 1002. In such embodiments, the inner surface of the buccal wall 1006 and/or the lingual wall 1008 can be designed to conform to the shape of the underlying gingiva. The inner surface of the buccal wall 1006 and/or lingual wall 1008 may contact the underlying gingiva when the shell 1002 is worn, or may be spaced apart from the underlying gingiva by a predetermined offset distance, e.g., as discussed further below with respect to FIGS. 15A-15C.

Gingival coverage may be advantageous for protecting the gingiva from injury (e.g., from external forces such as impact forces to the maxillofacial region), for distributing applied forces over a larger surface area to mitigate impacts, and/or for ensuring good retention of the dental appliance on the dental arch. However, excessive gingival coverage may also cause discomfort and/or interfere with activities such as breathing, speech, etc. Accordingly, in some embodiments, the shell 1002 includes a plurality of portions having different amounts of gingival coverage. These portions can be designed to protect the gingiva and/or maintain appliance retention while also reducing discomfort and/or interference with other activities. For example, the gingival coverage may be based on the expected locations and/or magnitudes of applied forces, e.g., portions of the shell 1002 that are expected to receive more and/or larger forces may have a greater amount of gingival coverage, while portions of the shell 1002 that are expected to receive fewer and/or smaller forces may have a reduced amount of gingival coverage or no gingival coverage. Alternatively or in addition, the gingival coverage may be based on comfort and/or convenience, e.g., portions of the shell 1002 proximate to locations that are likely to affect comfort, breathing, and/or speech (e.g., portions proximate to the tongue, palate, and/or trachea) may have a reduced amount of gingival coverage or no gingival coverage, while portions of the shell 1002 proximate to locations that are unlikely to affect comfort, breathing, and/or speech may have a greater amount of gingival coverage. Alternatively or in addition, the gingival coverage may be based on other considerations, such as the subject's anatomy, locations that affect retention of the dental appliance 1000 on the teeth (e.g., greater gingival coverage may improve retention), etc.

Referring now to FIG. 10A, the amount of gingival coverage may vary along an anterior-posterior axis AP of the dental appliance 1000. For example, the anterior portions of the buccal wall 1006 can have a greater amount of gingival coverage and the posterior portions can have a reduced amount of gingival coverage (e.g., no gingival coverage). In the illustrated embodiment, the amount of gingival coverage is the greatest for the portions of the buccal wall 1006 at or proximate to the anterior teeth (e.g., G₁), and gradually decreases along a posterior direction (e.g., G₂, G₃), with the least amount of gingival coverage for the portions of the buccal wall 1006 at or proximate to the posteriormost teeth in the jaw (e.g., G₄). Greater gingival coverage at the anterior portions may be beneficial for increased protection of the anterior teeth, since anterior teeth may be more exposed to external forces (e.g., impact forces) compared to posterior teeth, while reduced gingival coverage at the posterior portions may be beneficial for improved comfort. In some embodiments, the anterior portion corresponds to the cavities 1004 that receive one or more anterior teeth (e.g., central incisors, lateral incisors, and/or canines), and the posterior portion corresponds to the cavities 1004 that receive one or more posterior teeth (e.g., premolars, molars).

Alternatively or in addition, the anterior portions of the lingual wall 1008 can have a greater amount of gingival coverage and the posterior portions can have a reduced amount of gingival coverage. Moreover, in other embodiments, this configuration can be reversed, such that the gingival coverage of the buccal wall 1006 and/or the lingual wall 1008 can instead increase along the posterior direction; or any other suitable variations in gingival coverage along an anterior-posterior direction. For example, the gingival coverage of the buccal wall 1006 near the midline may be reduced (e.g., to no more than 4 mm) to accommodate the labial frenulum.

Referring next to FIG. 10B, in some embodiments, the buccal wall 1006 can have a different amount of gingival coverage than the lingual wall 1008. In the illustrated embodiment, for example, the buccal wall 1006 has a greater amount of gingival coverage and the lingual wall 1008 has a reduced amount of gingival coverage, such that the lingual gingival coverage G_{L} is less than the buccal gingival coverage G_{B}. The gingival coverage values G_{B} and G_{L} may refer to the maximum gingival coverage value or average gingival coverage value of the corresponding wall. For example, the lingual gingival coverage G_{L} may be no more than 90%, 80%, 70%, 60%, 50%, 40%, 30%, 20%, or 10% of the buccal gingival coverage G_{B}. This configuration may be advantageous to provide greater protection for the gingiva at the buccal side since these locations are more likely to be exposed to external forces (e.g., from impacts to the maxillofacial region), while reducing interference with comfort, breathing speech, etc., that might otherwise occur due to coverage of the gingiva at the lingual side.

Although FIG. 10B illustrates embodiments in which the lingual wall 1008 has less gingival coverage than the buccal wall 1006, this is not intended to be limiting, and many different configurations of gingival coverages for the dental appliance 1000 are possible. In other embodiments, for example, the buccal wall 1006 may have less gingival coverage than the lingual wall 1008, such that the buccal gingival coverage G_{B} is less than the lingual gingival coverage G_{L}. For example, the buccal gingival coverage GB may be no more than 90%, 80%, 70%, 60%, 50%, 40%, 30%, 20%, or 10% of the lingual gingival coverage G_{L}. Alternatively, the buccal wall 1006 may have substantially the same gingival coverage as the lingual wall 1008, such that the buccal gingival coverage GB is substantially equal to the lingual gingival coverage G_{L}.

In some embodiments, the buccal wall 1006 of the dental appliance 1000 has a gingival coverage within a range from 0 mm to 10 mm, 0 mm to 8 mm, 0 mm to 5 mm, 0 mm to 3 mm, 0 mm to 2 mm, 0 mm to 1 mm, 1 mm to 10 mm, 1 mm to 8 mm, 1 mm to 5 mm, 1 mm to 3 mm, 1 mm to 2 mm, 2 mm to 10 mm, 2 mm to 8 mm, 2 mm to 5 mm, 2 mm to 3 mm, 3 mm to 10 mm, 3 mm to 8 mm, 3 mm to 5 mm, 5 mm to 10 mm, 5 mm to 8 mm, or 8 mm to 10 mm. The minimum gingival coverage value for the buccal wall 1006 may be greater than or equal to 0 mm, 1 mm, 2 mm, 3 mm, 4 mm, or 5 mm. The maximum gingival coverage value for the buccal wall 1006 may be less than or equal to 10 mm, 9 mm, 8 mm, 7 mm, 6 mm, or 5 mm. In some embodiments, the buccal wall 1006 has a maximum gingival coverage of 4 mm (e.g., at the anterior portion of the shell 1002 proximate to the central incisors), and the gingival coverage gradually decreases along the posterior direction to a minimum gingival coverage of 0 mm (e.g., at the locations of the distalmost molars).

In some embodiments, the lingual wall 1008 of the dental appliance 1000 has a gingival coverage within a range from 0 mm to 10 mm, 0 mm to 8 mm, 0 mm to 5 mm, 0 mm to 3 mm, 0 mm to 2 mm, 0 mm to 1 mm, 1 mm to 10 mm, 1 mm to 8 mm, 1 mm to 5 mm, 1 mm to 3 mm, 1 mm to 2 mm, 2 mm to 10 mm, 2 mm to 8 mm, 2 mm to 5 mm, 2 mm to 3 mm, 3 mm to 10 mm, 3 mm to 8 mm, 3 mm to 5 mm, 5 mm to 10 mm, 5 mm to 8 mm, or 8 mm to 10 mm. The minimum gingival coverage value for the lingual wall 1008 may be greater than or equal to 0 mm, 1 mm, 2 mm, 3 mm, 4 mm, or 5 mm. The maximum gingival coverage value for the lingual wall 1008 may be less than or equal to 10 mm, 9 mm, 8 mm, 7 mm, 6 mm, or 5 mm. In some embodiments, the gingival edge 1014 of the lingual wall 1008 conforms to the underlying gingival margin, such that the lingual wall 1008 has no gingival coverage. In some embodiments, the gingival edge 1014 of the lingual wall 1008 is a substantially straight line, rather than following the contours of the underlying gingival margin.

In some embodiments, each cavity 1004 of the shell 1002 has a different respective gingival coverage profile for the buccal wall 1006 and/or lingual wall 1008 defining that cavity 1004. The gingival coverage profile for a cavity 1004 may be determined based on any of the following considerations: the anatomy of the received tooth; the location of the received tooth in the jaw (e.g., whether the tooth is an anterior or posterior tooth); whether the cavity 1004 is located at a portion of the shell 1002 that is expected to be subjected to significant forces (in which case increased gingival coverage may be desirable); whether the cavity 1004 is located at a portion of the shell 1002 that affects retention of the shell 1002 on the teeth (in which case increased gingival coverage may be desirable); whether the cavity 1004 is located at a portion of the shell 1002 that affects comfort, breathing, speech, etc. (in which case reduced gingival coverage may be desirable); and/or whether the cavity 1004 is located at a portion of the shell 1002 that is intended to apply forces to teeth. The overall gingival coverage distribution across the shell 1002 may be varied and/or customized as desired, e.g., for groups of teeth (e.g., per side, per quadrant), for each tooth individually, or for subregions of an individual tooth.

In some embodiments, at least a portion of the shell 1002 extends over and covers the palate of the subject when the shell 1002 is worn on the teeth, also referred to herein as “palatal coverage.” Palatal coverage may be achieved, for example, by extending the height of the lingual wall 1008 beyond the lingual gingiva so that the lingual wall 1008 also covers at least a portion of or the entire palate. In some embodiments, the lingual wall 1008 covers the entirety of the palate that is located between the left and right sides of the shell 1002. In other embodiments, the lingual wall 1008 covers only a portion of the palate, e.g., the anterior portion only, the posterior portion only, etc. Palatal coverage may be advantage to increase the stiffness of the dental appliance 1000 and/or improve the retention of the dental appliance 1000 on the teeth.

In some embodiments, a portion of the shell of a dental appliance may be omitted. For example, portions of the dental appliance that are not expected to be exposed to significant forces and/or that otherwise do not substantially contribute to protection of the teeth may be omitted (e.g., portions away from the buccal and occlusal surfaces of the teeth). Portions of the dental appliance that, if present, would significantly affect comfort and/or activities such as speech, breathing, etc., may also be omitted (e.g., portions proximate to the tongue, palate, and/or trachea).

FIG. 11A is a bottom view of a dental appliance 1100a for protecting a subject's teeth with reduced lingual coverage, in accordance with embodiments of the present technology. The dental appliance 1100a may be generally similar to other embodiments herein, such as the dental appliance 900 of FIGS. 9A-9G. For example, the dental appliance 1100a can be a mouthguard (e.g., sportsguard, nightguard) that is configured to be worn on the teeth of the subject's jaw (e.g., the upper jaw or the lower jaw) to protect the teeth and/or maxillofacial region from injury. The dental appliance 1100a includes a shell 1102 having a plurality of cavities 1104 (obscured in FIG. 11A) for receiving the teeth. The shell 1102 can include a buccal wall 1106, a lingual wall 1108, and an occlusal wall 1110 that define the cavities 1104. As described further herein, the shell 1102 (including the buccal wall 1106, lingual wall 1108, and the occlusal wall 1110) can be composed partially or entirely out of a material that is configured to protect the teeth from injuries, and/or can be fabricated partially or entirely via an additive manufacturing process.

The dental appliance 1100a includes at least one cutout 1116 where a portion of the buccal wall 1106, lingual wall 1108, and/or occlusal wall 1110 has been removed. In the illustrated embodiment, for example, a cutout 1116 is located at the anterior lingual side of the shell 1102, such that the lingual wall 1108 only includes posterior portions (e.g., portions proximate to the posterior teeth such as the molars and/or premolars) and does not include an anterior portion (e.g., a portion proximate to the anterior teeth such as the canines and/or incisors). Alternatively, the cutout 1116 can be located at the posterior lingual sides of the shell 1102, such that lingual wall 1108 only includes an anterior portion and does not include any posterior portions. Optionally, the cutout 1116 can extend along the entire lingual side of the shell 1102, such that the lingual wall 1108 is omitted altogether. A cutout 1116 that extends partially or entirely along the lingual side of the shell 1102 may be beneficial to improve comfort and/or reduce interference with speech, breathing, etc., without substantially compromising protection since the lingual side is generally less exposed to external forces.

Alternatively or in combination, the dental appliance 1100a can include at least one cutout 1116 at other locations. For example, the dental appliance 1100a can include a cutout that extends partially or entirely along the buccal side of the shell 1102, such that a portion of the buccal wall 1106 is omitted (e.g., the anterior portion only, the posterior portions only), or the entire buccal wall 1106 is omitted. As another example, the dental appliance 1100a can include a cutout that extends partially or entirely along the occlusal surface of the shell 1102, such that a portion of the occlusal wall 1110 is omitted (e.g., the anterior portion only, the posterior portions only), or the entire occlusal wall 1110 is omitted. A cutout 1116 may extend along multiple teeth, a single tooth, or a subregion of a single tooth. The location(s), size(s), and shape(s) of the cutouts 1116 may be determined based on any of the following considerations: the anatomy of the underlying tooth; the location of the underlying tooth in the jaw (e.g., whether the tooth is an anterior or posterior tooth); whether the corresponding portion of the shell 1102 is expected to be subjected to significant forces (in which case a cutout 1116 may not be desirable or a smaller cutout 1116 may be used); whether the corresponding portion of the shell 1102 affects retention of the shell 1102 on the teeth (in which case a cutout 1116 may not be desirable or a smaller cutout 1116 may be used); whether the corresponding portion of the shell 1102 affects comfort, breathing, speech, etc. (in which a cutout 1116 may be desirable); whether the corresponding portion of the shell 1102 is intended to apply forces to teeth (in which case a cutout 1116 may not be desirable or a smaller cutout 1116 may be used); and/or whether the corresponding portion of the shell 1102 lies over a missing or erupting tooth (in which case a cutout 1116 may be desirable).

The occlusal wall of the dental appliances described herein can be configured in many different ways to provide protection for the occlusal surfaces of the teeth (e.g., protection against impacts that force the jaws together; protection against forces arising from bruxism, clenching, etc.). Optionally, the occlusal wall may also perform other functions, such as providing a bite plane for contacting the teeth of the opposing jaw, and/or for stabilizing or adjusting the positioning of the opposing jaw relative to the jaw on which the dental appliance is worn. For example, a neutral alignment of the lower jaw relative to the upper jaw may reduce stress on the temporomandibular joint and/or decrease the risk of jaw dislocation or fracture, while a protrusive alignment of the lower jaw relative to the upper jaw may open the airway for improved breathing (e.g., to improve athletic performance, reduce the incidence of apnea events). In general, the characteristics of the occlusal wall (e.g., thickness, surface geometry) may be optimized or otherwise designed to provide comfort and a well-rested bite position for the subject (e.g., a wedged occlusal design).

FIG. 11B is a perspective view of a dental appliance 1100b for protecting a subject's teeth with thickened buccal walls and reduced lingual coverage, in accordance with embodiments of the present technology. The dental appliance 1100b can be generally similar to the dental appliance 1100a of FIG. 11A, in that the dental appliance 1100b includes a cutout 1116 at the anterior lingual side of the shell 1102. The remaining posterior portions of the lingual wall 1108 can be relatively thin, e.g., less than or equal to 1 mm in thickness. The anterior portion of the buccal wall 1106 of the dental appliance 1100b can be relatively thick, e.g., having a thickness within a range from 4 mm to 5 mm. This configuration can improve protection of the buccal surfaces of the anterior teeth while also maintaining comfort and ease of breathing/speech.

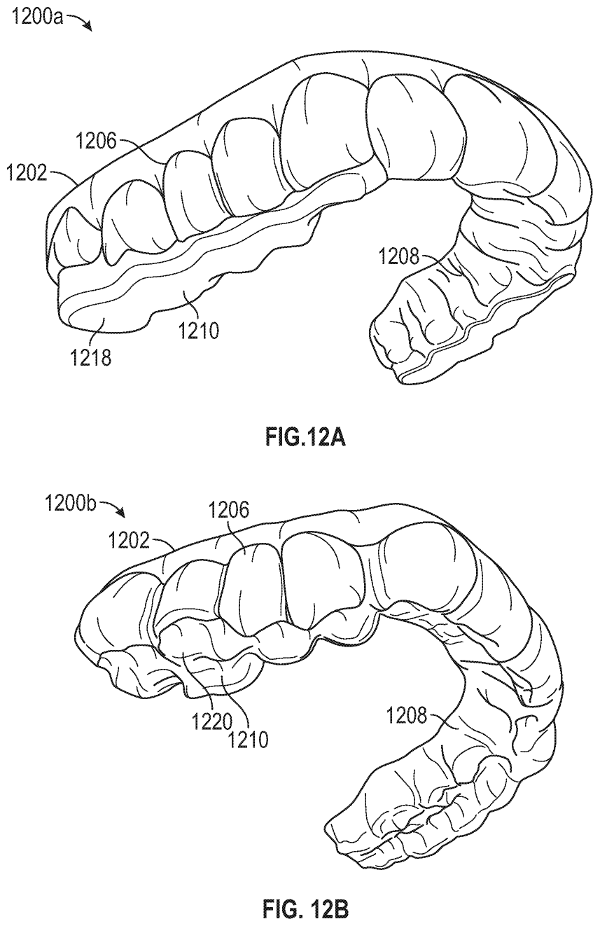

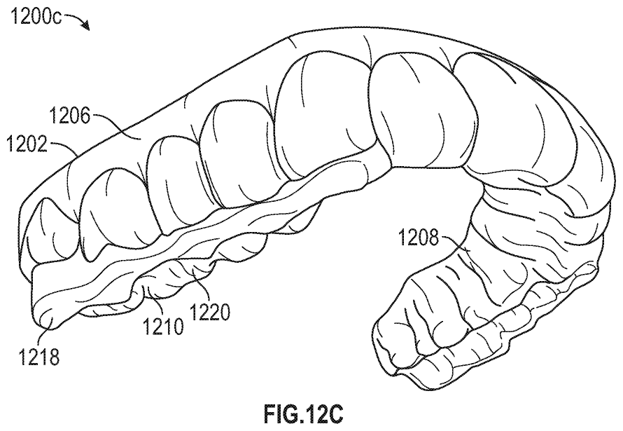

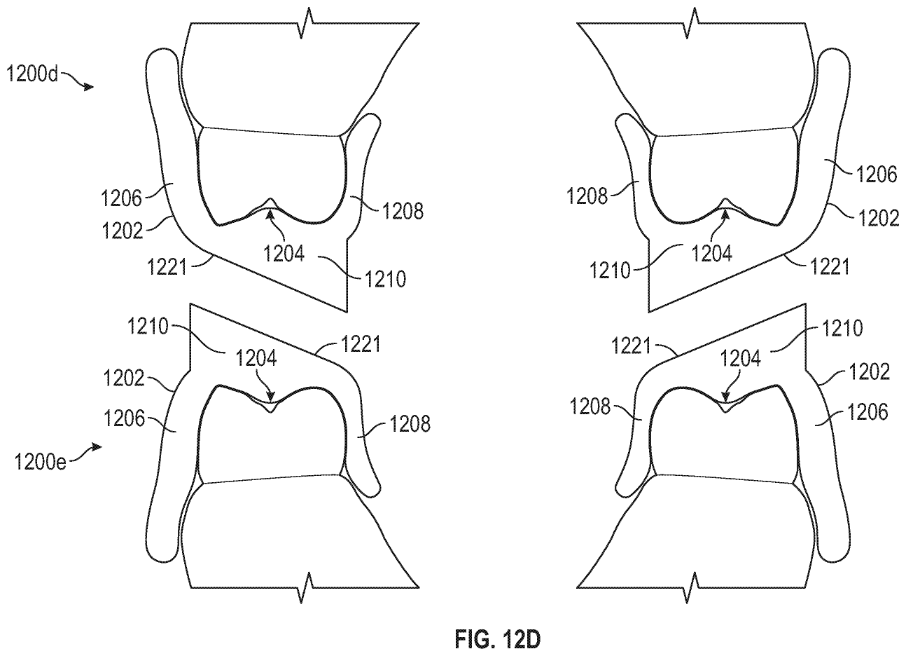

FIGS. 12A-12D illustrate dental appliances 1200a-1200e for protecting a subject's teeth with varying occlusal surface geometries, in accordance with embodiments of the present technology. The dental appliances 1200a-1200e may be generally similar to other embodiments herein, such as the dental appliance 900 of FIGS. 9A-9G. For example, the dental appliances 1200a-1200e can each be a mouthguard (e.g., sportsguard, nightguard) that is configured to be worn on the teeth of the subject's jaw (e.g., the upper jaw or the lower jaw) to protect the teeth and/or maxillofacial region from injury. The dental appliances 1200a-1200e can each include a shell 1202 having a plurality of cavities 1204 (obscured in FIGS. 12A-12C) for receiving the teeth. The shell 1202 can include a buccal wall 1206, a lingual wall 1208, and an occlusal wall 1210 that define the cavities 1204. As described further herein, the shell 1202 (including the buccal wall 1206, lingual wall 1208, and the occlusal wall 1210) can be composed partially or entirely out of a material that is configured to protect the teeth from injuries, and/or can be fabricated partially or entirely via an additive manufacturing process.

Referring first to FIG. 12A, a perspective view of a dental appliance 1200a having a flattened occlusal surface is shown. In the illustrated embodiment, the outer surface of the occlusal wall 1210 includes one or more flattened portions 1218 that extend along the cavities 1204 for the posterior teeth (e.g., the premolars and/or molars). The flattened portions 1218 can lie substantially along the occlusal plane of the subject's teeth to avoid interfering with the natural occlusion of the jaws. The flattened occlusal surface may be advantageous, for example, to provide a substantially flat bite plane for contacting the teeth of the opposing jaw, which may facilitate clenching of the teeth for improved impact protection. The flattened occlusal surface may improve the durability of the dental appliance 1200a by reducing the lateral forces applied to the dental appliance 1200a during clenching.

Referring next to FIG. 12B, a perspective view of a dental appliance 1200b having a contoured occlusal surface is shown. In the illustrated embodiment, the outer surface of the occlusal wall 1210 includes one or more contoured portions 1220 that extend along the cavities 1204 for the posterior teeth (e.g., the premolars and/or molars). The contoured portions 1220 can have a surface geometry that conforms to the occlusal surfaces of one or more teeth of the opposing jaw (e.g., the teeth that will come into contact with the contoured portions 1220) when the dental appliance 1200b is worn. For example, the contoured portions 1220 can have peaks and troughs that are complementary to and mate with the cusps and valleys of the teeth of the opposing jaw, respectively. The presence of the contoured portions 1220 can provide a more even distribution of bite forces across the dental arch, which may reduce the risk of overloading individual teeth (e.g., particularly for severely maloccluded or ectopic teeth) and/or also prevent temporomandibular joint injuries.

In some embodiments, the locations of the contoured portions 1220 correspond to the current (e.g., natural) occlusion of the jaws to stabilize the subject's bite in the current bite position. In other embodiments, the locations of the contoured portions 1220 may differ from the natural occlusion of the jaws to adjust the subject's bite to a different, desired position. For example, the contoured portions 1220 may adjust the lower jaw into a neutral, slightly open position or a slightly protrusive position (e.g., to slightly open the airway for improved breathing). Other types of adjustments can also be made, e.g., to protrude or retract the lower jaw relative to the upper jaw for treatment purposes such as correction of malocclusion, prevention of sleep apnea, etc.

Referring next to FIG. 12C, a perspective view of a dental appliance 1200c having a combination of flattened and contoured occlusal surfaces is shown. In the illustrated embodiment, the outer surface of the occlusal wall 1210 includes one or more flattened portions 1218 that extend along the buccal side of the shell 1202 at the locations of the cavities 1204 for the posterior teeth (e.g., the premolars and/or molars). The remaining portions of the occlusal wall 1210 can be contoured portions 1220 having a surface geometry that conforms to the occlusal surfaces of one or more teeth of the opposing jaw. The combination of the flattened portions 1218 and contoured portions 1220 can provide improved protection against external forces (e.g., impacts against the maxillofacial region) while also maintaining the ability to stabilize and/or adjust the subject's occlusion to a desired bite position.

Referring next to FIG. 12D, a cross-sectional view of a pair of dental appliances 1200d, 1200e with angled occlusal surfaces is shown. In the illustrated embodiment, the dental appliance 1200d is configured to be worn on the teeth of the upper jaw, and the dental appliance 1200e is configured to be worn on the teeth of the lower jaw. The outer surfaces of the occlusal walls 1210 of the dental appliances 1200d, 1200e each include flattened portions 1221 that are angled relative to the occlusal plane of the teeth. The flattened portions 1221 of the dental appliances 1200d, 1200e can be angled in opposite directions. For example, the flattened portions 1221 of the upper dental appliance 1200d can be angled outward (e.g., the lingual sides of the flattened portions 1221 are higher than the buccal sides), and the flattened portions 1221 of the lower dental appliance 1200e can be angled inward (e.g., the buccal sides of the flattened portions 1221 are higher than the lingual sides). Alternatively, the flattened portions 1221 of the upper dental appliance 1200d can be angled inward and the flattened portions 1221 of the lower dental appliance 1200e can be angled outward. The flattened portions 1221 of the dental appliances 1200d, 1200e can come into contact with each other when the subject's jaws are brought together (e.g., when receiving a punch or other head impact, during teeth clenching) and the opposing angles of the flattened portions 1221 can inhibit lateral movements of the jaws to provide enhanced protection.

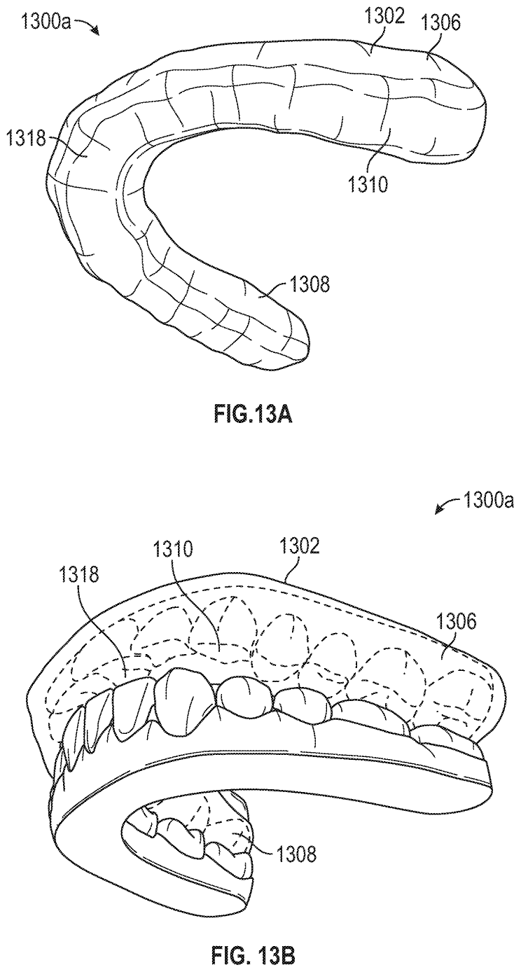

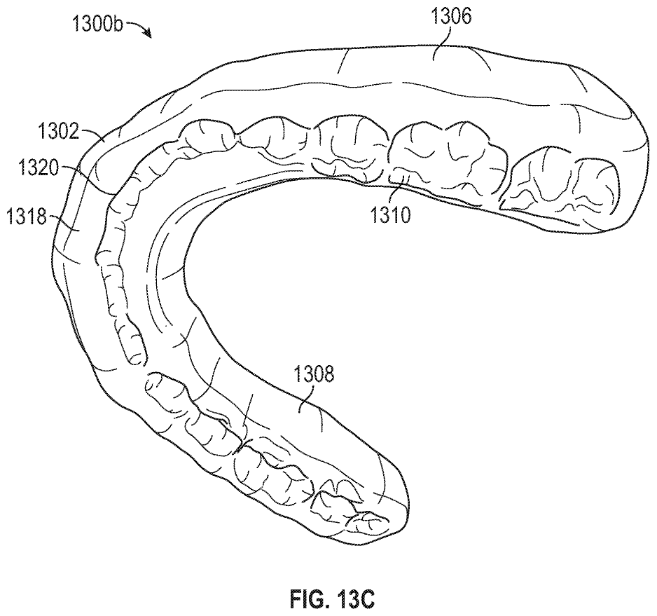

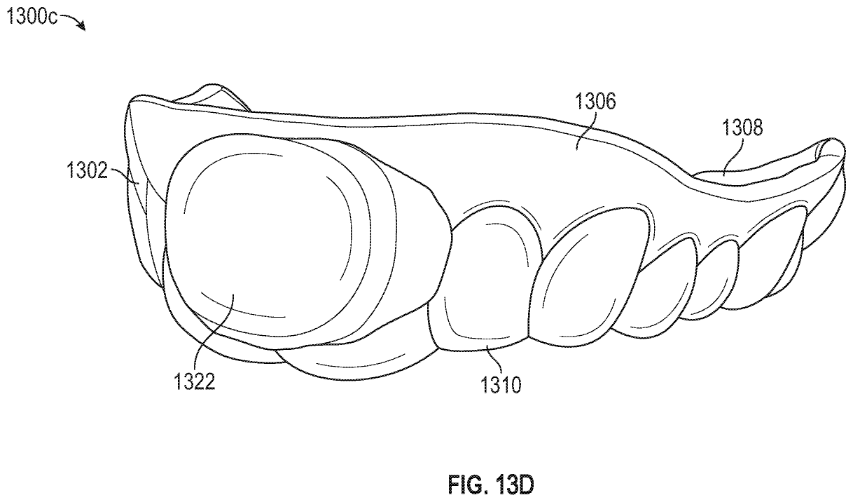

FIGS. 13A and 13B illustrate a dental appliance 1300a for protecting a subject's teeth with a flattened occlusal surface, in accordance with embodiments of the present technology. Specifically, FIG. 13A is a perspective view of the dental appliance 1300a, and FIG. 13B is a perspective view of the dental appliance 1300a together with the subject's upper and lower jaws.

The dental appliance 1300a may be generally similar to other embodiments herein, such as the dental appliance 900 of FIGS. 9A-9G. For example, the dental appliance 1300a can be a mouthguard (e.g., sportsguard, nightguard) that is configured to be worn on the teeth of the subject's jaw (e.g., the upper jaw or the lower jaw) to protect the teeth and/or maxillofacial region from injury. The dental appliance 1300a includes a shell 1302 having a plurality of cavities 1304 (obscured in FIGS. 13A and 13B) for receiving the teeth. The shell 1302 can include a buccal wall 1306, a lingual wall 1308, and an occlusal wall 1310 that define the cavities 1304. As described further herein, the shell 1302 (including the buccal wall 1306, lingual wall 1308, and the occlusal wall 1310) can be composed partially or entirely out of a material that is configured to protect the teeth from injuries, and/or can be fabricated partially or entirely via an additive manufacturing process.

Referring first to FIG. 13A, the dental appliance 1300a can be generally similar to the dental appliance 1200a of FIG. 12A, except that the dental appliance 1300a includes a flattened occlusal surface that extends over the anterior teeth (e.g., incisors and/or canines) as well as the posterior teeth (e.g., premolars and/or molars). In the illustrated embodiment, the outer surface of the occlusal wall 1310 includes a flattened portion 1318 that extends along all of the cavities 1304 of the shell 1302, including the cavities 1304 for the anterior teeth and the posterior teeth. The flattened portion 1318 can lie substantially along the occlusal plane of the subject's teeth to avoid interfering with the natural occlusion of the jaws. As shown in FIG. 13B, the flattened occlusal surface may be advantageous, for example, to provide a substantially flat bite plane for contacting the teeth of the opposing jaw, which may facilitate clenching of the teeth for improved impact protection.

FIG. 13C is a perspective view of a dental appliance 1300b for protecting a subject's teeth with a contoured occlusal surface, in accordance with embodiments of the present technology. The dental appliance 1300b may be generally similar to the dental appliance 1300a of FIGS. 13A and 13B, except that the occlusal wall 1310 includes contoured portions 1320 that extend over the anterior teeth as well as the posterior teeth. The contoured portions 1320 can have surface geometries that conform to the occlusal surfaces of the teeth of the opposing jaw (including both anterior and posterior teeth of the opposing jaw). In the illustrated embodiment, the contoured portions 1320 are a plurality of pockets formed in the occlusal wall 1310, each pocket being configured to receive a respective tooth of the opposing jaw and having peaks/troughs that are complementary to and mate with the cusps/valleys of the tooth. The locations of the pockets may match the current occlusion of the subject's jaws or may be configured to adjust the occlusion of the jaws to a desired bite position, as described elsewhere herein. The remaining portions of the occlusal wall 1310 (e.g., the portions that do not contact the teeth of the opposing jaw) may be flattened portions 1318, e.g., for improved impact protection.

FIG. 13D is a perspective view of a dental appliance 1300c for protecting a subject's teeth with a flattened anterior surface, in accordance with embodiments of the present technology. The dental appliance 1300c may be generally similar to other embodiments herein, such as the dental appliance 900 of FIGS. 9A-9G. For example, the dental appliance 1300c can be a mouthguard (e.g., sportsguard, nightguard) that is configured to be worn on the teeth of the subject's jaw (e.g., the upper jaw or the lower jaw) to protect the teeth and/or maxillofacial region from injury. The dental appliance 1300c includes a shell 1302 having a plurality of cavities 1304 (obscured in FIG. 13C) for receiving the teeth. The shell 1302 can include a buccal wall 1306, a lingual wall 1308, and an occlusal wall 1310 that define the cavities 1304. As described further herein, the shell 1302 (including the buccal wall 1306, lingual wall 1308, and the occlusal wall 1310) can be composed partially or entirely out of a material that is configured to protect the teeth from injuries, and/or can be fabricated partially or entirely via an additive manufacturing process.

In the illustrated embodiment, the dental appliance 1300c includes a flattened anterior surface. Specifically, the buccal wall 1306 can include a flattened portion 1322 that extends over one or more anterior teeth (e.g., incisors and/or canines). The flattened portion 1322 can have any suitable shape, such as circular, elliptical, square, rectangular, etc. The edges of the flattened portion 1322 may be smoothed and/or rounded to improve comfort. The flattened portion 1322 can define a plane that is parallel to the buccal surfaces of the anterior teeth (e.g., to reduce the prominence of the flattened portion 1352) and/or that is parallel to the surface of a build platform for additive manufacturing of the dental appliance 1300c. Moreover, the flattened portion 1322 can include or be coupled to ornamental features, such as logos (e.g. brand logos, sports team logos), graphics (e.g., flags, icons, emojis), text (e.g., the subject's name or initials), patterns, colors, stickers, etc.

The flattened portion 1322 can facilitate additive manufacturing of the dental appliance 1300c in a vertical orientation, e.g., the anterior end of the dental appliance 1300c is connected to the build platform at the flattened portion 1322 while the posterior end of the dental appliance 1300c faces away from the build platform. Moreover, the flattened portion 1322 can include or be coupled to ornamental features, such as logos, graphics, text. Patterns, colors, stickers, etc. Advantages of the vertical orientation may include any of the following: allowing for additive manufacturing of the dental appliance 1300c without support structures connecting the dental appliance 1300c to the build platform, thus obviating the need for trimming and polishing of support structures in post-processing; allowing for a greater number and/or density of dental appliances 1300c to be printed on the same build platform; and/or improving the mechanical properties of the dental appliance 1300c.

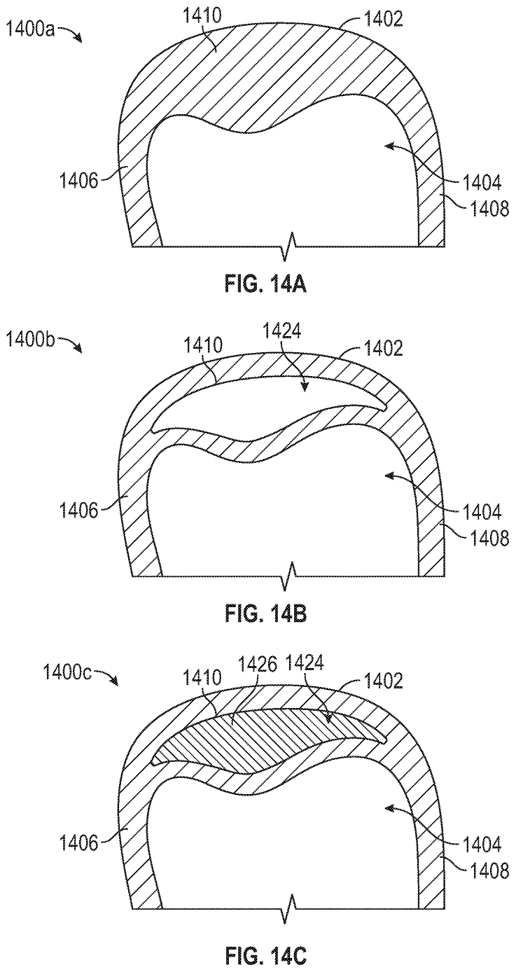

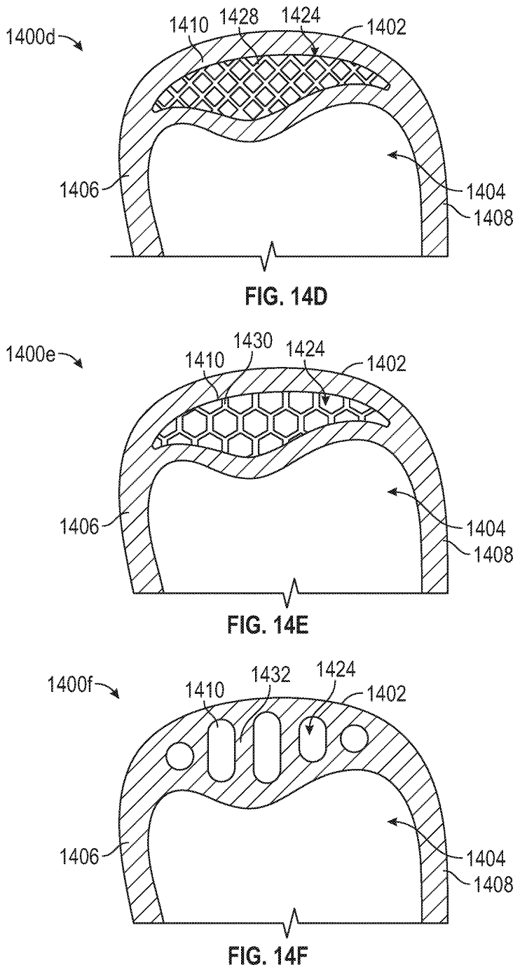

FIGS. 14A-14F are partially schematic cross-sectional views of dental appliances with shock absorbing features, in accordance with embodiments of the present technology. The dental appliances of FIGS. 14A-14F may be generally similar to other embodiments herein, such as the dental appliance 900 of FIGS. 9A-9G. For example, the dental appliances of FIGS. 14A-14F can each be a mouthguard (e.g., sportsguard, nightguard) that is configured to be worn on the teeth of the subject's jaw (e.g., the upper jaw or the lower jaw) to protect the teeth and/or maxillofacial region from injury. The dental appliances of FIGS. 14A-14F can each include a shell 1402 having a plurality of cavities 1404 for receiving the teeth. The shell 1402 can include a buccal wall 1406, a lingual wall 1408, and an occlusal wall 1410 that define the cavities 1404. As described further herein, the shell 1402 (including the buccal wall 1406, lingual wall 1408, and the occlusal wall 1410) can be composed partially or entirely out of a material that is configured to protect the teeth from injuries, and/or can be fabricated partially or entirely via an additive manufacturing process.

Referring first to FIG. 14A, a dental appliance 1400a with a thickened occlusal wall 1410 is shown. As described elsewhere herein, the thickened occlusal wall 1410 can protect the teeth and/or maxillofacial region against injuries due to external forces that bring the jaws together and/or against injuries arising due to bruxism, clenching, etc. The increased thickness of the occlusal wall 1410 and/or the material of the occlusal wall 1410 can be configured to absorb, redirect, or otherwise dissipate forces that might otherwise cause injury to the tooth received in the cavity 1404 and/or to other teeth proximate to the cavity 1404. Thus, the thickened occlusal wall 1410 can serve as a shock absorbing “bite pad” or “bite pillow” of the dental appliance 1400a. In some embodiments, the thickened occlusal wall 1410 is integrally formed with the rest of the shell 1402 as a single unitary component. Alternatively, the thickened occlusal wall 1410 may be a discrete component that is fabricated separately from and subsequently coupled to the shell 1402. The thickened occlusal wall 1410 may be made of the same material as the rest of the shell 1402, or may be made from a different material than the rest of the shell 1402.

Referring next to FIG. 14B, a dental appliance 1400b with a hollow chamber 1424 is shown. The hollow chamber 1424 can be formed at any suitable location in the shell 1402, such as within the occlusal wall 1410 of the shell 1402 as shown. The hollow chamber 1424 can have any suitable geometry, such as spherical, ellipsoidal, ovoid, cylindrical, prismatic, tubular, etc. The hollow chamber 1424 can be completely enclosed by the material of the shell 1402, such that the interior of the hollow chamber 1424 is fluidically isolated from the oral environment. Alternatively, the hollow chamber 1424 may be connected to the outer surface of the shell 1402 via one or more openings, thereby allowing for fluid communication between the interior of the hollow chamber 1424 and the oral environment.

In the illustrated embodiment, the hollow chamber 1424 is filled with air and thus forms an air pocket within the shell 1402. The presence of the air pocket, as well as the surrounding material of the shell 1402, can be configured to absorb, redirect, or otherwise dissipate forces that might otherwise cause injury to the tooth received in the cavity 1404 and/or to other teeth proximate to the cavity 1404. For example, the hollow chamber 1424 can be configured to deform when a force is applied to the shell 1402, and the deformation can enhance dissipation of the force via absorption and/or redirection of the force.

Referring next to FIG. 14C, a dental appliance 1400c with a hollow chamber 1424 including a fluid 1426 is shown. The dental appliance 1400c and hollow chamber 1424 can be generally similar to the corresponding components in FIG. 14B, except that the hollow chamber 1424 is filled partially or entirely with a fluid 1426, such as a liquid, a gas, or even a semi-solid or solid that exhibits a significant amount of deformation and/or flow-like behavior under compression. The properties of the fluid 1426, as well as the surrounding material of the shell 1402, can be configured to absorb, redirect, or otherwise dissipate forces that might otherwise cause injury to the tooth received in the cavity 1404 and/or to other teeth proximate to the cavity 1404. For example, the hollow chamber 1424 can be configured to deform when a force is applied to the shell 1402, and the deformation can enhance dissipation of the force via absorption and/or redirection of the force. The fluid 1426 can also dissipate applied forces via viscous and/or resistive flow.

Referring next to FIG. 14D, a dental appliance 1400d with a hollow chamber 1424 including an internal structure 1428 is shown. The dental appliance 1400d and hollow chamber 1424 can be generally similar to the corresponding components in FIG. 14B, except that the hollow chamber 1424 includes an internal structure 1428 formed therein. The internal structure 1428 can be a cellular structure, such as a mesh, lattice, open cell foam, closed cell foam, etc. In the illustrated embodiment, for example, the internal structure 1428 has a square lattice structure. The cells of the cellular structure may be filled with air as shown, or may be filled with a fluid 1426. The geometry and properties of the internal structure 1428, as well as the material of the shell 1402 surrounding the hollow chamber 1424, can be configured to absorb, redirect, or otherwise dissipate forces that might otherwise cause injury to the tooth received in the cavity 1404 and/or to other teeth proximate to the cavity 1404. For example, the hollow chamber 1424 and internal structure 1428 can be configured to deform when a force is applied to the shell 1402, and the deformation can enhance dissipation of the force via absorption and/or redirection of the force. The internal structure 1428 can also provide support to the hollow chamber 1424, such that the hollow chamber 1424 does not substantially deform until a threshold force is exceeded (e.g., a force greater than forces associated with normal usage, wearing, and/or handling of the dental appliance 1400d). Optionally, in embodiments where a fluid 1426 is also present in the hollow chamber 1424, the presence of the internal structure 1428 can affect the movement of the fluid 1426 within the hollow chamber 1424 and thus the shock absorption effects of the fluid 1426.

Referring next to FIG. 14E, a dental appliance 1400e with a hollow chamber 1424 including an internal structure 1430 is shown. The dental appliance 1400d, hollow chamber 1424, and internal structure 1430 can be generally similar to the corresponding components in FIG. 14D, except that the internal structure 1430 has a hexagonal lattice structure.

Although the internal structures 1428, 1430 in FIGS. 14D and 14E are depicted as being cellular (e.g., lattice) structures, other types of internal structures can also be used, such as struts, pillars, sheets, planes, and/or other structural elements. Any of the internal structures described herein may be made of the same material as the rest of the shell 1402, or may be made from a different material than the rest of the shell 1402.

Referring next to FIG. 14F, a dental appliance 1400f with a plurality of hollow chambers 1424 is shown. The dental appliance 1400f and hollow chambers 1424 can be generally similar to the corresponding components of any of the embodiments of FIGS. 14B-14E, except that the dental appliance 1400f includes multiple hollow chambers 1424. The number, geometry, and location of the hollow chambers 1424 can be configured to absorb, redirect, or otherwise dissipate forces that might otherwise cause injury to the tooth received in the cavity 1404 and/or to other teeth proximate to the cavity 1404. Any of the hollow chambers 1424 may be filled with air or with a fluid 1426. Moreover, any of the hollow chambers 1424 may include an internal structure therein. In some embodiments, some or all of the hollow chambers 1424 are fluidically isolated from each other and/or from the oral environment. In other embodiments, some or all of the hollow chambers 1424 may be connected to each other via internal channels and/or connected to the oral environment via openings formed in the outer surface of shell 1402.

Although FIGS. 14A-14F illustrate shock absorbing features that are located in the occlusal wall of a dental appliance, any of the embodiments of FIGS. 14A-14F may alternatively or additionally be located in any other portion of a dental appliance, such as in the buccal wall and/or the lingual wall. The number, geometry, and/or locations of shock absorbing features may be determined based on any of the following considerations: the anatomy of the underlying tooth; the location of the underlying tooth in the jaw (e.g., whether the tooth is an anterior or posterior tooth); whether the corresponding portion of the shell is expected to be subjected to significant forces (in which case more and/or larger shock absorbing features may be desirable); whether the corresponding portion of the shell affects retention of the shell on the teeth; whether the corresponding portion of the shell affects comfort, breathing, speech, etc. (in which case fewer and/or smaller shock absorbing features may be desirable); and/or whether the corresponding portion of the shell is intended to apply forces to teeth.

In some embodiments, the dental appliances described herein include a variable amount of separation distance between the inner surface of the shell and the surfaces of the underlying teeth and/or gingiva, also referred to herein as an “offset distance.” The offset distance between the dental appliance and the teeth/gingiva can affect the force transfer between the dental appliance and the teeth/gingiva, e.g., a smaller offset distance can result in greater force transfer while a larger offset distance can result in reduced or even no force transfer. The offset distance can also affect comfort when the dental appliance is worn, e.g., a smaller offset distance may be more uncomfortable, particularly for soft tissues that are sensitive to abrasion. The offset distance can also affect retention of the dental appliance on the teeth, e.g., a smaller offset distance may improve retention at that location. Thus, in some embodiments, the offset distances of a dental appliance are varied at different locations in the dental appliance to accommodate these and other considerations.

FIGS. 15A-15C are cross-sectional views of dental appliances with variable offset distances, in accordance with embodiments of the present technology. The dental appliances of FIGS. 15A-15C may be generally similar to other embodiments herein, such as the dental appliance 900 of FIGS. 9A-9G. For example, the dental appliances of FIGS. 15A-15C can each be a mouthguard (e.g., sportsguard, nightguard) that is configured to be worn on the teeth of the subject's jaw (e.g., the upper jaw or the lower jaw) to protect the teeth and/or maxillofacial region from injury. The dental appliances of FIGS. 15A-15C can each include a shell 1502 having a plurality of cavities 1504 for receiving the teeth. The shell 1502 can include a buccal wall 1506, a lingual wall 1508, and an occlusal wall 1510 that define the cavities 1504. As described further herein, the shell 1502 (including the buccal wall 1506, lingual wall 1508, and the occlusal wall 1510) can be composed partially or entirely out of a material that is configured to protect the teeth from injuries, and/or can be fabricated partially or entirely via an additive manufacturing process.

Referring first to FIG. 15A, a dental appliance 1500a having varying tooth and gingival offset distances is shown. A tooth offset distance may refer to the distance between the inner surface of the shell 1502 and the surface of the underlying tooth, while a gingival offset distance may refer to the distance between the inner surface of the shell 1502 and the surface of the underlying gingiva. In the illustrated embodiment, for example, the tooth offset distance O_{T} of the dental appliance 1500a is smaller than the gingival offset distance O_{G}. For instance, the tooth offset distance O_{T} may be no more than 90%, 80%, 70%, 60%, 50%, 40%, 30%, 20%, or 10% of the gingival offset distance O_{G}. This configuration may be advantageous for improving comfort by reducing contact between the gingiva and the shell 1502, while enhancing fit, retention and/or force application of the shell 1502 by maintaining close contact between the teeth and the shell 1502. The varying tooth and gingival offset distances may be present for the buccal wall 1506 only, the lingual wall 1508 only, or for both the buccal wall 1506 and the lingual wall 1508.

In other embodiments, the configuration of offset distances can be reversed, such that the gingival offset distance O_{G} of the dental appliance 1500a is smaller than the tooth offset distance O_{T}. For instance, the gingival offset distance O_{G} may be no more than 90%, 80%, 70%, 60%, 50%, 40%, 30%, 20%, or 10% of the tooth offset distance O_{T}. Alternatively, the gingival offset distance O_{G} may be substantially equal to the tooth offset distance O_{T}. The gingival offset distance O_{G} may be set independently of the tooth offset distance O_{T}.

Referring next to FIG. 15B, a dental appliance 1500b having varying buccal and lingual offset distances is shown. For example, the buccal offset distance O_{B} of the dental appliance 1500b (for the teeth and/or gingiva) may be smaller than the lingual offset distance O_{L}, e.g., the buccal offset distance O_{B} may be no more than 90%, 80%, 70%, 60%, 50%, 40%, 30%, 20%, or 10% of the lingual offset distance O_{L}. Conversely, the lingual offset distance O_{L} of the dental appliance 1500b (for the teeth and/or gingiva) may be smaller than the buccal offset distance OB, e.g., the lingual offset distance O_{L} may be no more than 90%, 80%, 70%, 60%, 50%, 40%, 30%, 20%, or 10% of the buccal offset distance GB. Alternatively, the buccal offset distance O_{B} may be substantially equal to the lingual offset distance O_{L}.

Referring next to FIG. 15C, a dental appliance 1500c having an occlusal offset distance O_{O} is shown. In the illustrated embodiment, the inner surface of the occlusal wall 1510 is flattened, rather than conforming to the cusps/valleys of the occlusal surface of the tooth, thus resulting in a relatively large occlusal offset distance O_{O}. This larger occlusal offset distance O_{O} may be beneficial for reducing the incidence of valleys in the occlusal wall 1510 that might require internal support structures during additive manufacturing; such internal support structures may be more challenging to remove during post-processing compared to other support structures (e.g., support structures connected to the gingival edges of the shell 1502). Moreover, the larger occlusal offset distance O_{O} can result in the formation of an air pocket between the inner surface of the occlusal wall 1510 and the occlusal surface of the tooth when the shell 1502 is worn, and the air pocket may contribute to improved shock absorption.

The ratio of the thickness of the occlusal wall 1510 to the occlusal offset distance O_{O} can be varied as appropriate to produce a desired dampening effect. For example, a relatively thick occlusal wall 1510 and a relatively small occlusal offset distance O_{O} may result in a higher stiffness overall for improved force distribution, whereas a relatively thin occlusal wall 1510 and a relatively large occlusal offset distance O_{O} may result in a reduced stiffness overall for improved cushioning. In some embodiments, the thickness of the occlusal wall 1510 is greater than the occlusal offset distance O_{O}, e.g., by 1×, 1.1×, 1.5×, 2×, 3×, 4×, or 5×. In some embodiments, the occlusal offset distance O_{O} is greater than the thickness of the occlusal wall 1510, e.g., by 1×, 1.1×, 1.5×, 2×, 3×, 4×, or 5×. In some embodiments, the thickness of the occlusal wall 1510 is substantially equal to the occlusal offset distance O_{O}.

In some embodiments, the buccal wall 1506 of the dental appliances described herein has an offset distance (e.g., a tooth offset distance and/or gingiva offset distance) within a range from 0 mm to 1 mm, 0 mm to 0.5 mm, 0.05 mm to 0.2 mm, or 0.05 mm to 0.1 mm. The minimum offset distance for the buccal wall 1506 may be greater than or equal to 0.01 mm, 0.02 mm, 0.05 mm, 0.1 mm, 0.2 mm, or 0.5 mm. The maximum offset distance for the buccal wall 1506 may be less than or equal to 0.5 mm, 0.2 mm, 0.1 mm, 0.05 mm, 0.02 mm, or 0.01 mm.

In some embodiments, the lingual wall 1508 of the dental appliances described herein has an offset distance (e.g., a tooth offset distance and/or gingiva offset distance) within a range from 0 mm to 1 mm, 0 mm to 0.5 mm, 0.05 mm to 0.2 mm, or 0.05 mm to 0.1 mm. The minimum offset distance for the lingual wall 1508 may be greater than or equal to 0.01 mm, 0.02 mm, 0.05 mm, 0.1 mm, 0.2 mm, or 0.5 mm. The maximum offset distance for the lingual wall 1508 may be less than or equal to 0.5 mm, 0.2 mm, 0.1 mm, 0.05 mm, 0.02 mm, or 0.01 mm.

In some embodiments, the occlusal wall 1510 of the dental appliances described herein has an offset distance (e.g., a tooth offset distance and/or gingiva offset distance) within a range from 0 mm to 1 mm, 0 mm to 0.5 mm, 0.05 mm to 0.2 mm, or 0.05 mm to 0.1 mm. The minimum offset distance for the occlusal wall 1510 may be greater than or equal to 0.01 mm, 0.02 mm, 0.05 mm, 0.1 mm, 0.2 mm, or 0.5 mm. The maximum offset distance for the occlusal wall 1510 may be less than or equal to 0.5 mm, 0.2 mm, 0.1 mm, 0.05 mm, 0.02 mm, or 0.01 mm.

In some embodiments, the dental appliances herein include a tooth offset distance within a range from 0 mm to 1 mm, 0 mm to 0.5 mm, 0.05 mm to 0.2 mm, or 0.05 mm to 0.1 mm. The minimum tooth offset distance may be greater than or equal to 0.01 mm, 0.02 mm, 0.05 mm, 0.1 mm, 0.2 mm, or 0.5 mm. The maximum tooth offset distance may be less than or equal to 0.5 mm, 0.2 mm, 0.1 mm, 0.05 mm, 0.02 mm, or 0.01 mm.

In some embodiments, the dental appliances herein include a gingival offset distance within a range from 0 mm to 1 mm, 0 mm to 0.5 mm, 0.05 mm to 0.2 mm, or 0.05 mm to 0.1 mm. The minimum gingival offset distance may be greater than or equal to 0.01 mm, 0.02 mm, 0.05 mm, 0.1 mm, 0.2 mm, or 0.5 mm. The gingival tooth offset distance may be less than or equal to 0.5 mm, 0.2 mm, 0.1 mm, 0.05 mm, 0.02 mm, or 0.01 mm.

In some embodiments, each cavity 1504 of the shell 1502 has a different respective offset distance profile for the buccal wall 1506, lingual wall 1508, and/or occlusal wall 1510 defining that cavity 1504. The offset distance profile for a cavity 1504 may be determined based on any of the following considerations: the anatomy of the received tooth; the location of the received tooth in the jaw (e.g., whether the tooth is an anterior or posterior tooth; a smaller offset distance may be advantageous for posterior teeth to improve appliance retention); whether the cavity 1504 is located at a portion of the shell 1502 that is expected to be subjected to significant forces; whether the cavity 1504 is located at a portion of the shell 1502 that affects retention of the shell 1502 on the teeth (in which case decreased tooth and/or gingival offset distances may be desirable); whether the cavity 1504 is located at a portion of the shell 1502 that affects comfort, breathing, speech, etc. (in which case increased tooth and/or gingival offset distances may be desirable); and/or whether the cavity 1504 is located at a portion of the shell 1502 that is intended to apply forces to teeth (in which case decreased tooth and/or gingival offset distance may be desirable). The overall offset distance distribution across the shell 1502 may be varied and/or customized as desired, e.g., for groups of teeth (e.g., per side, per quadrant), for each tooth individually, or for subregions of an individual tooth.

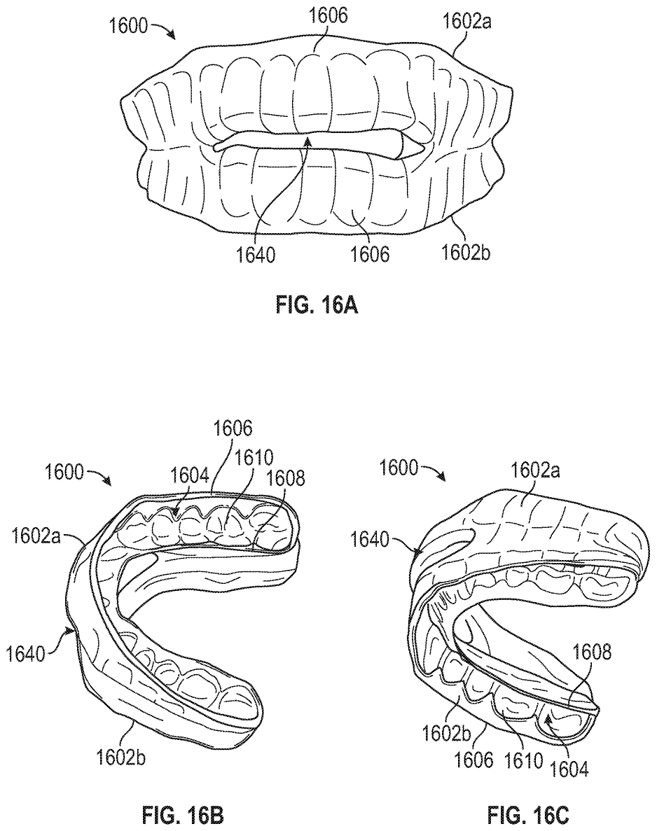

FIGS. 16A-16C illustrate a dental appliance 1600 for protecting teeth of a subject's upper and lower jaws, in accordance with embodiments of the present technology. Specifically, FIG. 16A is a front view of the dental appliance 1600, FIG. 16B is a top perspective view of the dental appliance 1600, and FIG. 16C is a bottom perspective view of the dental appliance 1600.

Referring to FIGS. 16A-16C together, the dental appliance 1600 may be generally similar to the other embodiments described herein, except that the dental appliance 1600 is configured to be worn on both jaws. Specifically, the dental appliance 1600 includes a first shell 1602a configured to be worn on the upper jaw and a second shell 1602b configured to be worn on the lower jaw, where the first shell 1602a and the second shell 1602b are connected to each other to form a single unitary device (e.g., via connections at the posterior portions of the first shell 1602a and second shell 1602b as shown). The relative positioning of the first shell 1602a and the second shell 1602b can be configured to stabilize or adjust the positioning of the upper and lower jaws, e.g., to maintain a current bite position or to reposition the jaws to a desired bite position.

The dental appliance 1600 can be a mouthguard (e.g., sportsguard, nightguard) that is configured to be worn on the teeth of the subject's jaws to protect the teeth and/or maxillofacial region from injury. The first shell 1602a and second shell 1602b can each have a plurality of cavities 1604 for receiving the teeth of the upper jaw and lower jaw, respectively. The first shell 1602a and second shell 1602b can each include a buccal wall 1606, a lingual wall 160 16, and an occlusal wall 1610 that define the cavities 1604. As described further herein, the first shell 1602a and second shell 1602b (including the buccal wall 1606, lingual wall 160 16, and the occlusal wall 1610) can each be composed partially or entirely out of a material that is configured to protect the teeth from injuries, and/or can be fabricated partially or entirely via an additive manufacturing process. The first shell 1602a and the second shell 1602b can each independently include any of the features of the shells previously described in connection with FIGS. 9A-15C.

In some embodiments, the dental appliance 1600 includes one or more air channels 1640 formed therein. For example, as best seen in FIG. 16A, the dental appliance 1600 can include an air channel 1640 at the anterior portion of the dental appliance 1600 between the first shell 1602a and the second shell 1602b. The presence of the air channel 1640 can allow for mouth breathing even while the subject's jaws are closed. Moreover, the location of the air channel 1640 at the anterior portion can improve speech and pronunciation, while not substantially affecting the protective capabilities of the dental appliance 1600. In other embodiments, however, one or more air channels 1640 may alternatively or additionally be located at any other suitable portion of the dental appliance 1600, such as at the posterior portions of the dental appliance 1600, in the first shell 1602a, in the second shell 1602b, etc.

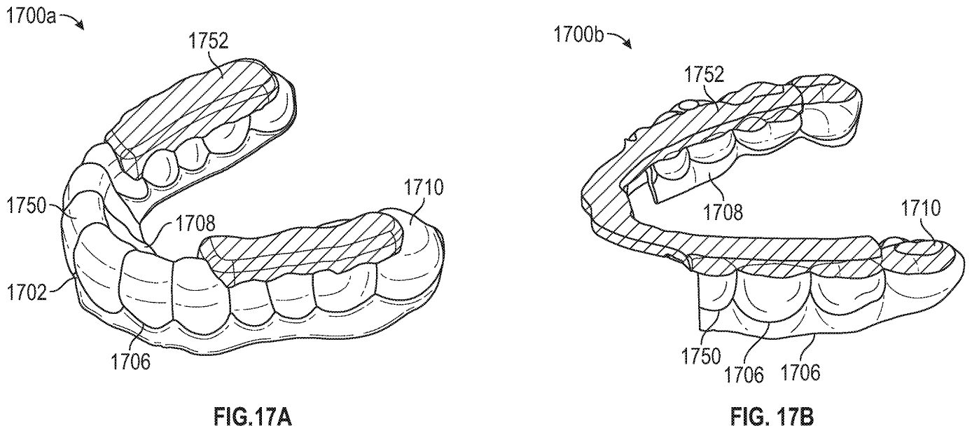

FIGS. 17A and 17B are perspective views of dental appliances 1700a, 1700b composed of multiple materials, in accordance with embodiments of the present technology. The dental appliances 1700a, 1700b may be generally similar to other embodiments herein, such as the dental appliance 900 of FIGS. 9A-9G. For example, the dental appliances 1700a, 1700b can each be a mouthguard (e.g., sportsguard, nightguard) that is configured to be worn on the teeth of the subject's jaw (e.g., the upper jaw or the lower jaw) to protect the teeth and/or maxillofacial region from injury. The dental appliances 1700a, 1700b can each include a shell 1702 having a plurality of cavities 1704 (obscured in FIGS. 17A and 17B) for receiving the teeth. The shell 1702 can include a buccal wall 1706, a lingual wall 1708, and an occlusal wall 1710 that define the cavities 1704. As described further herein, the shell 1702 (including the buccal wall 1706, lingual wall 1708, and the occlusal wall 1710) can be composed partially or entirely out of a material that is configured to protect the teeth from injuries, and/or can be fabricated partially or entirely via an additive manufacturing process.

Referring first to FIG. 17A, the dental appliance 1700a includes a shell 1702 that is composed of a first material 1750 and a second material 1752. The first material 1750 can differ from the second material 1752 with respect to one or more material properties, such as modulus, hardness, strength, elongation, tear resistance, fracture resistance, fatigue resistance, glass transition temperature, decomposition temperature, water absorption, etc. For example, the second material 1752 can be harder and/or stiffer than the first material 1750.

In the illustrated embodiment, for example, the second material 1752 is located at the occlusal wall 1710 of the shell 1702, while the remaining portions of the shell 1702 are composed of the first material 1750. The second material 1752 can be located over a subset of the teeth of the dental arch (e.g., the posterior teeth only as shown, or the anterior teeth only), or may be located over the entire dental arch. The presence of the harder and/or stiffer second material 1752 can increase the durability of the occlusal wall 1710 of the shell 1702 (e.g., to forces due to clenching, bruxism, or impacts forcing the jaws together), as well as improve force distribution across the posterior teeth to reduce the likelihood of injury to any individual tooth.

Referring next to FIG. 17B, the dental appliance 1700b is generally similar to the dental appliance 1700a, except that the anterior portions of the buccal wall 1706 and lingual wall 1708 are omitted, and the second material 1752 extends over the entire dental arch rather than over the posterior teeth only. Similar to the dental appliance 1700a of FIG. 17A, the second material 1752 can be harder and/or stiffer than the first material 1750, thereby increasing the durability of the occlusal wall 1710 of the shell 1702 (e.g., to forces due to clenching, bruxism, or impacts forcing the jaws together), as well as improving force distribution across the posterior teeth to reduce the likelihood of injury to any individual tooth.

Although FIGS. 17A and 17B illustrate a harder and/or stiffer second material 1752 at the occlusal wall 1710 of the shell 1702, in other embodiments, the second material 1752 may alternatively or additionally be located at other portions of the shell 1702, such as the buccal wall 1706, the lingual wall 1708, an anterior portion, a posterior portion, an inner surface, an outer surface, etc. For example, a harder and/or stiffer second material 1752 can be located at the buccal wall 1706 and/or anterior portion of the shell 1702 to provide protection against impacts. As another example, the shell 1702 can include an outer layer composed of a harder and/or stiffer second material 1752, and an inner layer composed of a softer and/or more elastic first material 1750, such that the outer layer provides improved durability, impact protection, and/or force distribution, while the inner layer provides improved comfort, cushioning, and/or force dissipation. Alternatively, the outer layer can be composed of a softer and/or more elastic first material 1750 and the inner layer can be composed of a harder and/or stiffer second material 1752, such that the inner layer provides greater forces for tooth repositioning and/or retention, while the outer layer provides greater cushioning and/or force dissipation.

Any of the dental appliances described herein (e.g., in connection with FIGS. 9A-17B) can optionally be configured to apply forces to the subject's teeth, such as forces for repositioning one or more teeth to from a first arrangement toward a second arrangement, forces for maintaining one or more teeth in a target arrangement, or a combination thereof. This can be advantageous, for example, in situations where an individual wears a mouthguard for a significant amount of time per day (e.g., professional athletes, individuals with night bruxism) and/or for extended time periods (e.g., months) while concurrently undergoing dental treatment. In order to avoid interfering with dental treatment, the mouthguard can be designed to apply sufficient forces to the teeth to effectuate the desired tooth movements and/or prevent tooth relapse. This can be achieved by designing the mouthguard with sufficient thickness, stiffness, and/or contact with the received teeth to apply the desired forces to the teeth. Optionally, the mouthguard can include other features designed to facilitate force application, such as receptacles for receiving and engaging tooth-mounted attachments, increased interproximal penetration to improve appliance retention, dimples to apply forces at targeted locations, etc. Moreover, the additive manufacturing techniques herein allow for fabrication of mouthguards with sufficient accuracy to apply the appropriate forces to the teeth.

In other embodiments, however, the dental appliances described herein (e.g., in connection with FIGS. 9A-17B) may not be intended to apply forces to the teeth, but can instead be used in combination with a second dental appliance that applies forces to the teeth (e.g., an aligner, retainer, or palatal expander). For instance, the second dental appliance can be placed directly on the teeth, and the dental appliance (e.g., mouthguard) can be worn over the second dental appliance to protect the second dental appliance and the underlying teeth. In such embodiments, the geometry of the dental appliance (e.g., the shell and cavities) can be designed to accommodate (e.g., fit over) the second dental appliance. Optionally, a single dental appliance (e.g., mouthguard) can be used with a plurality of second dental appliances, such as a series of dental appliances that are sequentially worn on the teeth to effectuate different treatment stages of a dental treatment plan.

### EXAMPLES

The following examples are given for the purpose of illustrating various embodiments of the disclosure and are not meant to limit the present disclosure in any fashion. The present examples, along with the methods described herein are presently representative of some embodiments, are exemplary, and are not intended as limitations on the scope of the disclosure. Changes therein and other uses which are encompassed within the spirit of the disclosure as defined by the scope of the claims will occur to those skilled in the art.

### Example 1: Preparation of Additively Manufactured Samples from Resin Formulations

Resin formulations according to the present disclosure were prepared by mixing the respective compounds in a beaker with an anchor agitator (IKA) or a DAC 150 FVZ speed mixer (Hauschild Engineering) at a temperature of 25-60 °C. The resins were mixed until they became homogeneous formulations. The resin formulations were further degassed in a Goldbrunn 450 vacuum oven until no air bubbles or (micro-)foam from mixing was detected within the formulation.

Mechanical test specimens and specimens for water uptake testing of the final materials according to the present disclosure were fabricated from the exemplary resin compositions via hot lithography technology on a Caligma DLP printer (Cubicure GmbH) (365 nm). All printer parts in contact with the formulations (material vat, recoating unit, recoating blade, and building platform) were heated to a process temperature of 40-70 °C during the printing process. All objects fabricated on the Caligma DLP printer were printed with a light output intensity of ~0 mW cm⁻², a layer thickness of 100 μm and an irradiation time of ~0.5-2.2 s. The pixel size was set to ~50 μm on the upper surface of the material vat.

After each print job, the samples were mechanically detached from the building platform with a blade and excess resin was removed from the parts with a wipe and/or via solvent cleaning with isopropanol. A UV-post curing step was performed with all 3D-printed specimens in a Uvitron IntelliRay 600 at 100% intensity (~150 mW cm⁻², ~280-550 nm broadband) or in a NK-Optik Otoflash G171 device (~100 mW cm⁻², ~280-700 nm broad band) for 2×5 min and samples were flipped in between exposure cycles to ensure the light curing step was completed.

Resin 1: The formulation components of samples 1-10 were mixed according to Table 2A in the respective weight percentage ratios and homogenized together with the photoinitiator ethyl phenyl(2,4,6-trimethylbenzoyl)phosphinate (TPO-L)(2.0 phr of TPO-L for S1-S5 and 1.5 phr of TPO-L for S6-S10, respectively).

Samples 1-10 (S1-S10) are composed of a light-curable reactive diluent (RD) (component A) in combination with an oligomer (component B) (in Examples 1-3, the term “oligomer” refers to the component B being a precursor of a polymer, and does not impose a limit on the molecular weight of the component B). Table 2A depicts the respective compositions of the exemplary formulations for 1-10.

TABLE 2A
Formulation compositions for samples 1-10 (S1-S10)

| | S1 | S2 | S3 | S4 | S5 | S6 | S7 | S8 | S9 | S10 |
|---|---|---|---|---|---|---|---|---|---|---|
| Components | (wt %) | (wt %) | (wt %) | (wt %) | (wt %) | (wt %) | (wt %) | (wt %) | (wt %) | (wt %) |
| Homomenthyl salicylate | 30 | 50 | | 30 | 30 | 30 | | | 30 | |
| methacrylate | | | | | | | | | | |
| (monofunctional | | | | | | | | | | |
| methacrylate HSMA, | | | | | | | | | | |
| component A as RD) | | | | | | | | | | |
| SR-789 | | | 30 | | | | | | | |
| (monofunctional | | | | | | | | | | |
| methacrylate, | | | | | | | | | | |
| component A as RD) | | | | | | | | | | |
| 2-Hydroxy cyclohexyl | | | | | | | | | | 30 |
| methacrylate | | | | | | | | | | |
| (monofunctional | | | | | | | | | | |
| methacrylate HCMA, | | | | | | | | | | |
| component A as RD) | | | | | | | | | | |
| Syringyl methacrylate | | | | | | | 30 | 15 | | |
| (monofunctional | | | | | | | | | | |
| methacrylate SMA, | | | | | | | | | | |
| component A as RD) | | | | | | | | | | |
| Bomar BR-7432GB | 70 | 50 | 70 | | | | | | | |
| (aliphatic polyester | | | | | | | | | | |
| urethane diacrylate | | | | | | | | | | |
| oligomer, component B) | | | | | | | | | | |
| Bomar BR-744BT | | | | 70 | | | | | | |
| (aliphatic polyester | | | | | | | | | | |
| urethane diacrylate | | | | | | | | | | |
| oligomer, component B) | | | | | | | | | | |
| Bomar BR-374 | | | | | 70 | | | | | |
| (aliphatic polyether | | | | | | | | | | |
| urethane diacrylate | | | | | | | | | | |
| oligomer, component B) | | | | | | | | | | |
| Bomar BR-1044MB | | | | | | 70 | 70 | 85 | | |
| (aliphatic polyether | | | | | | | | | | |
| urethane dimethacrylate | | | | | | | | | | |
| oligomer, component B) | | | | | | | | | | |
| Bomar BR-641TF | | | | | | | | | 70 | |
| (aliphatic polybutadiene | | | | | | | | | | |
| urethane diacrylate | | | | | | | | | | |
| oligomer, component B) | | | | | | | | | | |
| Bomar BR-641S | | | | | | | | | | 70 |
| (aliphatic polybutadiene | | | | | | | | | | |
| urethane diacrylate | | | | | | | | | | |
| oligomer, component B) | | | | | | | | | | |

Resin 2: The formulation components of samples 11-18 and comparative samples CS1-CS2 were mixed according to Table 2B in the respective weight percentage ratios and homogenized together with 1.5 phr of the photoinitiator ethyl phenyl(2,4,6-trimethylbenzoyl)phosphinate (TPO-L).

Samples 11-18 (S11-518) are composed of a light-curable reactive diluent (RD) (component A) in combination with an oligomer (component B), and comparative samples 1-2 (CS1-CS2) are combinations of an oligomer (component B) with multifunctional crosslinkers (as noted above, in Examples 1-3, the term “oligomer” refers to the component B being a precursor of a polymer, and does not impose a limit on the molecular weight of the component B). Table 2B depicts the respective compositions of the exemplary formulations for S11-S18 and CS1-CS2.

TABLE 2B
Formulation compositions for samples 11-18 (S11-S18) and
comparative samples 1-2 (CS1-CS2)

| | S11 | S12 | S13 | S14 | S15 | S16 | S17 | S18 | CS1 | CS2 |
|---|---|---|---|---|---|---|---|---|---|---|
| Components | (wt %) | (wt %) | (wt %) | (wt %) | (wt %) | (wt %) | (wt %) | (wt %) | (wt %) | (wt %) |
| Homomenthyl salicylate | 30 | 50 | 40 | 40 | 40 | | | 30 | | |
| methacrylate | | | | | | | | | | |
| (monofunctional | | | | | | | | | | |
| methacrylate HSMA, | | | | | | | | | | |
| component A as RD) | | | | | | | | | | |
| SR-789 | | | | | | 40 | 20 | | | |
| (monofunctional | | | | | | | | | | |
| methacrylate, | | | | | | | | | | |
| component A as RD) | | | | | | | | | | |
| UV-curable liquid | | | | 60 | 30 | 60 | 60 | 30 | 80 | 60 |
| isoprene rubber UC- | | | | | | | | | | |
| 102M | | | | | | | | | | |
| (multifunctional | | | | | | | | | | |
| methacrylate oligomer, | | | | | | | | | | |
| functionality 2, Mw | | | | | | | | | | |
| ~17,000 g/mol, | | | | | | | | | | |
| component B) | | | | | | | | | | |
| UV-curable liquid | 70 | 50 | 60 | | 30 | | | 30 | | |
| isoprene rubber UC- | | | | | | | | | | |
| 203M | | | | | | | | | | |
| (Multifunctional | | | | | | | | | | |
| methacrylate oligomer, | | | | | | | | | | |
| functionality 3, Mw | | | | | | | | | | |
| ~35,000 g/mol, | | | | | | | | | | |
| component B) | | | | | | | | | | |
| Miramer M2010 | | | | | | | | | 20 | |
| (difunctional acrylate | | | | | | | | | | |
| cross linker) | | | | | | | | | | |
| Miramer M262 | | | | | | | 20 | | | 20 |
| (difunctional acrylate | | | | | | | | | | |
| crosslinker) | | | | | | | | | | |
| SR-834 | | | | | | | | 10 | | |
| (difunctional | | | | | | | | | | |
| methacrylate crosslinker) | | | | | | | | | | |
| Bisphenol A (EO)₁₀ | | | | | | | | | | 20 |
| dimethacrylate, Miramer | | | | | | | | | | |
| M2101 | | | | | | | | | | |
| (difunctional | | | | | | | | | | |
| methacrylate oligomer) | | | | | | | | | | |

Resin 3: The formulation components of samples 19-20 were mixed according to Table 2C in the respective weight percentage ratios and homogenized together with 1.5 phr of the photoinitiator ethyl phenyl(2,4,6-trimethylbenzoyl)phosphinate (TPO-L).

Samples 19-20 (S19-S20) are composed of a light-curable reactive diluent (RD) (component A) in combination with an oligomer (component B) (as noted above, in Examples 1-3, the term “oligomer” refers to the component B being a precursor of a polymer, and does not impose a limit on the molecular weight of the component B). Table 2C depicts the respective compositions of the exemplary formulations for S19-S20.

TABLE 2C
Formulation compositions for samples 19-20 (S19-S20)

| Components | S19 (wt %) | S20 (wt %) |
|---|---|---|
| Syringyl methacrylate (monofunctional | 30 | 15 |
| methacrylate SMA, component A as RD) | | |
| Oligomer 2205-070 (difunctional | 70 | 85 |
| methacrylate oligomer, component B) | | |

S19 and S20 used urethane acrylate/methacrylate-based oligomers derived from a hydrophobic polyester polyol. These oligomers were synthesized in a two-step synthetic approach involving an initial reaction of the polyester polyol with a diisocyanate, subsequently followed by end-capping using mono-functional capping agents. The general synthetic procedure is as follows: Priplast 3196 polyol (67.37 g, 0.023 mol), isophorone diisocyanate (IPDI; 10.00 g, 0.044 mol), and butylated hydroxytoluene (BHT; 0.21 g, 0.25 wt %) were introduced into a 1 L glass reactor equipped with a mechanical stirrer. The reaction mixture was heated to 70 °C. Upon reaching the set temperature, 0.06 wt % of Tib-cat catalyst was added. The mixture was maintained at 70 °C for 2 hours, and the reaction progress was monitored via FTIR spectroscopy. Once the isocyanate peak showed no further decrease, indicating completion of the first reaction step, hydroxyethyl methacrylate (HEMA; 5.86 g, 0.045 mol) was added as a capping agent. The temperature was then raised to 80 °C and maintained until complete disappearance of the isocyanate absorption band in the FTIR spectrum, confirming full conversion. The resulting product was cooled to room temperature, collected, and used without further purification.

### Example 2: Mechanical Testing of Additively Manufactured Samples

A ProLine Z010 TH material tester (Zwick/Roell) was used for tensile tests of the samples. The tensile tests were performed according to ISO 527 using 5 A specimens. The tensile modulus was measured within 0.05-0.25% of elongation at a strain rate of 1 mm min⁻¹ and then the measurement was continued with a strain rate of 500 mm min⁻¹.

A ProLine Z010 TH material tester (Zwick/Roell) was used for tear resistance tests of the samples. The tear resistance tests were performed according to ISO 34. The tear resistance was measured at a strain rate of 500 mm min⁻¹.

Hardness tests were conducted according to ISO 868 using a Shore hardness tester (Zwick/Roell) 1. As deviation from the standard, the samples were prepared via 3D printing. Test samples of 2 mm thickness were used for the measurement.

A Rebound Resilience tester (Bareiss) with a pendulum hammer of 0.5 J was used to examine the rebound of the samples. The pendulum hammer had a drop angle of 90° and hit the samples with an impact speed of 2 m/s. The rebound value was calculated as the percentage of the height of the hammer compared to the initial drop height. Samples with a thickness of 2 mm (for S7, S8, and S20) or 4 mm (for all other samples) were measured.

The water uptake was determined according to ISO 62. Each printed sample was weighed and submerged in water at room temperature for 24 hours. Afterwards, the sample was cleaned and reweighed, and the water uptake was calculated in percentage from the weight gain (3 repetitions).

To determine the stain resistance, a printed sample was submerged in coffee at room temperature for 24 hours. The sample was then removed, cleaned in water, and optically compared to a printed reference of the same material. The tested specimens were categorized as follows:
A—stain resistance as good as comparative sample ethylene-vinyl acetate (EVA), only slight yellow staining observed;
B—stain resistance slightly inferior to comparative sample EVA, samples appear slightly more yellow than comparative example EVA; and
C—stain resistance significantly inferior to comparative sample EVA, samples showed high level of yellowing or even brownish color.

Samples 1-10 prepared according to the procedure in Example 1 above were tested for mechanical properties and the results are summarized in Table 3A.

TABLE 3A
Results for samples 1-10 (S1-S10) compared to reference EVA

| Property | S1 | S2 | S3 | S4 | S5 | S6 | S7 | S8 | S9 | S10 | EVA |
|---|---|---|---|---|---|---|---|---|---|---|---|
| Tensile modulus | 57.4 | 283.0 | 6.5 | 79.8 | 14.4 | 4.4 | 165.0 | 17.1 | 58.3 | 183.0 | — |
| E (MPa) | (±2.4) | (±16.9) | (±2.1) | (±5.1) | (±2.0) | (±1.2) | (±16.8) | (±1.3) | (±3.9) | (±3.9) | |
| Tensile strength | 21.4 | 20.4 | 12.1 | 21.1 | 8.8 | 8.0 | 15.2 | 7.8 | 14.5 | 17.7 | — |
| σ | (±1.0) | (±0.4) | (±2.2) | (±4.7) | (±1.0) | (±1.0) | (±0.6) | (±1.3) | (±2.7) | (±0.9) | |
| (MPa) | | | | | | | | | | | |
| Elongation at | 197.5 | 131.2 | 172.6 | 137.7 | (±10.0) | 179.2 | 200.0 | 155.8 | 160.5 | 115.9 | — |
| break ε (%) | (±4.6) | (±6.1) | (±30.2) | (±16.6) | 162.9 | (±7.7) | (±4.4) | (±14.7) | (±12.5) | (±8.0) | |
| Tear resistance | 93 | 119 | 33 | 68 | 27 | 38 | 56 | 17 | 54 | 71 | — |
| (kN/m) | (±4) | (±26) | (±8) | (±8) | (±2) | (±14) | (±9) | (±2) | (±5) | (±11) | |
| Hardness | 88.4 | 96.8 | 75.6 | 93.5 | 74.3 | 70.4 | 91.2 | 74.1 | 91.8 | 96.6 | 85.0 |
| (Shore A) | (±0.6) | (±0.7) | (±1.1) | (±0.4) | (±1.5) | (±0.1) | (±0.6) | (±1.5) | (±0.2) | (±0.2) | (±0.4) |
| Rebound | — | — | — | — | — | 19.3 | 20.0 | 19.8 | 24.2 | 30.6 | 39.4 |
| (%) | | | | | | (±0.3) | (±0.0) | (±0.2) | (±0.3) | (±0.0) | (±0.1) |
| Water uptake | 1.1 | N/A | N/A | 0.6 | 1.2 | 1.5 | 1.8 | 2.0 | 0.2 | 0.2 | 0.1 |
| (wt %) | (±0.0) | | | (±0.0) | (±0.0) | (±0.1) | (±0.1) | (±0.2) | (±0.1) | (±0.0) | (±0.0) |
| Stain resistance | C | C | C | B | C | C | C | C | A | A | A |
| (A-C) | | | | | | | | | | | |

N/A = Not available

Samples 1-10 were investigated in comparison to EVA, a commercial state-of-the-art mouthguard material. For the conducted studies, EVA samples with a diameter of 125 mm and a thickness of 4 mm were purchased from Great Lakes Orthodontics, LTD. Particularly relevant properties for mouthguard performance are high tear resistance or tear strength (such as >20 kN/m), suitable hardness (such as a value between 55 to 95 Shore A), low rebound (such as <300%), low water uptake (such as <0.5 wt %), and high stain resistance (compared to EVA reference).

Overall, the resin formulations in Table 3A, when 3D printed, led to materials that may be suitable for mouthguard applications. In these samples, the final properties met the above specifications and can be compared to the commercial reference EVA. It can be concluded from the samples in Table 3A that resin formulations can be adjusted via their ratio of reactive diluent (components A) to UV-curable oligomer (components B) to obtain the most suitable properties for the final mouthguard application (see S1-S10). By increasing the content of the high T_{g} reactive diluent, components A respectively, (compare Si and S2 or S7 and S8) properties such as modulus, strength, tear resistance and hardness were significantly increased. When looking at S2, increasing the reactive diluent content to 50 wt % and above can lead to materials that are harder than 95 Shore A, and thus do not meet the above specification for mouthguards. Looking at S8, a lower reactive diluent content (15 wt % and smaller) caused the tear resistance to drop under 20 kN/m.

These results suggest that an oligomer to reactive diluent ratio in the range of 15-50 wt % of reactive diluent and 50-85 wt % of oligomer may be advantageous for certain applications, such as mouthguards. When looking at the nature of the employed apolar oligomers, components B respectively, polyester- and polyether-based aliphatic urethane (meth)acrylates showed good properties (see S1-S8), yet had slight drawbacks when it came to water uptake (higher than 0.5 wt %) and stain resistance, which was observed to be significantly inferior to comparative sample EVA. A higher ratio of apolar units could mitigate this behavior, yet ester and urethane moieties are prone to water uptake and staining.

Certain samples (see S9 and S10) comprising an aliphatic polybutadiene urethane diacrylate oligomer as component B showed significantly improved stain resistance, comparable water uptake to reference EVA, and good overall properties for mouthguard applications. Thus, a higher apolar content within the oligomer may be beneficial.

Samples S11-S18 prepared according to the procedure in Example 1 were tested for mechanical properties and the results are summarized in Table 3B.

TABLE 3B
Results for samples 11-18 (S11-S18) and comparative samples 1-2
(CS1-2) compared to reference EVA

| Property | S11 | S12 | S13 | S14 | S15 | S16 | S17 | S18 | CS1 | CS2 | EVA |
|---|---|---|---|---|---|---|---|---|---|---|---|
| Tensile modulus | 15.8 | 184.0 | 68.3 | 53.5 | 54.8 | 1.9 | 114.0 | 140.0 | 11.3 | 15.2 | — |
| E (MPa) | (±3.6) | (±5.2) | (±7.9) | (±2.5) | (±3.1) | (±1.1) | (±4.4) | (±12.2) | (±1.3) | (±1.6) | |
| Tensile strength | 5.1 | 7.5 | 7.3 | 5.1 | 4.7 | 1.8 | 12.2 | 10.3 | 3.0 | 6.5 | — |
| σ | (±0.2) | (±0.7) | (±1.0) | (±0.3) | (±1.6) | (±0.2) | (±0.7) | (±0.3) | (±0.4) | (±2.0) | |
| (MPa) | | | | | | | | | | | |
| Elongation at | 210.9 | 119.8 | 212.4 | 159.1 | (±76.0) | 74.8 | 30.1 | 55.4 | 22.8 | 25.8 | — |
| break ε (%) | (±2.3) | (±32.5) | (±25.1) | (±15.9) | 113.2 | (±7.0) | (±2.7) | (±3.3) | (±2.8) | (±6.0) | |
| Tear resistance | 20 | 59 | 38 | 29 | 33 | 8 | 29 | 33 | — | 8 | — |
| (kN/m) | (±3) | (±14) | (±4) | (±4) | (±6) | (±2) | (±5) | (±6) | | (±1) | |
| Hardness | 62.8 | 88.7 | 82.6 | 82.1 | 82.1 | 50.1 | 95.5 | 94.4 | 78.1 | 86.4 | 85.0 |
| (Shore A) | (±0.8) | (±1.0) | (±0.8) | (±0.4) | (±0.5) | (±0.6) | (±0.2) | (±0.5) | (±0.4) | (±0.1) | (±0.4) |
| Rebound | 22.0 | 20.6 | 21.7 | 20.0 | 19.9 | 11.0 | 26.2 | 29.3 | 35.1 | 29.8 | 39.4 |
| (%) | (±0.1) | (±0.1) | (±0.6) | (±0.5) | (±0.2) | (±0.2) | (±0.8) | (±0.2) | (±0.2) | (±0.5) | (±0.1) |
| Water uptake | 0.1 | 0.1 | 0.4 | 0.4 | 0.3 | 0.1 | 0.1 | 0.1 | 0.1 | 0.4 | 0.1 |
| (wt %) | (±0.1) | (±0.1) | (±0.1) | (±0.1) | (±0.1) | (±0.1) | (±0.1) | (±0.1) | (±0.1) | (±0.1) | (±0.0) |
| Stain resistance | A | A | A | A | A | A | A | A | A | A | A |
| (A-C) | | | | | | | | | | | |

Samples 11-18 were investigated in comparison to EVA, a commercial state-of-the-art mouthguard material and to comparative samples (CS1 and CS2) comprising multifunctional crosslinkers instead of monofunctional reactive diluents. For the conducted studies, EVA samples with a diameter of 125 mm and a thickness of 4 mm were purchased from Great Lakes Orthodontics, LTD. Particularly relevant properties for mouthguard performance are high tear resistance or tear strength (such as >20 kn), suitable hardness (such as a value between 55 to 95 Shore A), low rebound (such as <300%), low water uptake (such as <0.5 wt %), and high stain resistance (preferably compared to EVA reference).

Overall, the resin formulations in Table 3B3, when 3D printed, led to materials that may be suitable for mouthguard applications. In these samples, the final properties met the above specifications and can be compared to the commercial reference EVA. It can be concluded from the samples in Table 3B that resin formulations can be adjusted via their ratio of reactive diluent (components A) to UV-curable oligomer (components B) to obtain the most suitable properties for the final mouthguard application (see S11-S18). By increasing the content of the high T_{g} reactive diluent, components A respectively, (compare S11, S12, and S13) properties such as modulus, strength, tear resistance and hardness were significantly increased. When looking at S13-S15, increasing the molecular weight and functionality of the employed oligomer led to materials of higher strength, modulus, elongation at break and tear resistance, yet other important characteristics such as rebound, water uptake and stain resistance were not significantly impacted. Using a lower T_{g} reactive diluent (SR-789 in S16) compared to a higher T_{g} diluent (HSMA in S13) could lead to a significant drop in strength, modulus and tear resistance. When implementing difunctional cross linkers (see S17 and S18), hardness and rebound were impacted and resulted in less desirable values. This is further substantiated by comparative samples CS1 and CS2, which entirely replaced the monofunctional reactive diluents with crosslinkers and resulted in inferior rebound behavior and low tear resistance.

These results suggest that an oligomer to reactive diluent ratio in the range of 20-50 wt % of reactive diluent and 50-80 wt % of oligomer may be advantageous for certain applications, such as mouthguards. When looking at the nature of the employed apolar oligomers, components B respectively, one can see that the employed UV-curable isoprene-based oligomers showed exceptional properties (see S11-S18) and the formed materials S11-S18 represented an excellent alternative to state-of-the-art EVA as a potential mouthguard material. The high stain resistance and low water uptake (<0.5 wt %) of the presented materials exhibited superior characteristics over state-of-the-art UV-curable resins currently employed in SLA or DLP technology.

Samples 19-20 were prepared according to the procedure in Example 1 and tested for mechanical properties. The results are summarized in Table 3C.

TABLE 3C
Results for samples 19-20 (S19-S20) compared to reference EVA

| Property | S19 | S20 | EVA |
|---|---|---|---|
| Tensile modulus E (MPa) | 227 | 51.1 | — |
| | (±4.5) | (±1.2) | |
| Tensile strength σ (MPa) | 21.5 | 9.2 | — |
| | (±1.7) | (±0.6) | |
| Elongation at break ε (%) | 128 | 88.7 | — |
| | (±13.3) | (±9.9) | |
| Tear resistance (kN/m) | 92 | 38 | — |
| | (±15) | (±16) | |
| Hardness (Shore A) | 97.5 | 84.3 | 85.0 |
| | (±0.5) | (±3.4) | (±0.4) |
| Rebound (%) | 29.4 | 22.2 | 39.4 |
| | (±0.1) | (±0.2) | (±0.1) |
| Water uptake (wt %) | — | 0.2 | 0.1 |
| | | (±0.0) | (±0.0) |
| Stain resistance (A-C) | B | A | A |

Samples 19-20 were investigated in comparison to EVA, a commercial state-of-the-art mouthguard material. For the conducted studies, EVA samples with a diameter of 125 mm and a thickness of 4 mm were purchased from Great Lakes Orthodontics, LTD. Particularly relevant properties for mouthguard performance are high tear resistance or tear strength (such as >20 kN/m), suitable hardness (such as a value between 55 to 95 Shore A), low rebound (preferably <30%), low water uptake (such as <0.5 wt %), and high stain resistance (compared to EVA reference).

Overall, the resin formulations in Table 3C, when 3D printed, led to materials that may be suitable for mouthguard applications. In these samples, the final properties met the preferred specifications and can be compared to the commercial reference EVA. It can be concluded from the samples in Table 3C, that resin formulations can be adjusted via their ratio of reactive diluent (components A) to UV-curable oligomer (components B) to obtain the most suitable properties for the final mouthguard application (see S19-520). By increasing the content of the high T_{g} reactive diluent, components A (SMA) respectively, (compare S19 and S20) properties such as modulus, strength, tear resistance, and hardness were significantly increased. With lower amounts of reactive diluent SMA (S20), the content of the hydrophobic difunctional crosslinker increased, thus hardness and rebound were favorably impacted (lower values), yet tear resistance and elongation at break were sacrificed.

These results suggest that an oligomer to reactive diluent ratio in the range of 20-50 wt % of reactive diluent and 50-80 wt % of oligomer may be advantageous for certain applications, such as mouthguards. When looking at the nature of the employed apolar oligomers, components B respectively, these oligomers showed exceptional properties (see S19-S20) and the formed materials represented an excellent alternative to state-of-the-art EVA as a potential mouthguard material. The high stain resistance and low water uptake (<0.5 wt %) of the presented materials exhibited superior characteristics over state-of-the-art UV-curable resins currently employed in SLA or DLP technology.

### Example 3: Comparison of Ethylene-Vinyl Acetate (EVA) Material Versus Additively Manufactured Material

This example describes a comparison of a conventional mouthguard material, EVA, with an additively manufactured (AM) material suitable for additive manufacturing of dental appliances.

The AM material was prepared from a resin formulation including a UV-curable oligomer, a reactive diluent, and a photoinitiator as described with respect to S1-S20 in Examples 1 and 2 above. AM material samples were fabricated from the resin formulation on a Caligma DLP printer (Cubicure GmbH). All samples were printed with a light wavelength of 365 nm and the pixel size was set to ~50 μm. After printing, the samples were mechanically detached from the build platform with a blade and excess resin was removed with a wipe and/or via solvent cleaning with isopropanol. A UV-post curing step was performed in a Uvitron IntelliRay 600 at 100% intensity (~150 mW/cm², ~280-550 nm broadband) for 2×5 min. Samples were flipped in between exposure cycles to ensure complete curing.

Rebound testing was performed using a Rebound Resilience tester (Bareiss) with a pendulum hammer of 0.5 J. The pendulum hammer had a drop angle of 90° and struck the samples with an impact speed of 2 m/s. The rebound value was calculated as the percentage of the height of the hammer compared to the initial drop height. Samples with an overall thickness of 2 mm or 4 mm were measured.

The AM material exhibited superior shock absorption compared to the EVA material, as evidenced by lower rebound values indicating greater energy absorption. For rebound testing performed at a low impact energy (0.5 J) with an impactor with an edge-hemisphere having a 15 mm diameter, the EVA materials exhibited rebound values of greater than 30%, while the AM materials exhibited rebound values of 10%-3^{0%}.

Additional impact testing was performed with a drop tester using an impactor with a diameter of −10 mm and a mass of ~3.4 kg. By adjusting the drop height, the respective impact velocities and impact energies were set for each impact test. Tests were conducted at impact velocities of 1.0 m/s, 1.6 m/s, and 2.2 m/s, resulting in impact energies of 1.74 J, 4.5 J, and 8.4 J, respectively.

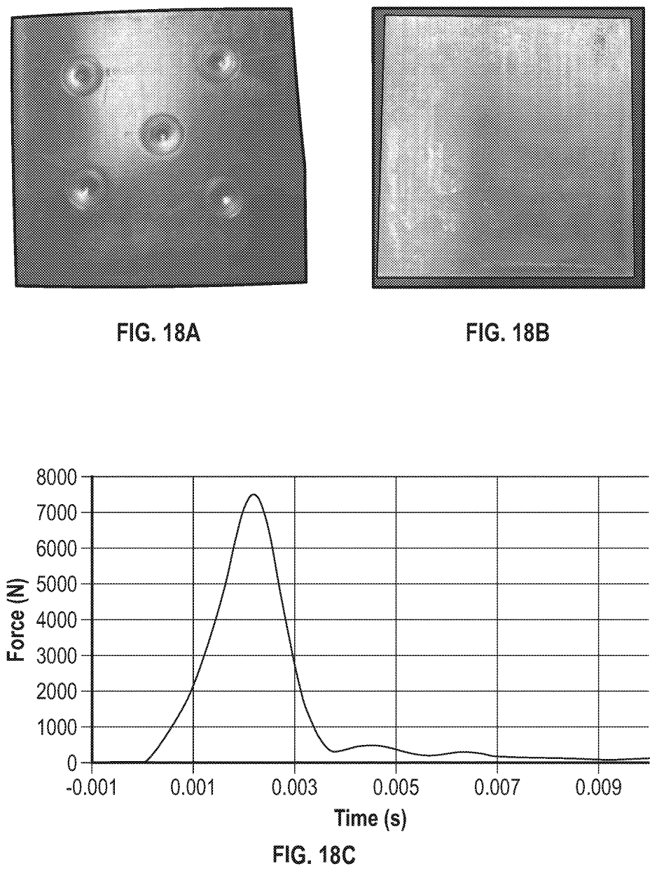

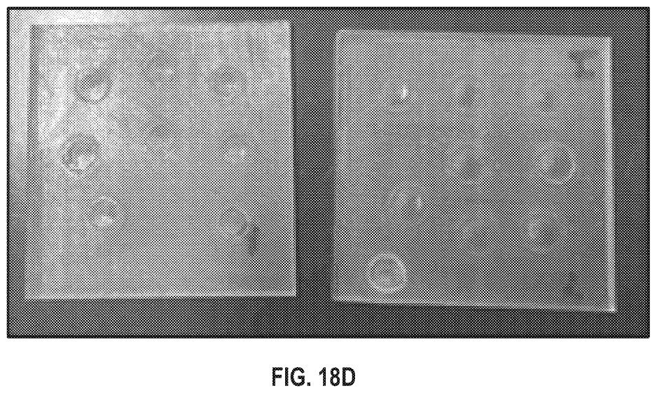

FIG. 18A is a photograph of the EVA material after impact testing at an impact energy of 1.74 J, and FIG. 18B is a photograph of the AM material after impact testing at an impact energy of 1.74 J. The results in FIGS. 18A and 18B were obtained via impact testing on 4 mm thick samples. The EVA material deformed plastically during the impact event and retained a visual mark from the impactor (FIG. 18A), while the AM material remained intact and showed no signs of permanent deformation (FIG. 18B). Additional impact testing right after soaking the material samples in water at 37 °C showed a comparable result at impact energies around 1.13 J. These results indicate that the AM material exhibited higher durability and better protection over multiple impact events than the EVA material.

For higher impact energies, the impactor pierced the EVA material and the rebound values could not be measured. The AM material was able to withstand impact energies up to almost 8.4 J before plastic deformation occurred. FIG. 18C is a graph of the force recorded during rebound testing of the AM material with an impactor with an edge-hemisphere having a 10 mm diameter at 2.2 m/s, and FIG. 18D illustrates the AM material after rebound testing at 2.2 m/s and 8.4 J. These results indicate that the AM material exhibited higher durability and better protection compared to the EVA material for impact events with impact energies greater than 1.13 J.

The AM material was harder and stiffer (Shore A ~90-95, tensile modulus ~30-100 MPa) than the EVA material (Shore A ~80-85, tensile modulus −10-30 MPa). Without wishing to be bound by theory, it is hypothesized that the reduced deformation and higher stiffness of the AM material would cause impact forces to be distributed over a wider area over the dental arch (e.g., across more teeth), which may reduce the force applied to any individual tooth below the injury threshold and thus confer improved protection.

### Additional Examples (I)

The following examples are included to further describe some aspects of the present technology, and should not be used to limit the scope of the technology.

Clause I-1. A dental appliance for protecting a subject's teeth, the dental appliance comprising:
a shell composed of a plurality of additively manufactured layers of a polymeric material that is configured to protect the subject's teeth from injury, wherein the polymeric material is prepared from a polymerizable composition comprising:
   (a) a polymerizable compound comprising:
      (i) a non-polar unit, and
      (ii) a polar unit substituted with one or more curable groups,
      wherein a ratio of the non-polar unit to the polar unit in the polymerizable compound is configured to confer shock absorption properties to the polymeric material while maintaining low water uptake of the polymeric material,
   (b) a reactive diluent, and
   (c) an initiator.

Clause I-2. The dental appliance of Clause I-1, wherein the ratio of the non-polar unit to the polar unit in the polymerizable compound is at least 1:5 by weight.

Clause I-3. The dental appliance of Clause I-2, wherein the ratio of the non-polar unit to the polar unit in the polymerizable compound is at least 1:2, 1:1, 5:1, 20:1, 25:1, 30:1, or 35:1 by weight.

Clause I-4. The dental appliance of any one of Clauses I-1 to I-3, wherein the polymerizable compound comprises a chain composed of a plurality of the non-polar units interspersed with a plurality of the polar units.

Clause I-5. The dental appliance of any one of Clauses I-1 to I-4, wherein the non-polar unit comprises an aliphatic hydrocarbon, an isoprene, a butadiene, a hydrogenated isoprene, a hydrogenated butadiene, an aromatic compound, or a siloxane.

Clause I-6. The dental appliance of any one of Clauses I-1 to I-5, wherein the non-polar unit comprises an isoprene unit having a structure of Formula (II):

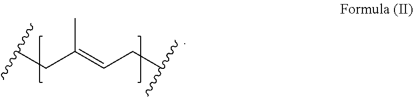

Clause I-7. The dental appliance of any one of Clauses I-1 to I-6, wherein the polar unit comprises a functionalized isoprene unit having a structure of Formula (III):

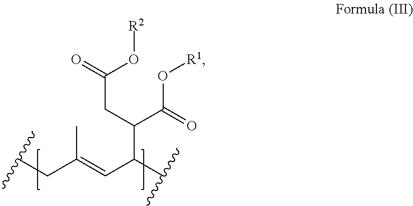

wherein:
   R₁ is H, alkyl, cycloalkyl, aryl, or a UV-curable group; and
   R₂ is a UV-curable group.

Clause I-8. The dental appliance of Clause I-6 or I-7, wherein the polar unit comprises a functionalized isoprene unit having a structure of Formula (IV):

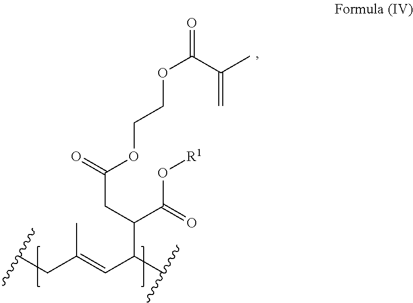

wherein R₁ is H, alkyl, cycloalkyl, or aryl.

Clause I-9. The dental appliance of any one of Clauses I-1 to I-8, wherein the polymerizable compound comprises a structure of Formula (V):

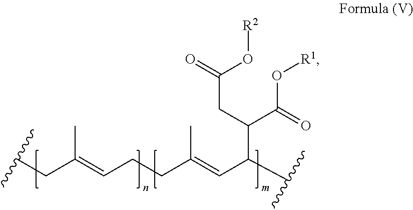

wherein:
   R₁ is H, alkyl, cycloalkyl, aryl, or a UV-curable group (e.g., (meth)acrylate);
   R₂ is a UV-curable group (e.g., (meth)acrylate);
   n is an integer from 1 to 10, 1 to 100, 1 to 1,000, or 1 to 10,000; and
   m is an integer from 1 to 10, 1 to 100, 1 to 1,000, or 1 to 10,000.

Clause I-10. The dental appliance of any one of Clauses I-1 to I-9, wherein the polymerizable compound comprises a structure of Formula (VI):

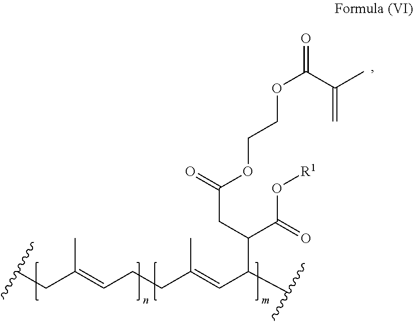

wherein:
   R₁ is H, alkyl, cycloalkyl, aryl, or a UV-curable group (e.g., (meth)acrylate);
   n is an integer from 1 to 10, 1 to 100, 1 to 1,000, or 1 to 10,000; and
   m is an integer from 1 to 10, 1 to 100, 1 to 1,000, or 1 to 10,000.

Clause I-11. The dental appliance of any one of Clauses I-1 to I-3, wherein the polymerizable compound comprises a chain composed of a plurality of the non-polar units, and wherein one or more of the polar units are located at one or more ends of the chain.

Clause I-12. The dental appliance of Clause I-11, wherein the chain comprises two, four, or six ends.

Clause I-13. The dental appliance of Clause I-11 or I-12, wherein the non-polar unit comprises aliphatic diol, diamine, diacid, butadiene diol, hydrogenated butadiene diol, or siloxane diol.

Clause I-14. The dental appliance of any one of Clauses I-11 to I-13, wherein the polar unit comprises methacrylate, acrylate, diisocyanate, or diacid.

Clause I-15. The dental appliance of any one of Clauses I-1 to I-14, wherein the one or more curable groups comprise methacrylate, acrylate, vinyl ether, or maleimide.

Clause I-16. The dental appliance of any one of Clauses I-1 to I-15, wherein the one or more curable groups comprises one or more UV-curable groups, and wherein the initiator comprises a photoinitiator.

Clause I-17. The dental appliance of any one of Clauses I-1 to I-16, wherein the polymerizable compound has a number average molecular weight of least 1,000 g/mol, 2,000 g/mol, 17,000 g/mol, or 35,000 g/mol.

Clause I-18. The dental appliance of any one of Clauses I-1 to I-17, wherein the reactive diluent comprises C₁-C₂₄ alkyl acrylate, C₁-C₂₄ alkyl methacrylate, C₁-C₂₄ cycloalkyl acrylate, C₁-C₂₄ cycloalkyl methacrylate, heteroalkyl acrylate, heteroalkyl methacrylate, heterocyclyl acrylate, heterocyclyl methacrylate, aryl acrylate, or aryl methacrylate.

Clause I-19. The dental appliance of any one of Clauses I-1 to I-18, wherein the reactive diluent has a structure of Formula (I):

X—Y Formula (I),
wherein:
   X is a linear, branched or cyclic, bicyclic or polycyclic C₅-C₄₀ aliphatic, heterocyclic or aromatic residue of one or more of the group consisting of methyl, ethyl, propyl, butyl, pentyl, hexyl, 2-ethylhexyl, octyl, decanyl, dodecanyl, acetic, propanoic, butanoic, pentanoic, undecanoic, dodecanoic, benzoic acid and corresponding esters, alkyl or aromatic esters, phenyl, benzyl, phenethyl, biphenyl, naphthyl, anthracenyl, pyrenyl, cyclopropyl, cyclobutyl, cyclopentyl, cyclohexyl, 4-isobutylcyclohexyl, cycloheptyl, cyclooctyl, adamantyl, isobornyl, salicyl, syringyl, and cholesteryl, wherein the one or more of the groups are individually linked via an ester, amide, urea, urethane, carbonate, ether, or thioether group, each of which are optionally substituted with one or more C₁-C₆ alkyl, C₁-C₆ alkoxy, C₃-C₇-cycloalkyl, C₆-C₁₀-aryl, C₁-C₆ thioether, halogen, —NO₂, —SO₃H, —CF₃, —OH, —NH₂, —SH, —CN, -trimethoxysilyl, or -triethoxysilyl; and
   Y is (meth)acrylate, (meth)acrylamide, vinyl ester, vinyl ether, vinyl amide, N-vinyl compounds, vinyl carbonate, vinyl carbamate, maleimide, itaconate, fumarate, styrene compounds, or a derivative thereof, each of which are optionally substituted with one or more C₁-C₆ alkyl, C₁-C₆ alkoxy, C₁-C₆ thioether, halogen, —NO₂, —SO₃H, —CF₃, —OH, —NH₂, —SH, —CN, -trimethoxysilyl, or -triethoxysilyl.

Clause I-20. The dental appliance of any one of Clauses I-1 to I-19, wherein the reactive diluent comprises a compound having one of the following structures:

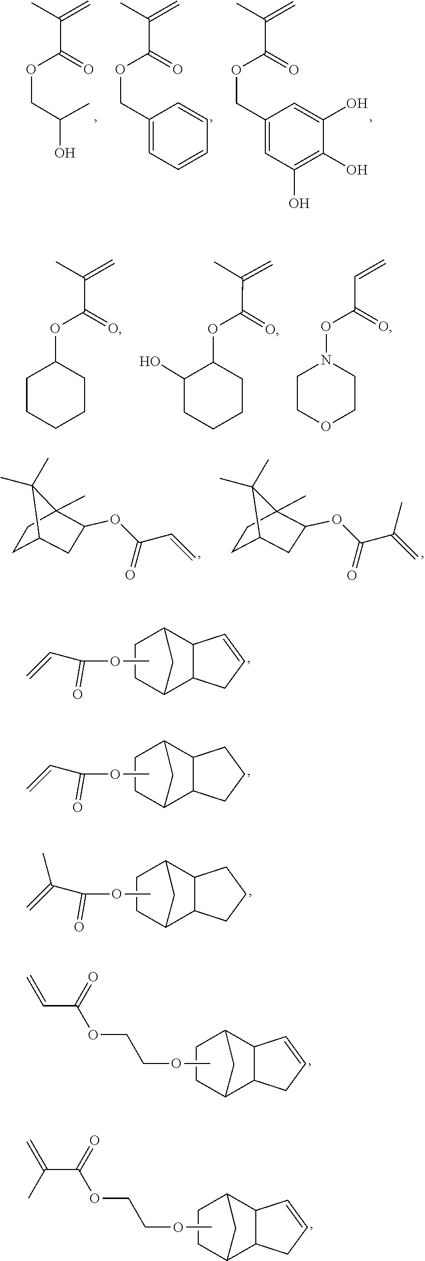

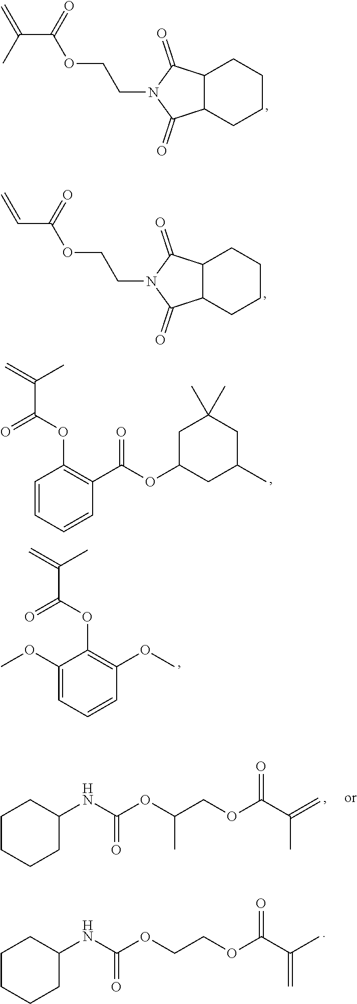

Clause I-21. The dental appliance of any one of Clauses I-1 to I-20, wherein the reactive diluent comprises a compound having one of the following structures:

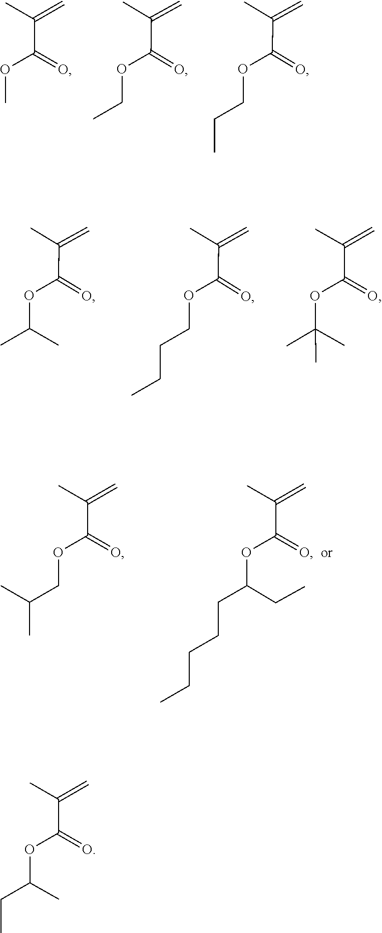

Clause I-22. The dental appliance of any one of Clauses I-1 to I-21, wherein the polymerizable compound, the reactive diluent, or both independently comprise silicone monomers, fluorinated monomers, or combinations thereof.

Clause I-23. The dental appliance of any one of Clauses I-1 to I-22, wherein the initiator comprises a free radical initiator.

Clause I-24. The dental appliance of any one of Clauses I-1 to I-23, wherein the polymerizable compound is present at a concentration within a range from 30 wt % to 90 wt % or from 30 wt % to 70 wt % based on the total weight of the polymerizable composition.

Clause I-25. The dental appliance of any one of Clauses I-1 to I-24, wherein the reactive diluent is present at a concentration within a range from 10 wt % to 60 wt % based on the total weight of the polymerizable composition.

Clause I-26. The dental appliance of any one of Clauses I-1 to I-25, wherein the initiator is present at a concentration within a range from 0.5 wt % to 2.0 wt % based on the total weight of the polymerizable composition.

Clause I-27. The dental appliance of any one of Clauses I-1 to I-26, wherein the polymerizable composition comprises from 50 wt % to 80 wt % of the polymerizable compound, and from 20 wt % to 50 wt % of the reactive diluent.

Clause I-28. The dental appliance of any one of Clauses I-1 to I-27, wherein the polymerizable composition comprises from 50 wt % to 85 wt % of the polymerizable compound, and from 15 wt % to 50 wt % of the reactive diluent.

Clause I-29. The dental appliance of any one of Clauses I-1 to I-28, wherein the polymerizable compound is present at a concentration within a range from 30 wt % to 70 wt %, the initiator is present at a concentration within a range from 0.5 wt % to 2.0 wt %, and the reactive diluent is present at a concentration within a range from 20 wt % to 50 wt % and comprises a compound having one of the following structures:

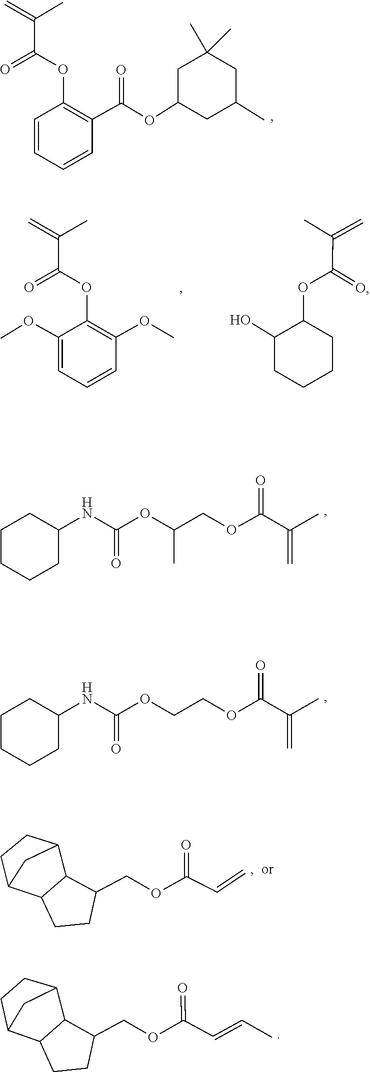

Clause I-30. The dental appliance of any one of Clauses I-1 to I-29, wherein the polymerizable compound is present at a concentration within a range from 50 wt % to 80 wt %, the initiator is present at a concentration within a range from 0.5 wt % to 2.0 wt %, and the reactive diluent is present at a concentration within a range from 20 wt % to 50 wt % and comprises a compound having one of the following structures:

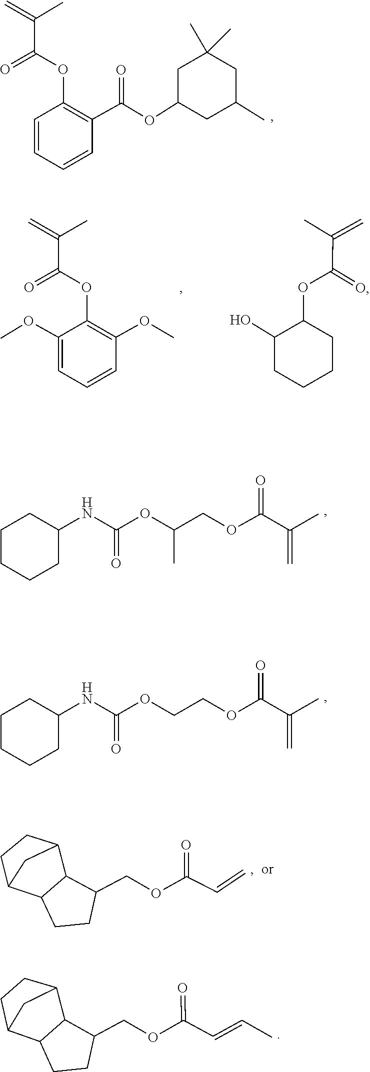

Clause I-31. The dental appliance of any one of Clauses I-1 to I-30, wherein the polymerizable compound comprises hydrogenated polybutadiene and is present at a concentration within a range from 50 wt % to 85 wt %, the initiator is present at a concentration within a range from 0.5 wt % to 2.0 wt %, and the reactive diluent is present at a concentration within a range from 15 wt % to 50 wt % and comprises a compound having one of the following structures:

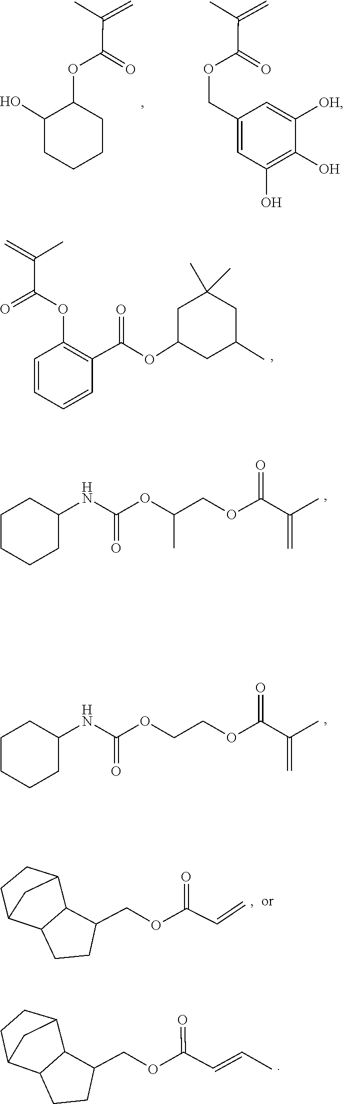

Clause I-32. The dental appliance of any one of Clauses I-1 to I-31, wherein the polymerizable composition further comprises one or more reagents selected from the group consisting of a crosslinking modifier, a glass transition temperature modifier, a toughness modifier, a polymerization catalyst, a polymerization inhibitor, thermal initiators, a light blocker, a UV absorber, an optical brightener, an opacifier, a plasticizer, a surface energy modifier, an antistatic agent, a wetting agent, a matting agent, an adhesion promoter, a rheology modifier, a thixotropic agent, an antifoaming agent, a pigment, a dye, a filler, an IR-absorbing component, an antioxidant, a dispersing agent, an antibacterial agent, a cyclopolymerizable monomer, a biologically significant chemical, a solvent, and combinations thereof.

Clause I-33. The dental appliance of any one of Clauses I-1 to I-32, wherein the polymerizable composition has a viscosity within a range from 1 cP to 10,000 cP at a temperature within a range from 15 °C to 100 °C, a viscosity within a range from 10 cP to 1,000 cP at a temperature within a range from 25 °C to 90 °C, a viscosity within a range from 100 cP to 500 cP at a temperature within a range from 30 °C to 60 °C, or a viscosity within a range from 5,000 cP to 10,000 cP at a temperature within a range from 15 °C to 30 °C.

Clause I-34. The dental appliance of any one of Clauses I-1 to I-33, wherein the dental appliance has a water uptake of less than 1 wt % when measured after 24 hours in a wet environment at 37 °C.

Clause I-35. The dental appliance of any one of Clauses I-1 to I-34, wherein the dental appliance has a rebound value of less than 30%.

Clause I-36. The dental appliance of any one of Clauses I-1 to 35, wherein the dental appliance is configured to absorb at least 70% of energy from an impact event.

Clause I-37. The dental appliance of any one of Clauses I-1 to I-36, wherein the dental appliance has a tear resistance of at least 20 kN/m.

Clause I-38. The dental appliance of any one of Clauses I-1 to I-37, wherein the dental appliance has a hardness within a range from 55 to 95 Shore A.

Clause I-39. The dental appliance of any one of Clauses I-1 to I-38, wherein the dental appliance has improved stain resistance.

Clause I-40. The dental appliance of any one of Clauses I-1 to I-39, wherein the shell comprises a buccal wall, a lingual wall, and an occlusal wall that define a plurality of cavities configured to receive the subject's teeth.

Clause I-41. The dental appliance of Clause I-40, wherein the lingual wall is thinner than the buccal wall and the occlusal wall.

Clause I-42. The dental appliance of Clause I-40 or I-41, wherein at least one of the buccal wall, the lingual wall, or the occlusal wall comprises a thickness that varies along an anterior-posterior axis of the shell.

Clause I-43. The dental appliance of any one of Clauses I-40 to I-42, wherein the buccal wall comprises a thicker anterior portion and a thinner posterior portion.

Clause I-44. The dental appliance of any one of Clauses I-40 to I-43, wherein the lingual wall comprises a thicker anterior portion and a thinner posterior portion.

Clause I-45. The dental appliance of any one of Clauses I-40 to I-44, wherein the occlusal wall comprises a thicker anterior portion and a thinner posterior portion.

Clause I-46. The dental appliance of any one of Clauses I-40 to I-45, wherein the buccal wall comprises an amount of gingival coverage that varies along the anterior-posterior axis of the shell.

Clause I-47. The dental appliance of any one of Clauses I-40 to I-46, wherein the lingual wall comprises substantially no gingival coverage.

Clause I-48. The dental appliance of any one of Clauses I-40 to I-47, wherein the occlusal wall comprises a flattened occlusal surface.

Clause I-49. The dental appliance of any one of Clauses I-40 to I-48, wherein the dental appliance is configured to be worn on an upper jaw of the subject, and wherein the occlusal wall comprises an occlusal surface having a surface geometry that is configured to mate with an occlusal surface of one or more teeth of a lower jaw of the subject.

Clause I-50. The dental appliance of Clause I-49, wherein the mating between the occlusal surface of the occlusal wall and the occlusal surface of the one or more teeth is configured to place the lower jaw at a desired position relative to the upper jaw.

Clause I-51. The dental appliance of any one of Clauses I-40 to I-50, wherein at least a portion of the buccal wall, the lingual wall, or a combination thereof is configured to be spaced apart from the subject's gingiva when the dental appliance is worn on the subject's teeth.

Clause I-52. The dental appliance of any one of Clauses I-40 to I-51, wherein at least some of the cavities define an offset distance from one or more teeth that are received by the at least some cavities when the dental appliance is worn on the subject's teeth.

Clause I-53. The dental appliance of any one of Clauses I-1 to I-52, wherein the shell is configured to apply forces to the subject's teeth to reposition the subject's teeth from a first arrangement toward a second arrangement.

Clause I-54. The dental appliance of any one of Clauses I-1 to I-52, wherein the shell is configured to apply forces to the subject's teeth to maintain the subject's teeth in a target arrangement.

Clause I-55. The dental appliance of any one of Clauses I-1 to I-54, wherein the dental appliance is a mouthguard.

Clause I-56. The dental appliance of Clause I-55, wherein the mouthguard is a sportsguard.

Clause I-57. The dental appliance of Clause I-55, wherein the mouthguard is a nightguard.

Clause I-58. The dental appliance of any one of Clauses I-1 to I-57, wherein the shell is configured to be worn over a second dental appliance placed on the subject's teeth.

Clause I-59. The dental appliance of Clause I-58, wherein the second dental appliance is an aligner, a retainer, or a palatal expander.

Clause I-60. The dental appliance of any one of Clauses I-1 to I-59, wherein the shell is a first shell that is configured to be worn on an upper jaw of the subject, and wherein the dental appliance further comprises a second shell connected to the first shell, the second shell being configured to be worn on a lower jaw of the subject.

Clause I-61. A dental appliance for protecting a subject's teeth, the dental appliance comprising:
a shell composed of a plurality of additively manufactured layers of a polymeric material that is configured to protect the subject's teeth from injury, wherein the polymeric material is prepared from a polymerizable composition comprising:
   (a) a polymerizable compound comprising:
      (i) a non-polar unit, and
      (ii) a polar unit substituted with one or more curable groups,
   (b) a reactive diluent, and
   (c) an initiator.

Clause I-62. A method comprising fabricating the dental appliance of any one of Clauses I-1 to 61 via an additive manufacturing process.

Clause I-63. The method of Clause I-62, wherein the additive manufacturing process comprises applying energy to the polymerizable composition to form the polymeric material.

Clause I-64. The method of Clause I-63, wherein the energy comprises light.

Clause I-65. The method of any one of Clauses I-62 to I-64, wherein the additive manufacturing process comprises stereolithography or digital light processing.

Clause I-66. The method of any one of Clauses I-62 to I-65, wherein the polymerizable composition is a first polymerizable composition, and wherein the method further comprises forming a polymeric coating on the dental appliance from a second polymerizable composition.

Clause I-67. The method of Clause I-66, wherein forming the polymeric coating comprises applying the second polymerizable composition to the dental appliance and applying energy to the second polymerizable composition to form the polymeric coating.

### Additional Examples (II)

The following examples are included to further describe some aspects of the present technology, and should not be used to limit the scope of the technology.

Clause II-1. A polymerizable composition comprising:
a) an oligomer having a molecular weight of at least 1,000 g/mol and comprising:
   i) a non-polar unit; and
   ii) a polar unit substituted with one or more UV-curable groups, wherein the ratio of the non-polar unit to the polar unit is at least 1:5 by weight;
b) a reactive diluent comprising C₁-C₂₄ alkyl acrylate, C₁-C₂₄ alkyl methacrylate, C₁-C₂₄ cycloalkyl acrylate, C₁-C₂₄ cycloalkyl methacrylate, heteroalkyl acrylate, heteroalkyl methacrylate, heterocyclyl acrylate, heterocyclyl methacrylate, aryl acrylate, or aryl methacrylate; and
c) a photoinitiator.

Clause II-2. A polymerizable composition comprising:
a) an oligomer having a molecular weight of at least 1,000 g/mol and comprising:
   i) a non-polar unit; and
   ii) a polar unit substituted with one or more UV-curable groups, wherein the ratio of the non-polar unit to the polar unit is at least 1:5 by weight;
b) a reactive diluent having the Formula (I):

X—Y Formula (I),
wherein:
   X is a linear, branched or cyclic, bicyclic or polycyclic C₅-C₄₀ aliphatic, heterocyclic or aromatic residue of one or more of the group consisting of methyl, ethyl, propyl, butyl, pentyl, hexyl, 2-ethylhexyl, octyl, decanyl, dodecanyl, acetic, propanoic, butanoic, pentanoic, undecanoic, dodecanoic, benzoic acid and corresponding esters, alkyl or aromatic esters, phenyl, benzyl, phenethyl, biphenyl, naphthyl, anthracenyl, pyrenyl, cyclopropyl, cyclobutyl, cyclopentyl, cyclohexyl, 4-isobutylcyclohexyl, cycloheptyl, cyclooctyl, adamantyl, isobornyl, salicyl, syringyl, and cholesteryl, wherein the one or more of the groups are individually linked via an ester, amide, urea, urethane, carbonate, ether, or thioether group, each of which are optionally substituted with one or more C₁-C₆ alkyl, C₁-C₆ alkoxy, C₃-C₇-cycloalkyl, C₆-C₁₀-aryl, C₁-C₆ thioether, halogen, —NO₂, —SO₃H, —CF₃, —OH, —NH₂, —SH, —CN, -trimethoxysilyl, or -triethoxysilyl; and
   Y is (meth)acrylate, (meth)acrylamide, vinyl ester, vinyl ether, vinyl amide, N-vinyl compounds, vinyl carbonate, vinyl carbamate, maleimide, itaconate, fumarate, styrene compounds, or a derivative thereof, each of which are optionally substituted with one or more C₁-C₆ alkyl, C₁-C₆ alkoxy, C₁-C₆ thioether, halogen, —NO₂, —SO₃H, —CF₃, —OH, —NH₂, —SH, —CN, -trimethoxysilyl, or -triethoxysilyl; and
c) a photoinitiator.

Clause II-3. The polymerizable composition of Clause II-1 or II-2, wherein the non-polar unit comprises aliphatic hydrocarbon, isoprene, butadiene, hydrogenated isoprene, hydrogenated butadiene, aromatic compound, or siloxane.

Clause II-4. The polymerizable composition of any one of Clauses II-1 to II-3, wherein the non-polar unit comprises isoprene.

Clause II-5. The polymerizable composition of any one of Clauses II-1 to II-4, wherein a ratio of the non-polar unit to the polar unit is about 1:2 by weight.

Clause II-6. The polymerizable composition of any one of Clauses II-1 to II-4, wherein a ratio of the non-polar unit to the polar unit is about 1:1 by weight.

Clause II-7. The polymerizable composition of any one of Clauses II-1 to II-4, wherein a ratio of the non-polar unit to the polar unit is about 5:1 by weight.

Clause II-8. The polymerizable composition of any one of Clauses II-1 to II-4, wherein a ratio of the non-polar unit to the polar unit is about 25:1 by weight.

Clause II-9. The polymerizable composition of any one of Clauses II-1 to II-4, wherein a ratio of the non-polar unit to the polar unit is about 35:1 by weight.

Clause II-10. The polymerizable composition of any one of Clauses II-1 to II-4, wherein a ratio of the non-polar unit to the polar unit is about 38:1 by weight.

Clause II-11. The polymerizable composition of any one of Clauses II-1 to II-4, wherein a ratio of the non-polar unit to the polar unit is about 28:1 by weight.

Clause II-12. The polymerizable composition of any one of Clauses I-1-4, wherein a ratio of the non-polar unit to the polar unit is higher than 1:2 by weight.

Clause II-13. The polymerizable composition of any one of Clauses II-1 to II-4, wherein a ratio of the non-polar unit to the polar unit is higher than 1:1 by weight.

Clause II-14. The polymerizable composition of any one of Clauses II-1 to II-4, wherein a ratio of the non-polar unit to the polar unit is higher than 5:1 by weight.

Clause II-15. The polymerizable composition of any one of Clauses II-1 to II-4, wherein a ratio of the non-polar unit to the polar unit is higher than 20:1 by weight.

Clause II-16. The polymerizable composition of any one of Clauses II-1 to II-4, wherein a ratio of the non-polar unit to the polar unit is higher than 25:1 by weight.

Clause II-17. The polymerizable composition of any one of Clauses II-1 to II-4, wherein a ratio of the non-polar unit to the polar unit is higher than 30:1 by weight.

Clause II-18. The polymerizable composition of any one of Clauses II-1 to II-4, wherein a ratio of the non-polar unit to the polar unit is higher than 35:1 by weight.

Clause II-19. The polymerizable composition of any one of Clauses II-1 to II-18, wherein the non-polar unit comprises an isoprene unit having a structure of Formula (II):

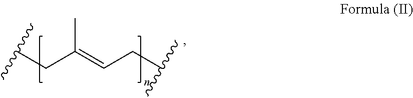

wherein n is an integer from 1 to 10.

Clause II-20. The polymerizable composition of any one of Clauses II-1 to II-19, wherein the polar unit comprises isoprene having a structure of Formula (III):

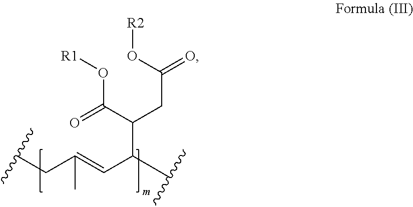

wherein:
   R₁ is H, alkyl, cycloalkyl, aryl, or a UV-curable group preferably selected from (meth)acrylates;
   R₂ is a UV-curable group preferably selected from (meth)acrylates; and
   m is an integer from 1 to 10.

Clause II-21. The polymerizable composition of Clause II-20, wherein the polar unit comprises isoprene having a structure of Formula (IV):

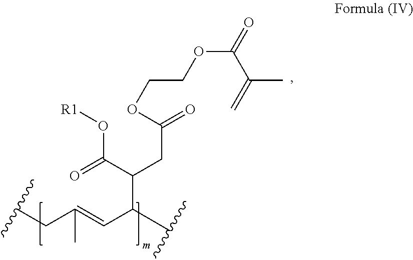

wherein:
   R₁ is H, alkyl, cycloalkyl, or aryl; and
   m is an integer from 1 to 10.

Clause II-22. A polymerizable composition comprising:
a) an oligomer having a molecular weight of at least 1,000 g/mol and comprising:
   i) an oligomeric multifunctional non-polar unit; and
   ii) a component B substituted with one or more UV-curable groups, wherein the ratio of the non-polar unit to the component B is at least 1:5 by weight;
b) a reactive diluent comprising C₁-C₂₄ alkyl acrylate, C₁-C₂₄ alkyl methacrylate, C₁-C₂₄ cycloalkyl acrylate, C₁-C₂₄ cycloalkyl methacrylate, heteroalkyl acrylate, heteroalkyl methacrylate, heterocyclyl acrylate, heterocyclyl methacrylate aryl acrylate, or aryl methacrylate; and
c) a photoinitiator.

Clause II-23. The polymerizable composition of Clause II-22, wherein the oligomeric multifunctional non-polar unit comprises aliphatic diol, diamine, diacid, butadiene diol, hydrogenated butadiene diol, or siloxane diol.

Clause II-24. The polymerizable composition of Clause II-22 or Clause II-23, wherein the oligomeric multifunctional non-polar unit is a dumbbell oligomer.

Clause II-25. The polymerizable composition of any one of Clauses II-22 to II-24, wherein the component B comprises methacrylate or acrylate.

Clause II-26. The polymerizable composition of any one of Clauses II-22 to II-25, wherein the component B comprises diisocyanate or diacid.

Clause II-27. The polymerizable composition of any one of Clauses II-22 to II-26, wherein a ratio of the oligomeric multifunctional non-polar unit to the component B is about 1:2 by weight.

Clause II-28. The polymerizable composition of any one of Clauses II-22 to II-26, wherein a ratio of the oligomeric multifunctional non-polar unit to the component B is about 1:1 by weight.

Clause II-29. The polymerizable composition of any one of Clauses II-22 to II-26, wherein a ratio of the oligomeric multifunctional non-polar unit to the component B is about 5:1 by weight.

Clause II-30. The polymerizable composition of any one of Clauses II-22 to II-26, wherein a ratio of the oligomeric multifunctional non-polar unit to the component B is at least 1:2 by weight.

Clause II-31. The polymerizable composition of any one of Clauses II-22 to II-26, wherein a ratio of the oligomeric multifunctional non-polar unit to the component B is at least 1:1 by weight.

Clause II-32. The polymerizable composition of any one of Clauses II-22 to II-26, wherein a ratio of the oligomeric multifunctional non-polar unit to the component B is at least 5:1 by weight.

Clause II-33. The polymerizable composition of any one of Clauses II-1 to II-32, wherein the one or more UV-curable groups are methacrylate, acrylate, vinyl ether, or maleimide.

Clause II-34. The polymerizable composition of any one of Clauses II-22 to II-33, wherein the methacrylate comprises propyl methacrylate, butyl methacrylate, pentyl methacrylate, hexyl methacrylate, ethyl hexyl methacrylate, adamantyl methacrylate, or thiol-methacrylate.

Clause II-35. The polymerizable composition of any one of Clauses II-22 to II-34, wherein the acrylate comprises propyl acrylate, butyl acrylate, pentyl acrylate, hexyl acrylate, ethyl hexyl acrylate, adamantyl acrylate, or thiol-acrylate.

Clause II-36. The polymerizable composition of any one of Clauses II-1 to II-35, wherein the oligomer has a molecular weight of at least 1,500 g/mol.

Clause II-37. The polymerizable composition of any one of Clauses II-1 to II-36, wherein the oligomer has a molecular weight of at least 2,000 g/mol.

Clause II-38. The polymerizable composition of any one of Clauses II-1 to II-36, wherein the oligomer has a molecular weight of about 17,000 g/mol.

Clause II-39. The polymerizable composition of any one of Clauses II-1 to II-38, wherein the oligomer has a molecular weight of about 35,000 g/mol.

Clause II-40. The polymerizable composition of any one of Clauses II-1 to II-39, wherein the oligomer is present at a concentration of within a range from 30 wt % to 90 wt % based on the total weight of the polymerizable composition.

Clause II-41. The polymerizable composition of any one of Clauses II-1 to II-40, wherein the oligomer is present at a concentration within a range from 30 wt % to 70 wt % based on the total weight of the polymerizable composition.

Clause II-42. The polymerizable composition of any one of Clauses II-1 to II-41, wherein the reactive diluent is present at a concentration within a range from 10 wt % to 60 wt % based on the total weight of the polymerizable composition.

Clause II-43. The polymerizable composition of any one of Clauses II-1 to II-42, wherein the photoinitiator is present at a concentration within a range from 0.1 wt % to 2.5 wt % or from 0.25 wt % to 2.5 wt % based on the total weight of the polymerizable composition.

Clause II-44. The polymerizable composition of any one of Clauses II-1 to II-43, wherein the photoinitiator is present at a concentration within a range from 0.5 wt % to 2.0 wt % based on the total weight of the polymerizable composition.

Clause II-45. The polymerizable composition of any one of Clauses II-1 to II-44, wherein the oligomer, reactive diluent, or both independently comprise silicone monomers, fluorinated monomers, or combinations thereof.

Clause II-46. The polymerizable composition of any one of Clauses II-1 to II-45, wherein the reactive diluent comprises a compound having one of the following structures:

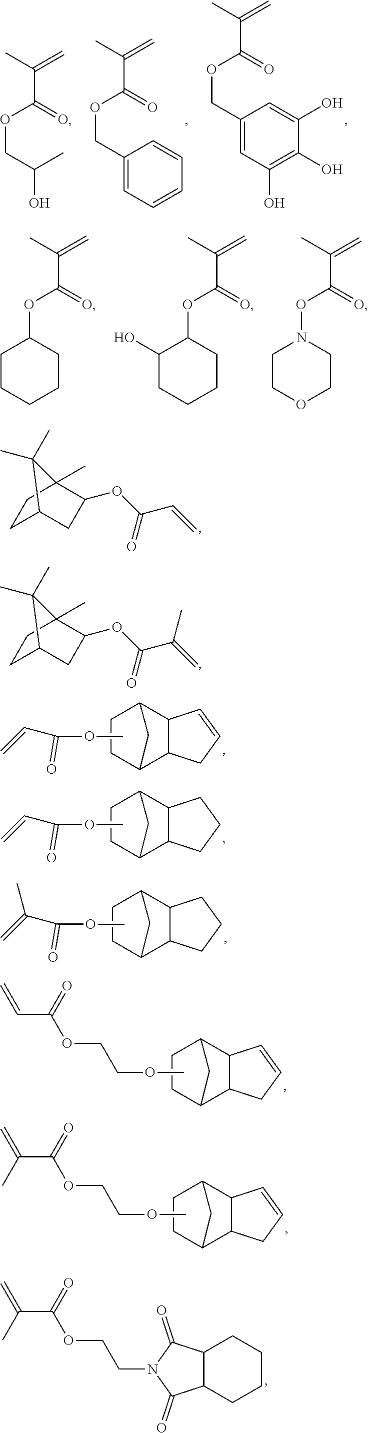

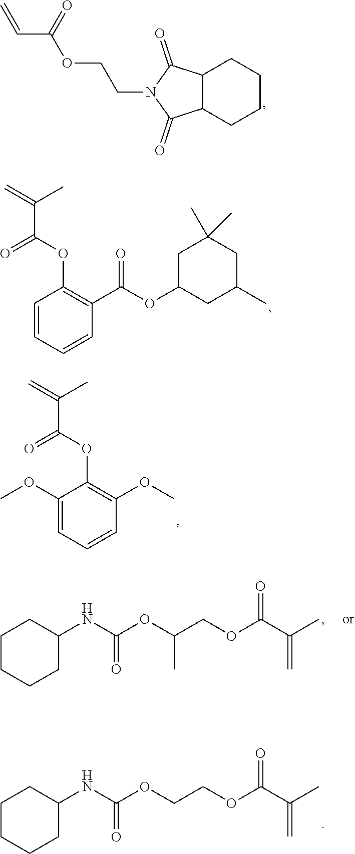

Clause II-47. The polymerizable composition of any one of Clauses II-1 to II-46, wherein the reactive diluent comprises a compound having one of the following structures:

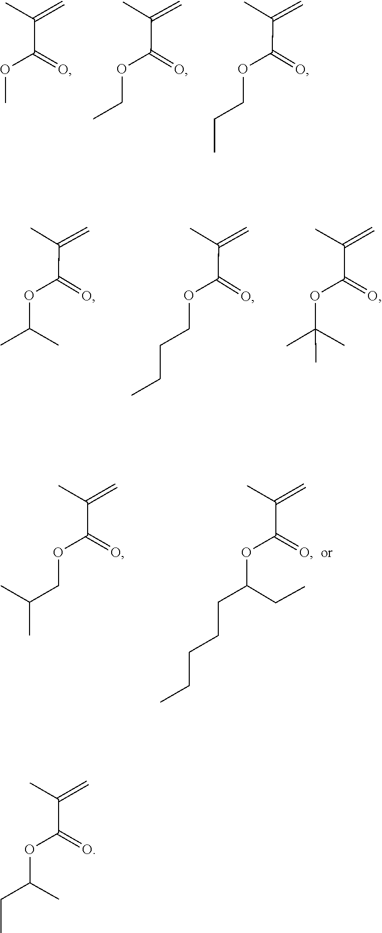

Clause II-48. The polymerizable composition of any one of Clauses II-1 to II-47, wherein the oligomer is present at a concentration within a range from 30 wt % to 70 wt %, the photoinitiator is present at a concentration within a range from 0.5 wt % to 2.0 wt %, and the reactive diluent is present at a concentration within a range from 20 wt % to 50 wt % and comprises a compound having one of the following structures:

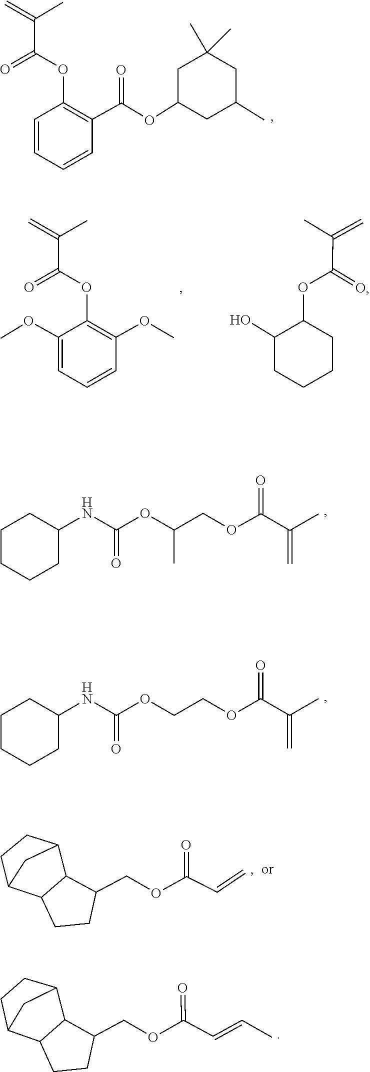

Clause II-49. The polymerizable composition of any one of Clauses II-1 to II-47, wherein the oligomer is present at a concentration within a range from 50 wt % to 80 wt %, the photoinitiator is present at a concentration within a range from 0.5 wt % to 2.0 wt %, and the reactive diluent is present at a concentration within a range from 20 wt % to 50 wt % and comprises a compound having one of the following structures:

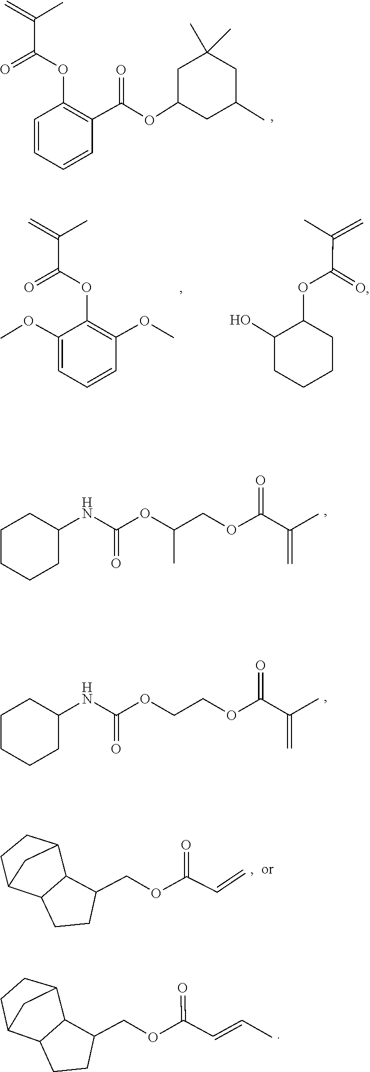

Clause II-50. The polymerizable composition of any one of Clauses II-1 to II-47, wherein the oligomer comprises hydrogenated polybutadiene present at a concentration within a range from 50 wt % to 85 wt %, the photoinitiator is present at a concentration within a range from 0.5 wt % to 2.0 wt %, and the reactive diluent is present at a concentration within a range from 15 wt % to 50 wt % and comprises a compound having one of the following structures:

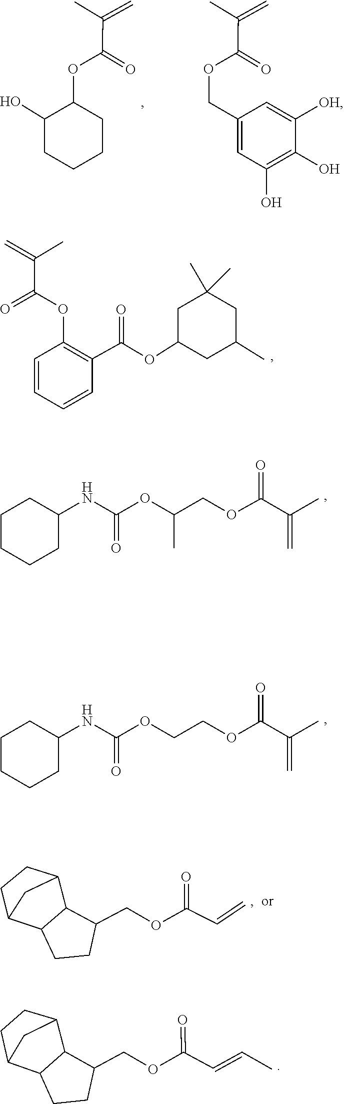

Clause II-51. The polymerizable composition of any one of Clauses II-1 to II-50, wherein the photoinitiator comprises a free radical photoinitiator.

Clause II-52. The polymerizable composition of any one of Clauses II-1 to II-51, wherein the polymerizable composition is a photocurable composition.

Clause II-53. The polymerizable composition of any one of Clauses II-1 to II-52, further comprising one or more reagents selected from the group consisting of a crosslinking modifier, a glass transition temperature modifier, a toughness modifier, a polymerization catalyst, a polymerization inhibitor, thermal initiators, a light blocker, a UV absorber, an optical brightener, an opacifier, a plasticizer, a surface energy modifier, an antistatic agent, a wetting agent, a matting agent, an adhesion promoter, a rheology modifier, a thixotropic agent, an antifoaming agent, a pigment, a dye, a filler, an IR-absorbing component, an antioxidant, a dispersing agent, an antibacterial agent, a cyclopolymerizable monomer, a biologically significant chemical, a solvent, and combinations thereof.

Clause II-54. The polymerizable composition of any one of Clauses II-1 to II-53, wherein the polymerizable composition has a viscosity within a range from 1 cP to 10,000 cP at a temperature within a range from 15 °C to 100 °C.

Clause II-55. The polymerizable composition of any one of Clauses II-1 to II-53, wherein the polymerizable composition has a viscosity within a range from 10 cP to 1,000 cP at a temperature within a range from 25 °C to 90 °C.

Clause II-56. The polymerizable composition of any one of Clauses II-1 to II-53, wherein the polymerizable composition has a viscosity within a range from 100 cP to 500 cP at a temperature within a range from 30 °C to 60 °C.

Clause II-57. The polymerizable composition of any one of Clauses II-1 to II-56, wherein the polymerizable composition has a viscosity within a range from 5,000 cP to 10,000 cP at a temperature within a range from 15 °C to 30 °C.

Clause II-58. A polymeric coating formed from the polymerizable composition of any one of Clauses II-1 to II-57.

Clause II-59. The polymeric coating of Clause II-58, wherein the polymeric coating is present on the surface of a polymeric substrate having one or more of the following characteristics:
(A) a storage modulus greater than or equal to 10 MPa;
(B) an elongation at break greater than or equal to 5% before and after 24 hours in a wet environment at 37 °C;
(C) a water uptake of less than 2 wt % when measured after 24 hours in a wet environment at 37 °C;
(D) transmission of at least 30% of visible light through the polymeric material after 24 hours in a wet environment at 37 °C; and
(E) comprises a plurality of polymeric phases, wherein at least one polymeric phase of the one or more polymeric phases has a T_{g} of at least 60 °C, 80 °C, 90 °C, 100 °C, or at least 110 °C.

Clause II-60. The polymeric coating of any one of Clauses II-58 or II-59, wherein the polymeric coating, polymeric substrate, or both taken together are characterized as having a water uptake of less than 20 wt %, less than 15 wt %, less than 10 wt %, less than 5 wt %, less than 4 wt %, less than 3 wt %, less than 2 wt %, less than 1 wt %, less than 0.5 wt %, less than 0.25 wt %, or less than 0.1 wt % when measured after 24 hours in a wet environment at 37 °C.

Clause II-61. The polymeric coating of any one of Clauses II-58 to II-60, wherein the polymeric coating has greater than 90% conversion of double bonds to single bonds compared to the polymerizable composition, as measured by FTIR.

Clause II-62. The polymeric coating of any one of Clauses II-58 to II-61, wherein the polymeric coating, polymeric substrate, or both taken together have an ultimate tensile strength from 10 MPa to 100 MPa, from 15 MPa to 80 MPa, from 20 MPa to 60 MPa, from 10 MPa to 50 MPa, from 10 MPa to 45 MPa, from 25 MPa to 40 MPa, from 30 MPa to 45 MPa, or from 30 MPa to 40 MPa after 24 hours in a wet environment at 37 °C.

Clause II-63. The polymeric coating of any one of Clauses II-58 to II-62, wherein the polymeric coating, polymeric substrate, or both taken together are characterized by an elongation at break greater than 10%, an elongation at break greater than 20%, an elongation at break greater than 30%, an elongation at break of 5% to 250%, an elongation at break of 20% to 250%, or an elongation at break value between 40% and 250% before and after 24 hours in a wet environment at 37 °C.

Clause II-64. The polymeric coating of any one of Clauses II-58 to II-63, wherein the polymeric coating, polymeric substrate, or both taken together are characterized by a storage modulus within a range from 0.1 MPa to 4000 MPa, from 300 MPa to 3000 MPa, or from 750 MPa to 3000 MPa after 24 hours in a wet environment at 37 °C.

Clause II-65. The polymeric coating of any one of Clauses II-58 to II-64, wherein at least 40%, 50%, 60%, or 70% of visible light passes through the polymeric coating, polymeric substrate, or both taken together after 24 hours in a wet environment at 37 °C.

Clause II-66. The polymeric coating of any one of Clauses II-58 to II-65, wherein the polymeric coating, polymeric substrate, or both taken together are biocompatible, bioinert, or a combination thereof.

Clause II-67. The polymeric coating of any one of Clauses II-58 to II-66, wherein the polymeric coating has a thickness of within a range from 5 m to 50 m.

Clause II-68. The polymeric coating of any one of Clauses II-58 to II-67, wherein the polymeric coating increases stain resistance relative to the polymeric substrate without the polymeric coating.

Clause II-69. The polymerizable composition of any one of Clauses II-1 to II-68, wherein the oligomeric multifunctional non-polar unit is a difunctional non-polar unit.

Clause II-70. The polymerizable composition of any one of Clauses II-1 to II-68, wherein the oligomeric multifunctional non-polar unit is a trifunctional non-polar unit.

Clause II-71. The polymerizable composition of any one of Clauses II-1 to II-68, wherein the oligomeric multifunctional non-polar unit is a tetrafunctional non-polar unit.

Clause II-72. The polymerizable composition of any one of Clauses II-1 to II-68, wherein the oligomeric multifunctional non-polar unit is a hexafunctional non-polar unit.

Clause II-73. An object comprising the polymeric coating of any one of Clauses II-58 to II-72.

Clause II-74. A mouthguard formed from the polymerizable composition of any one of Clauses II-1 to II-58.

Clause II-75. The mouthguard of Clause II-74, wherein the mouthguard has a tear resistance of at least 20 kN/m.

Clause II-76. The mouthguard of Clause II-74 or II-75, wherein the mouthguard has a water uptake of at least less than 1 wt %.

Clause II-77. The mouthguard of any one of Clauses II-74 to II-76, wherein the mouthguard has a rebound resilience of at least less than 30%.

Clause II-78. The mouthguard of any one of Clauses II-74 to II-77, wherein the mouthguard has an absorbed energy of at least more than 70%.

Clause II-79. The mouthguard of any one of Clauses II-74 to II-78, wherein the mouthguard is free from tin (Sn).

Clause II-80. An orthodontic appliance comprising the polymeric coating of any one of Clauses II-58 to II-68.

Clause II-81. The orthodontic appliance of Clause II-80, wherein the orthodontic appliance is a dental appliance.

Clause II-82. The orthodontic appliance of Clause II-80, wherein the orthodontic appliance is a dental aligner, a dental expander, a mouthguard, a dental spacer, or a nightguard.

Clause II-83. A method of forming a polymeric coating, the method comprising: providing an orthodontic appliance;
contacting the orthodontic appliance with the polymerizable composition of any one of Clauses II-1 to II-58, thereby forming a polymeric coating; and
exposing the polymerizable composition to a light source, thereby curing the polymeric coating.

Clause II-84. The method of Clause II-83, wherein the light source is an ultraviolet (UV) or visible light source.

Clause II-85. The method of any one of Clauses II-83 to II-84, further comprising fabricating an orthodontic appliance with a polymer.

Clause II-86. The method of any one of Clauses II-83 to II-85, wherein the contacting is done via dip coating or spray coating.

Clause II-87. The method of any one of Clauses II-83 to II-86, wherein the method further comprises removing excess polymerizable composition via centrifugation.

Clause II-88. The method of any one of Clauses II-83 to II-87, wherein the centrifugation uses tension, compression, or a combination of tension and compression.

Clause II-89. The method any one of Clauses II-83 to II-88, wherein the polymeric coating is covalently bound to the surface of the orthodontic appliance.

Clause II-90. The method of any one of Clauses II-83 to II-89, wherein the orthodontic appliance has not undergone a curing step.

Clause II-91. The method of any one of Clauses II-83 to II-90, wherein the orthodontic appliance has undergone a curing step.

Clause II-92. The method of any one of Clauses II-83 to II-91, wherein the orthodontic appliance is partially cured.

Clause II-93. The method of any one of Clauses II-83 to II-92, wherein the contacting, exposing, or both are performed under an inert atmosphere.

Clause II-94. The method of any one of Clauses II-83 to II-93, wherein the contacting, exposing, or both are performed under an atmosphere that includes less than 5% oxygen.

Clause II-95. The method of any one of Clauses II-83 to II-94, wherein the contacting, exposing, or both are not performed under an atmosphere that includes less than 5% oxygen.

Clause II-96. A method for preparing an object by an additive manufacturing process, comprising:
providing a first polymerizable composition;
exposing the first polymerizable composition to radiation;
polymerizing the first polymerizable composition layer-by-layer based on a predefined design, thereby polymerizing the first polymerizable composition to form a polymer;
fabricating the object with the polymer; and
contacting the object with a second polymerizable composition thereby forming a polymeric coating, wherein the second polymerizable composition is the polymerizable composition of any one of Clauses II-1 to II-58.

Clause II-97. The method of Clause II-96, wherein the method further comprises heating the first polymerizable composition to a processing temperature.

Clause II-98. The method of Clause II-97, wherein the processing temperature is less than 80 °C.

Clause II-99. The method of any one of Clauses II-96 to II-98, wherein the processing temperature is less than 40 °C, less than 35 °C, less than 30 °C, or less than 27 °C.

Clause II-100. The method of any one of Clauses II-96 to II-99, wherein the method further comprises receiving a file containing instructions for fabrication of a dental appliance.

Clause II-101. The method of any one of Clauses II-96 to II-100, wherein the additive manufacturing process is a 3D printing process.

Clause II-102. The method of any one of Clauses II-96 to II-101, wherein the method further comprises increasing the stain resistance of the object.

Clause II-103. The method of any one of Clauses II-96 to II-102, wherein the object is a medical device.

Clause II-104. The method of Clause I-103, wherein the medical device is an orthodontic appliance.

Clause II-105. The method of any one of Clauses II-96 to II-102, wherein the object is a mouthguard.

Clause II-106. A method of repositioning a patient's teeth, comprising:
generating a treatment plan for the patient, the plan comprising a plurality of intermediate tooth arrangements for moving teeth along a treatment path from an initial tooth arrangement toward a final tooth arrangement;
producing an orthodontic appliance according to any one of Clauses II-80 to II-82, or an orthodontic appliance comprising the polymeric coating of any one of Clauses II-58 to II-68; and
moving on-track, with the orthodontic appliance, at least one of the patient's teeth toward an intermediate tooth arrangement or the final tooth arrangement.

Clause II-107. The method of Clause II-106, wherein producing the orthodontic appliance comprises 3D printing of the orthodontic appliance.

Clause II-108. The method of Clause II-106 or II-107, further comprising tracking progression of the patient's teeth along the treatment path after administration of the orthodontic appliance to the patient, the tracking comprising comparing a current arrangement of the patient's teeth to a planned arrangement of the patient's teeth.

Clause II-109. The method of any one of Clauses II-106 to II-108, wherein greater than 60% of the patient's teeth are on track with the treatment plan after 2 weeks of treatment.

Clause II-110. The method of any one of Clauses II-106 to II-109, wherein the orthodontic appliance has a retained repositioning force to the at least one of the patient's teeth after 2 days that is at least 10%, at least 20%, at least 30%, at least 40%, at least 50%, at least 60%, or at least 70% of a repositioning force initially provided to the at least one of the patient's teeth.

Clause II-111. The method of any one of Clauses II-106 to II-110, wherein the treatment plan is generated using an intraoral scan of the patient's teeth.

### CONCLUSION

Although many of the embodiments are described above with respect to compositions, devices, and methods for fabrication of dental appliances, the technology is applicable to other applications and/or other approaches, such as fabrication of other types of objects. For example, the polymerizable compositions herein can be used for other devices within the field of dentistry (e.g., prosthetics, restoratives), as well as outside the field of dentistry, such as devices for use in any of the following: aerospace applications, automotive applications, construction applications, consumer products (e.g., shoes, clothing, sporting goods), electronics applications, energy applications, industrial applications (e.g., prototyping, manufacturing), medical applications (e.g., hearing aids, implants, prosthetics), and/or military applications. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-18D.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. It is noted that as used herein and in the appended claims, the singular forms “a”, “an”, and “the” include plural references unless the context clearly dictates otherwise. Thus, for example, reference to “a monomer” includes a plurality of such monomers and equivalents thereof known to those skilled in the art, and so forth. As well, the terms “a” (or “an”), “one or more”, and “at least one” can be used interchangeably herein.

Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art. Number ranges are to be understood as inclusive, i.e., including the indicated lower and upper limits (e.g., the phrase “an integer ranging from 1-3” includes the integers 1, 2, and 3). Furthermore, the term “about,” as used herein in connection with one or more numerical values, and unless clearly indicated otherwise, refers to and encompasses plus or minus 10% of the indicated numerical value(s). For example, “about 10%” may indicate a range from 9% to 11%, and “about 1” may include a range from 0.9 to 1.1.

Moreover, unless the word “or” is expressly limited to mean only a single item exclusive from the other items in reference to a list of two or more items, then the use of “of” in such a list is to be interpreted as including (a) any single item in the list, (b) all of the items in the list, or (c) any combination of the items in the list. As used herein, the phrase “and/or” as in “A and/or B” refers to A alone, B alone, and A and B.

Additionally, the terms “to comprise” or “comprising” are understood to be non-limiting and are used throughout to mean including at least the recited feature(s), such that any greater number of the same feature and/or additional types of other features are not precluded. It is also to be noted that the terms “comprising”, “including”, and “having” can be used interchangeably.

The terms “consisting” or “consisting of” means that only components that are explicitly described are included. The term “consisting essentially of” limits the scope to specified materials, elements, steps, embodiments, aspects, and limitations except for those that do not materially affect basic and novel characteristics. For each embodiment of this disclosure, it is understood that any specified materials, elements, steps, embodiments, aspects, and limitations may be included with any of the phrases.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A dental appliance for protecting a subject's teeth, the dental appliance comprising:
a shell composed of a plurality of additively manufactured layers of a polymeric material that is configured to protect the subject's teeth from injury, wherein the polymeric material is prepared from a polymerizable composition comprising:
(a) a polymerizable compound comprising:
(i) a non-polar unit, and
(ii) a polar unit substituted with one or more curable groups,
wherein a ratio of the non-polar unit to the polar unit in the polymerizable compound is configured to confer shock absorption properties to the polymeric material while maintaining low water uptake of the polymeric material,
(b) a reactive diluent, and
(c) an initiator.

2. The dental appliance of claim 1, wherein the ratio of the non-polar unit to the polar unit in the polymerizable compound is at least 1:5 by weight.

3. The dental appliance of claim 1, wherein the polymerizable compound comprises a chain composed of a plurality of the non-polar units interspersed with a plurality of the polar units.

4. The dental appliance of claim 3, wherein the non-polar unit comprises an aliphatic hydrocarbon, an isoprene, a butadiene, a hydrogenated isoprene, a hydrogenated butadiene, an aromatic compound, or a siloxane.

5. The dental appliance of claim 1, wherein the polymerizable compound comprises a chain composed of a plurality of the non-polar units, and wherein one or more of the polar units are located at one or more ends of the chain.

6. The dental appliance of claim 5, wherein the chain comprises two, four, or six ends.

7. The dental appliance of claim 5, wherein the non-polar unit comprises aliphatic diol, diamine, diacid, butadiene diol, hydrogenated butadiene diol, or siloxane diol.

8. The dental appliance of claim 5, wherein the polar unit comprises methacrylate, acrylate, diisocyanate, or diacid.

9. The dental appliance of claim 1, wherein the polymerizable compound has a number average molecular weight of least 1,000 g/mol, 2,000 g/mol, 17,000 g/mol, or 35,000 g/mol.

10. The dental appliance of claim 1, wherein the reactive diluent comprises C₁-C₂₄ alkyl acrylate, C₁-C₂₄ alkyl methacrylate, C₁-C₂₄ cycloalkyl acrylate, C₁-C₂₄ cycloalkyl methacrylate, heteroalkyl acrylate, heteroalkyl methacrylate, heterocyclyl acrylate, heterocyclyl methacrylate, aryl acrylate, or aryl methacrylate.

11. The dental appliance of claim 1, wherein the reactive diluent comprises a salicylate methacrylate or a salicylate acrylate.

12. The dental appliance of claim 1, wherein the polymerizable composition comprises from 50 wt % to 80 wt % of the polymerizable compound, and from 20 wt % to 50 wt % of the reactive diluent.

13. The dental appliance of claim 1, wherein the polymerizable composition comprises from 50 wt % to 85 wt % of the polymerizable compound, and from 15 wt % to 50 wt % of the reactive diluent.

14. The dental appliance of claim 1, wherein the polymerizable composition has a viscosity within a range from 1 cP to 10,000 cP at a temperature within a range from 15 °C to 100 °C, a viscosity within a range from 10 cP to 1,000 cP at a temperature within a range from 25 °C to 90 °C, a viscosity within a range from 100 cP to 500 cP at a temperature within a range from 30 °C to 60 °C, or a viscosity within a range from 5,000 cP to 10,000 cP at a temperature within a range from 15 °C to 30 °C.

15. The dental appliance of claim 1, wherein the dental appliance has a water uptake of less than 1 wt % when measured after 24 hours in a wet environment at 37 °C.

16. The dental appliance of claim 1, wherein the dental appliance has a rebound value of less than 30%.

17. The dental appliance of claim 1 wherein the dental appliance is configured to absorb at least 70% of energy from an impact event.

18. The dental appliance of claim 1, wherein the dental appliance has a tear resistance of at least 20 kN/m.

19. The dental appliance of claim 1, wherein the dental appliance has a hardness within a range from 55 to 95 Shore A.

20. The dental appliance of claim 1, wherein the dental appliance is a mouthguard.
